(19) United States
(12) Patent Application Publication
(10) Pub. No.: US 2026/0268677 A1
(43) Pub. Date: Sep. 10, 2026

(54) USER INTERFACES AND TECHNIQUES FOR MONITORING GUESTS

(71) Applicant: Apple Inc., Cupertino, CA (US)

(72) Inventors: Vincenzo O. GIULIANI, Thousand Oaks, CA (US); Joshua D. DEITEL, San Francisco, CA (US); Mischa K. MCLACHLAN, San Francisco, CA (US); Sung Min K. ARENA, Mill Valley, CA (US); William N. DANNER, Santa Cruz, CA (US)

(21) Appl. No.: 19/462,925

(22) Filed: Jan. 28, 2026

Related U.S. Application Data
(60) Provisional application No. 63/751,242, filed on Jan. 29, 2025.
(60) Provisional application No. 63/754,556, filed on Feb. 5, 2025.
(60) Provisional application No. 63/970,187, filed on Jan. 28, 2026.

(51) Int. Cl. G06V 20/52; G06F 3/04815

(52) U.S. Cl. CPC G06V 20/52; G06F 3/04815; G06V 2201/07

(57) ABSTRACT

Some techniques are for displaying a user interface element to contact guests in accordance with some embodiments. Other techniques are for displaying guest activities in accordance with some embodiments. Other techniques are for displaying a camera feed corresponding to guest position in accordance with some embodiments. Other techniques are for displaying media based on context in accordance with some embodiments.

### CROSS-REFERENCE TO RELATED APPLICATIONS

This application claims priority to U.S. Provisional Patent Application Ser. No. 63/970,187, entitled “USER INTERFACES AND TECHNIQUES FOR MONITORING GUESTS,” filed Jan. 28, 2026, to U.S. Provisional Patent Application Ser. No. 63/754,556, entitled “USER INTERFACES AND TECHNIQUES FOR MONITORING GUESTS” filed Feb. 5, 2025, and to U.S. Provisional Patent Application Ser. No. 63/751,242, entitled “USER INTERFACES AND TECHNIQUES FOR MONITORING GUESTS” filed Jan. 29, 2025. The content of these applications is hereby incorporated by reference in their entirety.

### BACKGROUND

Electronic devices often capture images and detect motion. Such detection of motion and capture of images often include displaying the images and notifying of the motion.

### SUMMARY

Some techniques described herein enable electronic devices to be faster, more efficient, and/or more effective for monitoring guests. Such techniques can replace and/or work in conjunction with existing techniques for monitoring guests.

In some embodiments, a method that is performed at a computer system that is in communication with one or more display components is described. In some embodiments, the method comprises: receiving a notification that a respective subject has been detected in an environment; and in response to receiving the notification that the respective subject has been detected in the environment: in accordance with a determination that the respective subject is a first subject, displaying, via the one or more display components, a user interface element to contact the first subject; and in accordance with a determination that the respective subject is a second subject, displaying, via the one or more display components, a user interface element to contact the second subject without displaying the user interface element to contact the first subject, wherein the first subject is different from the second subject, and wherein the user interface element to contact the first subject is separate from the user interface element to contact the second subject.

In some embodiments, a non-transitory computer-readable storage medium storing one or more programs configured to be executed by one or more processors of a computer system that is in communication with one or more display components is described. In some embodiments, the one or more programs includes instructions for: receiving a notification that a respective subject has been detected in an environment; and in response to receiving the notification that the respective subject has been detected in the environment: in accordance with a determination that the respective subject is a first subject, displaying, via the one or more display components, a user interface element to contact the first subject; and in accordance with a determination that the respective subject is a second subject, displaying, via the one or more display components, a user interface element to contact the second subject without displaying the user interface element to contact the first subject, wherein the first subject is different from the second subject, and wherein the user interface element to contact the first subject is separate from the user interface element to contact the second subject.

In some embodiments, a transitory computer-readable storage medium storing one or more programs configured to be executed by one or more processors of a computer system that is in communication with one or more display components is described. In some embodiments, the one or more programs includes instructions for: receiving a notification that a respective subject has been detected in an environment; and in response to receiving the notification that the respective subject has been detected in the environment: in accordance with a determination that the respective subject is a first subject, displaying, via the one or more display components, a user interface element to contact the first subject; and in accordance with a determination that the respective subject is a second subject, displaying, via the one or more display components, a user interface element to contact the second subject without displaying the user interface element to contact the first subject, wherein the first subject is different from the second subject, and wherein the user interface element to contact the first subject is separate from the user interface element to contact the second subject.

In some embodiments, a computer system that is configured to communicate with one or more display components is described. In some embodiments, the computer system comprises one or more processors and memory storing one or more programs configured to be executed by the one or more processors. In some embodiments, the one or more programs includes instructions for: receiving a notification that a respective subject has been detected in an environment; and in response to receiving the notification that the respective subject has been detected in the environment: in accordance with a determination that the respective subject is a first subject, displaying, via the one or more display components, a user interface element to contact the first subject; and in accordance with a determination that the respective subject is a second subject, displaying, via the one or more display components, a user interface element to contact the second subject without displaying the user interface element to contact the first subject, wherein the first subject is different from the second subject, and wherein the user interface element to contact the first subject is separate from the user interface element to contact the second subject.

In some embodiments, a computer system that is configured to communicate with one or more display components is described. In some embodiments, the computer system comprises means for performing each of the following steps: receiving a notification that a respective subject has been detected in an environment; and in response to receiving the notification that the respective subject has been detected in the environment: in accordance with a determination that the respective subject is a first subject, displaying, via the one or more display components, a user interface element to contact the first subject; and in accordance with a determination that the respective subject is a second subject, displaying, via the one or more display components, a user interface element to contact the second subject without displaying the user interface element to contact the first subject, wherein the first subject is different from the second subject, and wherein the user interface element to contact the first subject is separate from the user interface element to contact the second subject.

In some embodiments, a computer program product is described. In some embodiments, the computer program comprises one or more programs configured to be executed by one or more processors of a computer system that is in communication with one or more display components. In some embodiments, the one or more programs include instructions for: receiving a notification that a respective subject has been detected in an environment; and in response to receiving the notification that the respective subject has been detected in the environment: in accordance with a determination that the respective subject is a first subject, displaying, via the one or more display components, a user interface element to contact the first subject; and in accordance with a determination that the respective subject is a second subject, displaying, via the one or more display components, a user interface element to contact the second subject without displaying the user interface element to contact the first subject, wherein the first subject is different from the second subject, and wherein the user interface element to contact the first subject is separate from the user interface element to contact the second subject.

In some embodiments, a method that is performed at a computer system that is in communication with one or more input devices and one or more display components is described. In some embodiments, the method comprises: receiving a notification that a subject has been detected in an environment; in response to receiving the notification that the subject has been detected in the environment, displaying, via the one or more display components, a user interface element to view indications of activities of the subject in the environment; while displaying the user interface element to view indications of activities of the subject in the environment, detecting, via the one or more input devices, an input corresponding to the user interface element to view indications of activities of the subject in the environment; and in response to detecting the input corresponding to the user interface element to view indications of activities, displaying, via the one or more display components, a plurality of representations of activities performed by the subject, wherein the plurality of representations of activities includes a first representation of a first activity and a second representation of a second activity, wherein the first representation is separate from the second representation.

In some embodiments, a non-transitory computer-readable storage medium storing one or more programs configured to be executed by one or more processors of a computer system that is in communication with one or more input devices and one or more display components is described. In some embodiments, the one or more programs includes instructions for: receiving a notification that a subject has been detected in an environment; in response to receiving the notification that the subject has been detected in the environment, displaying, via the one or more display components, a user interface element to view indications of activities of the subject in the environment; while displaying the user interface element to view indications of activities of the subject in the environment, detecting, via the one or more input devices, an input corresponding to the user interface element to view indications of activities of the subject in the environment; and in response to detecting the input corresponding to the user interface element to view indications of activities, displaying, via the one or more display components, a plurality of representations of activities performed by the subject, wherein the plurality of representations of activities includes a first representation of a first activity and a second representation of a second activity, wherein the first representation is separate from the second representation.

In some embodiments, a transitory computer-readable storage medium storing one or more programs configured to be executed by one or more processors of a computer system that is in communication with one or more input devices and one or more display components is described. In some embodiments, the one or more programs includes instructions for: receiving a notification that a subject has been detected in an environment; in response to receiving the notification that the subject has been detected in the environment, displaying, via the one or more display components, a user interface element to view indications of activities of the subject in the environment; while displaying the user interface element to view indications of activities of the subject in the environment, detecting, via the one or more input devices, an input corresponding to the user interface element to view indications of activities of the subject in the environment; and in response to detecting the input corresponding to the user interface element to view indications of activities, displaying, via the one or more display components, a plurality of representations of activities performed by the subject, wherein the plurality of representations of activities includes a first representation of a first activity and a second representation of a second activity, wherein the first representation is separate from the second representation.

In some embodiments, a computer system that is configured to communicate with one or more input devices and one or more display components is described. In some embodiments, the computer system comprises one or more processors and memory storing one or more programs configured to be executed by the one or more processors. In some embodiments, the one or more programs includes instructions for: receiving a notification that a subject has been detected in an environment; in response to receiving the notification that the subject has been detected in the environment, displaying, via the one or more display components, a user interface element to view indications of activities of the subject in the environment; while displaying the user interface element to view indications of activities of the subject in the environment, detecting, via the one or more input devices, an input corresponding to the user interface element to view indications of activities of the subject in the environment; and in response to detecting the input corresponding to the user interface element to view indications of activities, displaying, via the one or more display components, a plurality of representations of activities performed by the subject, wherein the plurality of representations of activities includes a first representation of a first activity and a second representation of a second activity, wherein the first representation is separate from the second representation.

In some embodiments, a computer system that is configured to communicate with one or more input devices and one or more display components is described. In some embodiments, the computer system comprises means for performing each of the following steps: receiving a notification that a subject has been detected in an environment; in response to receiving the notification that the subject has been detected in the environment, displaying, via the one or more display components, a user interface element to view indications of activities of the subject in the environment; while displaying the user interface element to view indications of activities of the subject in the environment, detecting, via the one or more input devices, an input corresponding to the user interface element to view indications of activities of the subject in the environment; and in response to detecting the input corresponding to the user interface element to view indications of activities, displaying, via the one or more display components, a plurality of representations of activities performed by the subject, wherein the plurality of representations of activities includes a first representation of a first activity and a second representation of a second activity, wherein the first representation is separate from the second representation.

In some embodiments, a computer program product is described. In some embodiments, the computer program product comprises one or more programs configured to be executed by one or more processors of a computer system that is in communication with one or more input devices and one or more display components. In some embodiments, the one or more programs include instructions for: receiving a notification that a subject has been detected in an environment; in response to receiving the notification that the subject has been detected in the environment, displaying, via the one or more display components, a user interface element to view indications of activities of the subject in the environment; while displaying the user interface element to view indications of activities of the subject in the environment, detecting, via the one or more input devices, an input corresponding to the user interface element to view indications of activities of the subject in the environment; and in response to detecting the input corresponding to the user interface element to view indications of activities, displaying, via the one or more display components, a plurality of representations of activities performed by the subject, wherein the plurality of representations of activities includes a first representation of a first activity and a second representation of a second activity, wherein the first representation is separate from the second representation.

In some embodiments, a method that is performed at a computer system that is in communication with one or more display components and one or more input devices is described. In some embodiments, the method comprises: displaying, via the one or more display components, a representation of a notification of a subject being detected in an environment with a user interface element to review the subject being detected in the environment; while displaying the representation of the notification of the subject being detected in the environment with the user interface element to review the subject being detected in environment, detecting, via the one or more input devices, an input corresponding to the user interface element to review the subject being detected in the environment; in response to detecting the input corresponding to the user interface element to review the subject being detected in the environment and in accordance with a determination that the subject is in a first portion of the environment, displaying, via the one or more display components, a representation of a first camera feed corresponding to the first portion of the environment; while displaying the first camera feed corresponding to the first portion of the environment, receiving an indication that the subject is at a second portion of the environment, wherein the second portion of the environment is different from the first portion of the environment; and in response to receiving the indication that the subject is in the second portion of the environment, displaying, via the one or more display components, a representation of a second camera feed corresponding to the second portion of the environment, wherein the first camera feed is different from the second camera feed.

In some embodiments, a non-transitory computer-readable storage medium storing one or more programs configured to be executed by one or more processors of a computer system that is in communication with one or more display components and one or more input devices is described. In some embodiments, the one or more programs includes instructions for: displaying, via the one or more display components, a representation of a notification of a subject being detected in an environment with a user interface element to review the subject being detected in the environment; while displaying the representation of the notification of the subject being detected in the environment with the user interface element to review the subject being detected in environment, detecting, via the one or more input devices, an input corresponding to the user interface element to review the subject being detected in the environment; in response to detecting the input corresponding to the user interface element to review the subject being detected in the environment and in accordance with a determination that the subject is in a first portion of the environment, displaying, via the one or more display components, a representation of a first camera feed corresponding to the first portion of the environment; while displaying the first camera feed corresponding to the first portion of the environment, receiving an indication that the subject is at a second portion of the environment, wherein the second portion of the environment is different from the first portion of the environment; and in response to receiving the indication that the subject is in the second portion of the environment, displaying, via the one or more display components, a representation of a second camera feed corresponding to the second portion of the environment, wherein the first camera feed is different from the second camera feed.

In some embodiments, a transitory computer-readable storage medium storing one or more programs configured to be executed by one or more processors of a computer system that is in communication with one or more display components and one or more input devices is described. In some embodiments, the one or more programs includes instructions for: displaying, via the one or more display components, a representation of a notification of a subject being detected in an environment with a user interface element to review the subject being detected in the environment; while displaying the representation of the notification of the subject being detected in the environment with the user interface element to review the subject being detected in environment, detecting, via the one or more input devices, an input corresponding to the user interface element to review the subject being detected in the environment; in response to detecting the input corresponding to the user interface element to review the subject being detected in the environment and in accordance with a determination that the subject is in a first portion of the environment, displaying, via the one or more display components, a representation of a first camera feed corresponding to the first portion of the environment; while displaying the first camera feed corresponding to the first portion of the environment, receiving an indication that the subject is at a second portion of the environment, wherein the second portion of the environment is different from the first portion of the environment; and in response to receiving the indication that the subject is in the second portion of the environment, displaying, via the one or more display components, a representation of a second camera feed corresponding to the second portion of the environment, wherein the first camera feed is different from the second camera feed.

In some embodiments, a computer system that is configured to communicate with one or more display components and one or more input devices is described. In some embodiments, the computer system comprises one or more processors and memory storing one or more programs configured to be executed by the one or more processors. In some embodiments, the one or more programs includes instructions for: displaying, via the one or more display components, a representation of a notification of a subject being detected in an environment with a user interface element to review the subject being detected in the environment; while displaying the representation of the notification of the subject being detected in the environment with the user interface element to review the subject being detected in environment, detecting, via the one or more input devices, an input corresponding to the user interface element to review the subject being detected in the environment; in response to detecting the input corresponding to the user interface element to review the subject being detected in the environment and in accordance with a determination that the subject is in a first portion of the environment, displaying, via the one or more display components, a representation of a first camera feed corresponding to the first portion of the environment; while displaying the first camera feed corresponding to the first portion of the environment, receiving an indication that the subject is at a second portion of the environment, wherein the second portion of the environment is different from the first portion of the environment; and in response to receiving the indication that the subject is in the second portion of the environment, displaying, via the one or more display components, a representation of a second camera feed corresponding to the second portion of the environment, wherein the first camera feed is different from the second camera feed.

In some embodiments, a computer system that is configured to communicate with one or more display components and one or more input devices is described. In some embodiments, the computer system comprises means for performing each of the following steps: displaying, via the one or more display components, a representation of a notification of a subject being detected in an environment with a user interface element to review the subject being detected in the environment; while displaying the representation of the notification of the subject being detected in the environment with the user interface element to review the subject being detected in environment, detecting, via the one or more input devices, an input corresponding to the user interface element to review the subject being detected in the environment; in response to detecting the input corresponding to the user interface element to review the subject being detected in the environment and in accordance with a determination that the subject is in a first portion of the environment, displaying, via the one or more display components, a representation of a first camera feed corresponding to the first portion of the environment; while displaying the first camera feed corresponding to the first portion of the environment, receiving an indication that the subject is at a second portion of the environment, wherein the second portion of the environment is different from the first portion of the environment; and in response to receiving the indication that the subject is in the second portion of the environment, displaying, via the one or more display components, a representation of a second camera feed corresponding to the second portion of the environment, wherein the first camera feed is different from the second camera feed.

In some embodiments, a computer program product is described. In some embodiments, the computer program product comprises one or more programs configured to be executed by one or more processors of a computer system that is in communication with one or more display components and one or more input devices. In some embodiments, the one or more programs include instructions for: displaying, via the one or more display components, a representation of a notification of a subject being detected in an environment with a user interface element to review the subject being detected in the environment; while displaying the representation of the notification of the subject being detected in the environment with the user interface element to review the subject being detected in environment, detecting, via the one or more input devices, an input corresponding to the user interface element to review the subject being detected in the environment; in response to detecting the input corresponding to the user interface element to review the subject being detected in the environment and in accordance with a determination that the subject is in a first portion of the environment, displaying, via the one or more display components, a representation of a first camera feed corresponding to the first portion of the environment; while displaying the first camera feed corresponding to the first portion of the environment, receiving an indication that the subject is at a second portion of the environment, wherein the second portion of the environment is different from the first portion of the environment; and in response to receiving the indication that the subject is in the second portion of the environment, displaying, via the one or more display components, a representation of a second camera feed corresponding to the second portion of the environment, wherein the first camera feed is different from the second camera feed.

In some embodiments, a method that is performed at a computer system that is in communication with one or more input devices and one or more display components is described. In some embodiments, the method comprises: detecting, via the one or more input devices, an input corresponding to a request to display an activity log; and in response to detecting the input corresponding to the request to display the activity log, displaying, via the one or more display components, an indication of a subject: in accordance with a determination that authentication of the subject detected in an environment satisfies a first set of one or more criteria, with media content captured of the subject; and in accordance with a determination that authentication of the subject detected in the environment satisfies a second set of one or more criteria, without media content captured of the subject, wherein the second set of one or more criteria is different from the first set of one or more criteria.

In some embodiments, a non-transitory computer-readable storage medium storing one or more programs configured to be executed by one or more processors of a computer system that is in communication with one or more input devices and one or more display components is described. In some embodiments, the one or more programs includes instructions for: detecting, via the one or more input devices, an input corresponding to a request to display an activity log; and in response to detecting the input corresponding to the request to display the activity log, displaying, via the one or more display components, an indication of a subject: in accordance with a determination that authentication of the subject detected in an environment satisfies a first set of one or more criteria, with media content captured of the subject; and in accordance with a determination that authentication of the subject detected in the environment satisfies a second set of one or more criteria, without media content captured of the subject, wherein the second set of one or more criteria is different from the first set of one or more criteria.

In some embodiments, a transitory computer-readable storage medium storing one or more programs configured to be executed by one or more processors of a computer system that is in communication with one or more input devices and one or more display components is described. In some embodiments, the one or more programs includes instructions for: detecting, via the one or more input devices, an input corresponding to a request to display an activity log; and in response to detecting the input corresponding to the request to display the activity log, displaying, via the one or more display components, an indication of a subject: in accordance with a determination that authentication of the subject detected in an environment satisfies a first set of one or more criteria, with media content captured of the subject; and in accordance with a determination that authentication of the subject detected in the environment satisfies a second set of one or more criteria, without media content captured of the subject, wherein the second set of one or more criteria is different from the first set of one or more criteria.

In some embodiments, a computer system that is configured to communicate with one or more input devices and one or more display components is described. In some embodiments, the computer system comprises one or more processors and memory storing one or more programs configured to be executed by the one or more processors. In some embodiments, the one or more programs includes instructions for: detecting, via the one or more input devices, an input corresponding to a request to display an activity log; and in response to detecting the input corresponding to the request to display the activity log, displaying, via the one or more display components, an indication of a subject: in accordance with a determination that authentication of the subject detected in an environment satisfies a first set of one or more criteria, with media content captured of the subject; and in accordance with a determination that authentication of the subject detected in the environment satisfies a second set of one or more criteria, without media content captured of the subject, wherein the second set of one or more criteria is different from the first set of one or more criteria.

In some embodiments, a computer system that is configured to communicate with one or more input devices and one or more display components is described. In some embodiments, the computer system comprises means for performing each of the following steps: detecting, via the one or more input devices, an input corresponding to a request to display an activity log; and in response to detecting the input corresponding to the request to display the activity log, displaying, via the one or more display components, an indication of a subject: in accordance with a determination that authentication of the subject detected in an environment satisfies a first set of one or more criteria, with media content captured of the subject; and in accordance with a determination that authentication of the subject detected in the environment satisfies a second set of one or more criteria, without media content captured of the subject, wherein the second set of one or more criteria is different from the first set of one or more criteria.

In some embodiments, a computer program product is described. In some embodiments, the computer program product comprises one or more programs configured to be executed by one or more processors of a computer system that is in communication with one or more input devices and one or more display components. In some embodiments, the one or more programs include instructions for: detecting, via the one or more input devices, an input corresponding to a request to display an activity log; and in response to detecting the input corresponding to the request to display the activity log, displaying, via the one or more display components, an indication of a subject: in accordance with a determination that authentication of the subject detected in an environment satisfies a first set of one or more criteria, with media content captured of the subject; and in accordance with a determination that authentication of the subject detected in the environment satisfies a second set of one or more criteria, without media content captured of the subject, wherein the second set of one or more criteria is different from the first set of one or more criteria.

A computer-readable storage medium or other computer program product that is set up to run on one or more processors can optionally include executable instructions for carrying out steps described above.

### DESCRIPTION OF THE FIGURES

To gain a clearer understanding of techniques described herein, references to various embodiments are described below in the Detailed Description. In conjunction with the Detailed Description, drawings are provided in which reference numerals refer to related parts across the drawings.

FIG. 1 is a block diagram illustrating a computer system in accordance with some embodiments.

FIG. 2A is a block diagram illustrating a device and a system in accordance with some embodiments.

FIG. 2B illustrates a computer system with a touch screen in accordance with some embodiments.

FIG. 3 is a block diagram illustrating an ecosystem including a computer system with other accessory devices in accordance with some embodiments.

FIGS. 4A-4F illustrate exemplary user interfaces for monitoring guests in accordance with some embodiments.

FIG. 5 is a flow diagram illustrating a process for displaying a user interface element to contact guests in accordance with some embodiments.

FIG. 6 is a flow diagram illustrating a process for displaying guest activities in accordance with some embodiments.

FIGS. 7A-7V illustrate exemplary user interfaces for displaying guest activity in accordance with some embodiments.

FIG. 8 is a flow diagram illustrating a process for displaying a camera feed corresponding to guest position in accordance with some embodiments.

FIG. 9 is a flow diagram illustrating a process for displaying media based on context in accordance with some embodiments.

FIGS. 10A-10H illustrate exemplary user interfaces for displaying guest activity in accordance with some embodiments.

FIG. 11 is a flow diagram illustrating a process for displaying a camera feed corresponding to guest position in accordance with some embodiments.

FIG. 12 is a flow diagram illustrating a process for displaying media based on context in accordance with some embodiments.

### DETAILED DESCRIPTION

The description that follows covers exemplary embodiments and examples. However, it should be acknowledged that this description is given as an explanation and is not meant to restrict the scope of the current disclosure. For example, terms used to describe different embodiments and different examples are not meant to be restrictive unless explicitly stated.

In some embodiments, one or more steps of a process can be contingent upon fulfillment of one or more conditions. To fulfill the one or more conditions, a process can be repeated multiple times. In such embodiments, different conditions can be satisfied in different repetitions. For example, steps can be repeated until all conditions have been satisfied. In some embodiments, electronic devices, computer systems, and/or computer readable mediums include instructions for performing one or more steps that are contingent upon one or more conditions being satisfied. Such instructions can include logic that determines whether the one or more conditions have been fulfilled without repetition of a step.

Although terms such as “first”, “second”, and so forth are used with different elements in the following description, these elements should not be constrained by the terms unless explicitly stated otherwise. In some embodiments, the terms are used to differentiate one element from another. For example, a “first” input can be different from a “second” input, though the terms “first” and “second” can be switched without changing the meaning of either input. In some embodiments, the “first” input and the “second” input are two different references to the same input unless explicitly stated otherwise.

Unless context makes it apparent otherwise, singular forms of “a”, “an”, and “the” are meant to cover plural forms. Additionally, the term “and/or” is meant to be interpreted to apply to and include any and all potential combinations of one or more of the related mentioned things. The terms “has”, “having”, “includes”, “including”, “comprises”, and/or “comprising” are meant to cover the presence of different elements; however, they do not preclude the presence or addition of one or more additional elements. The term “if” is meant to be interpreted to indicate “when”, “upon”, “in response to determining”, or “in response to detecting”. Accordingly, depending on the context, the expressions “if it is determined” or “if [a stated condition] is detected” can be interpreted as meaning “upon determining”, “in response to determining”, “upon detecting [the stated condition]”, or “in response to detecting [the stated condition]”.

Some processes described below enhance the operability of devices and make interfaces better, such as by helping a user provide proper inputs and/or reduce mistakes when using devices, through various techniques. For example, some processes perform an operation when a set of conditions has been met without requiring further input, such as input by a user. For another example, some processes provide additional control options without cluttering user interfaces with additional displayed controls. For another example, some processes reduce the number of inputs needed to perform an operation. For another example, some processes provide improved feedback (e.g., visual, haptic, acoustic, and/or tactile feedback) to a user. Additional techniques include increasing the security and/or privacy of the device and/or reducing burn-in. These techniques also reduce power usage and/or improve battery life of devices, such as by enabling a user to use devices better, more quickly, and/or efficiently.

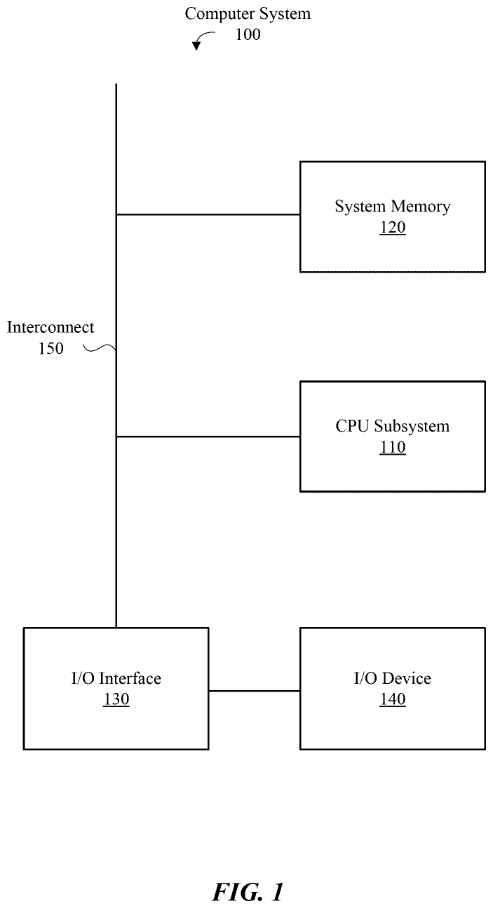

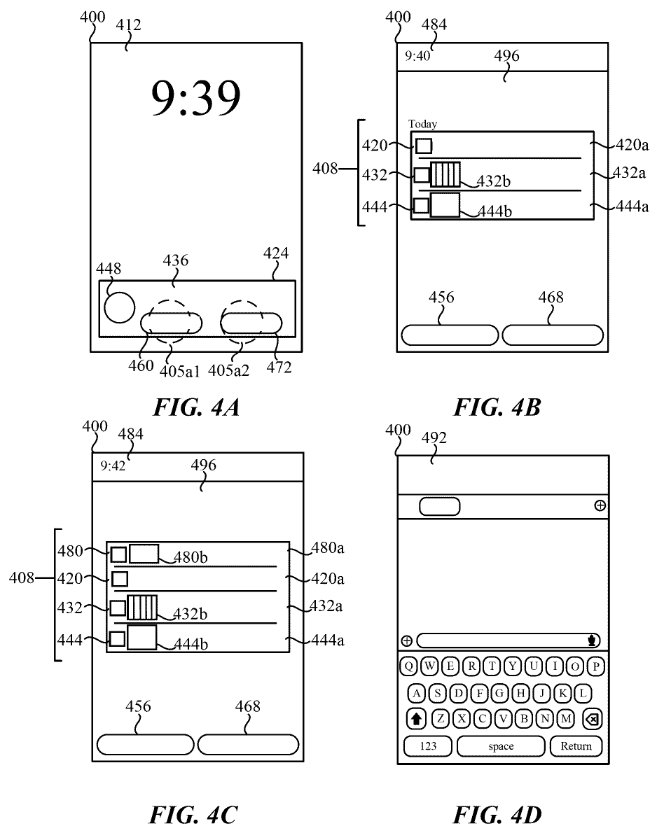

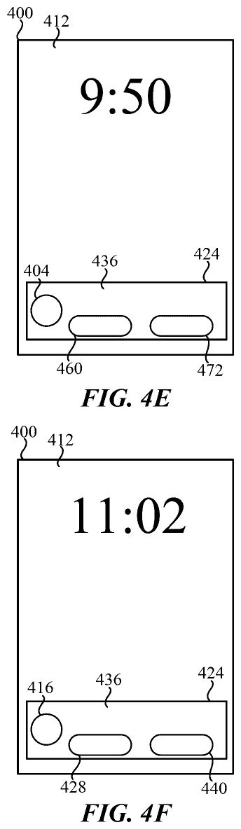

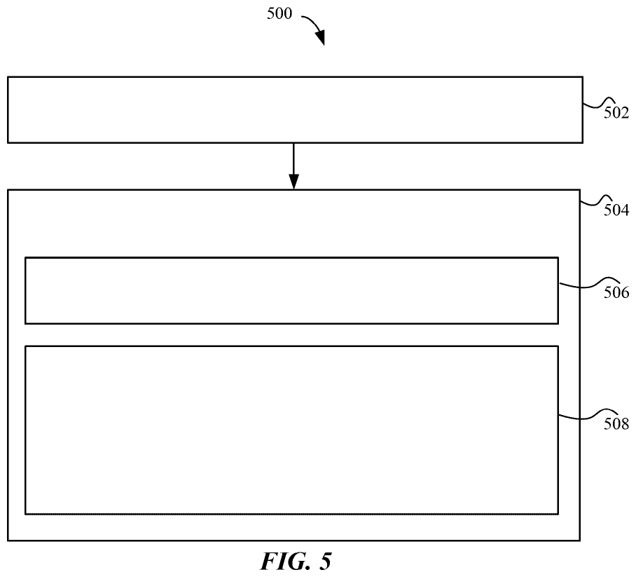

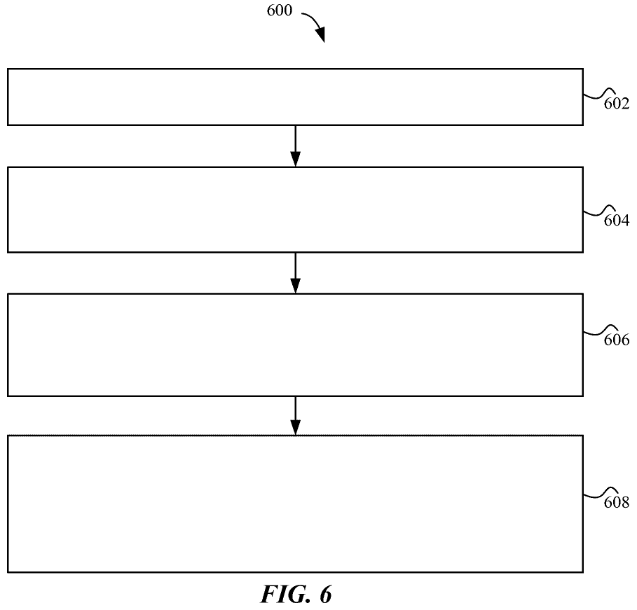

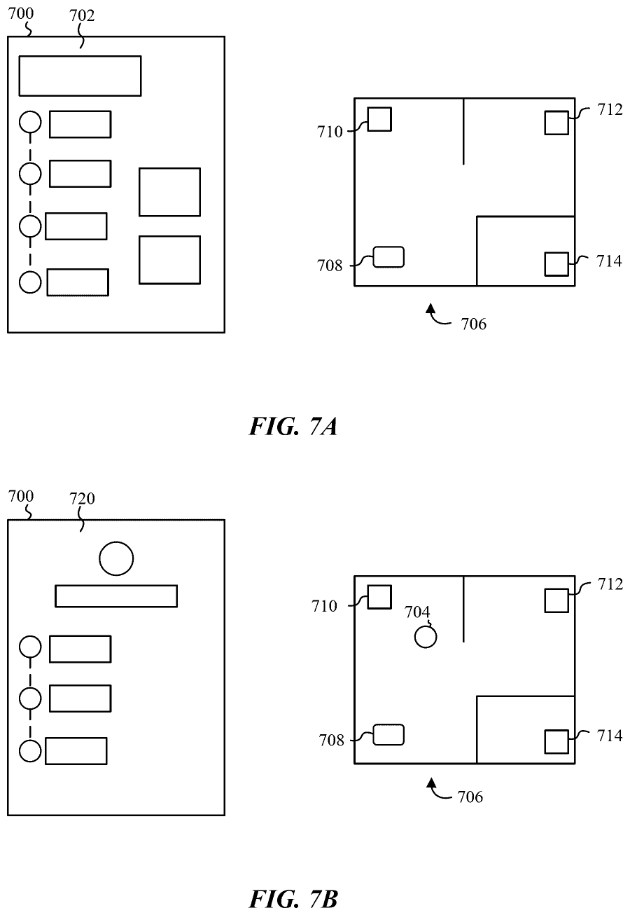

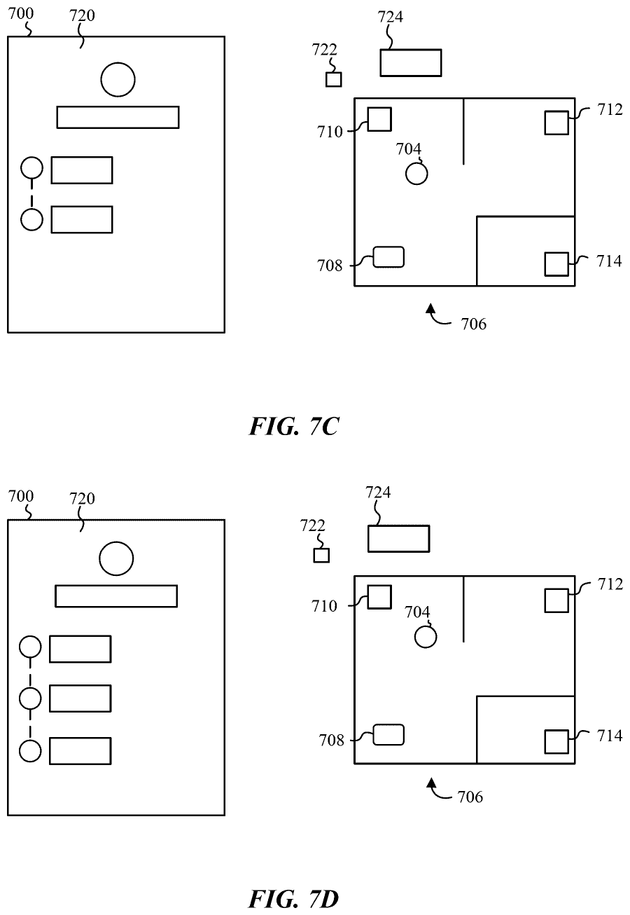

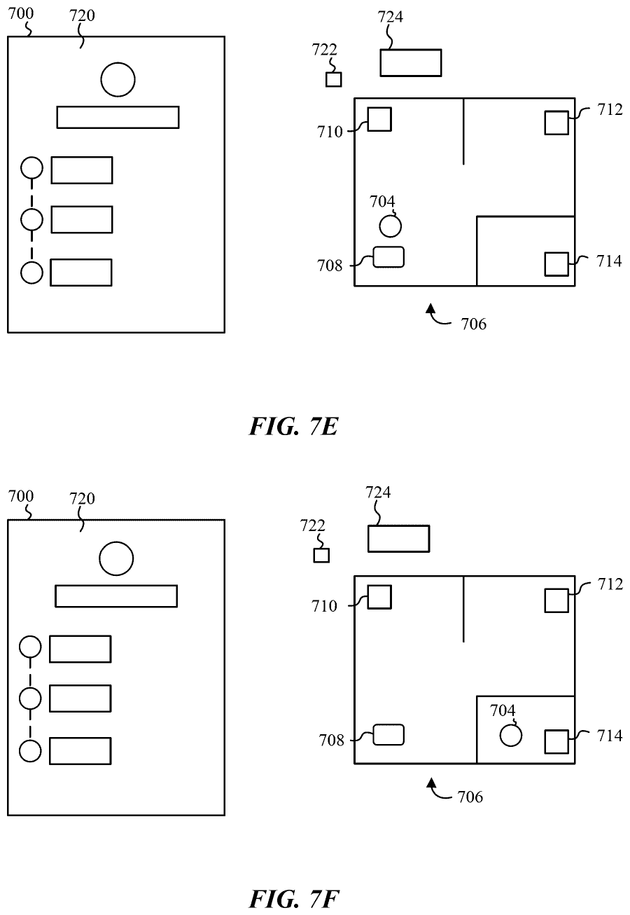

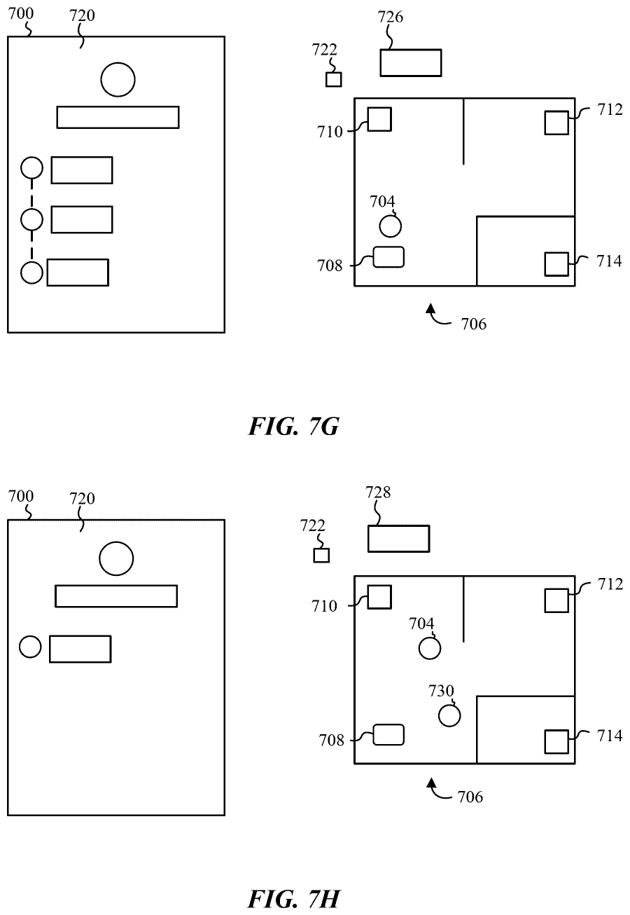

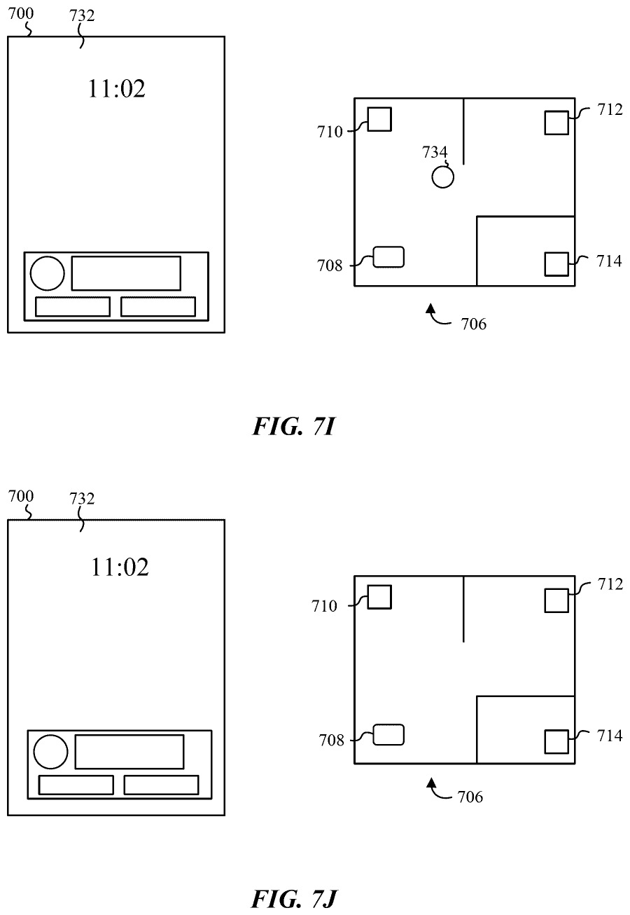

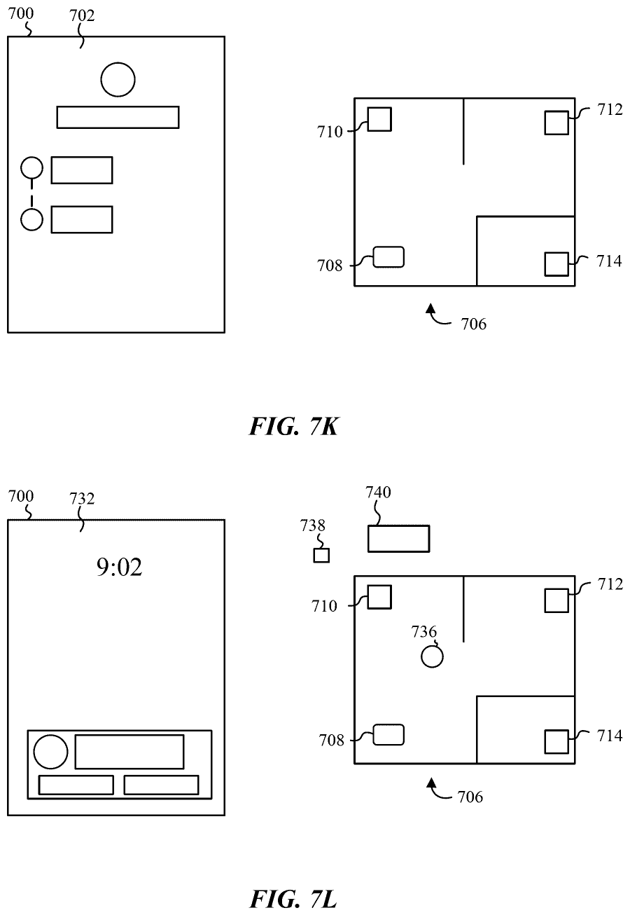

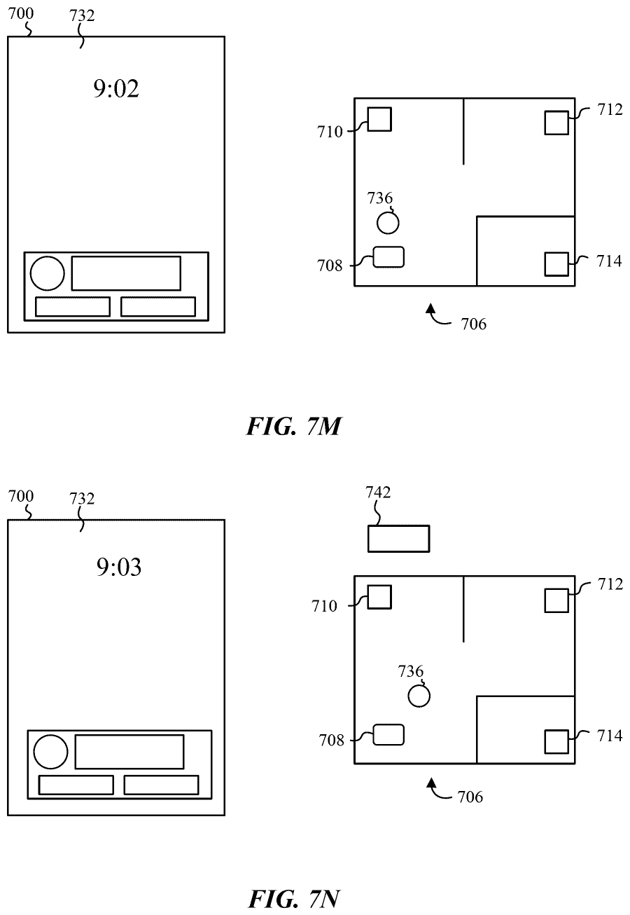

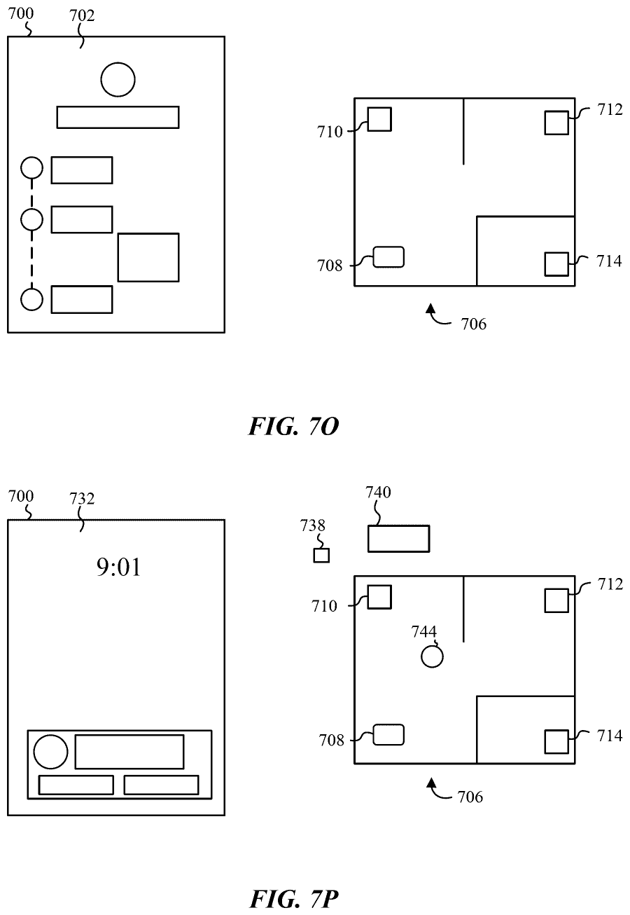

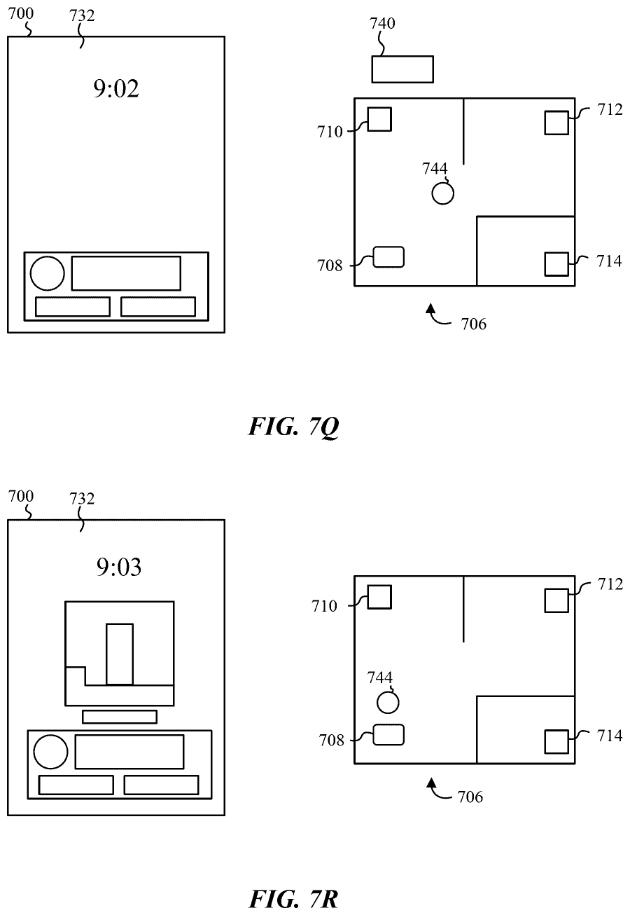

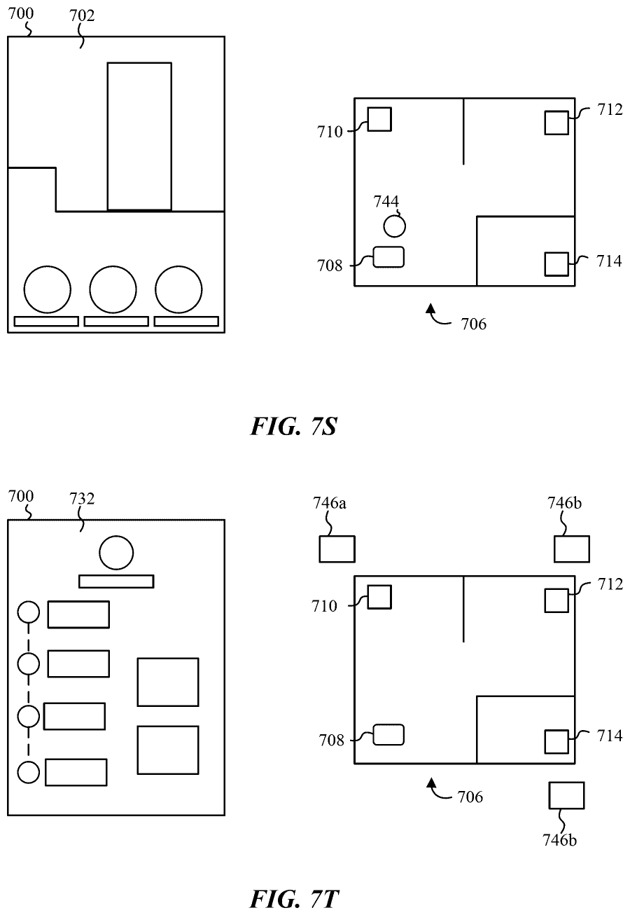

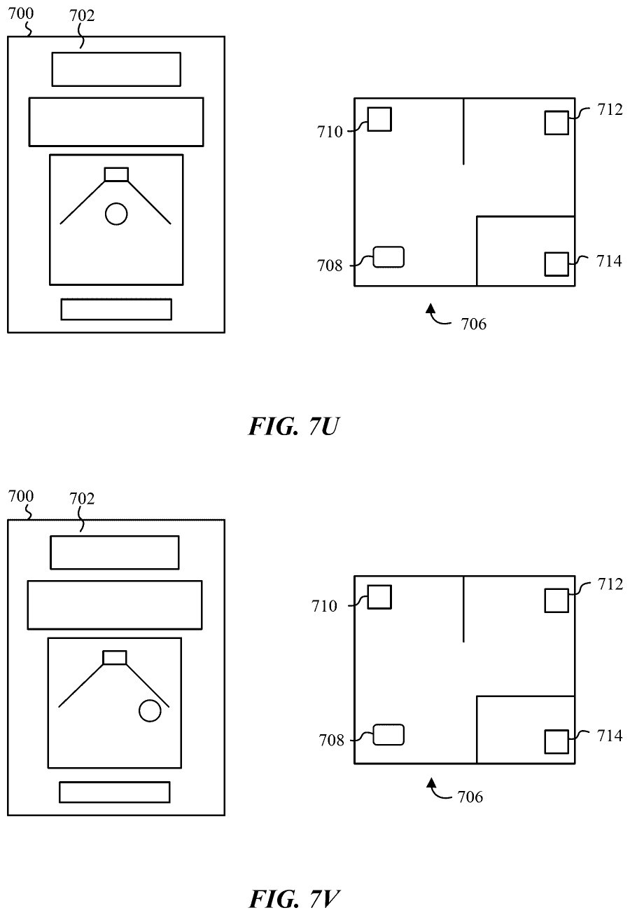

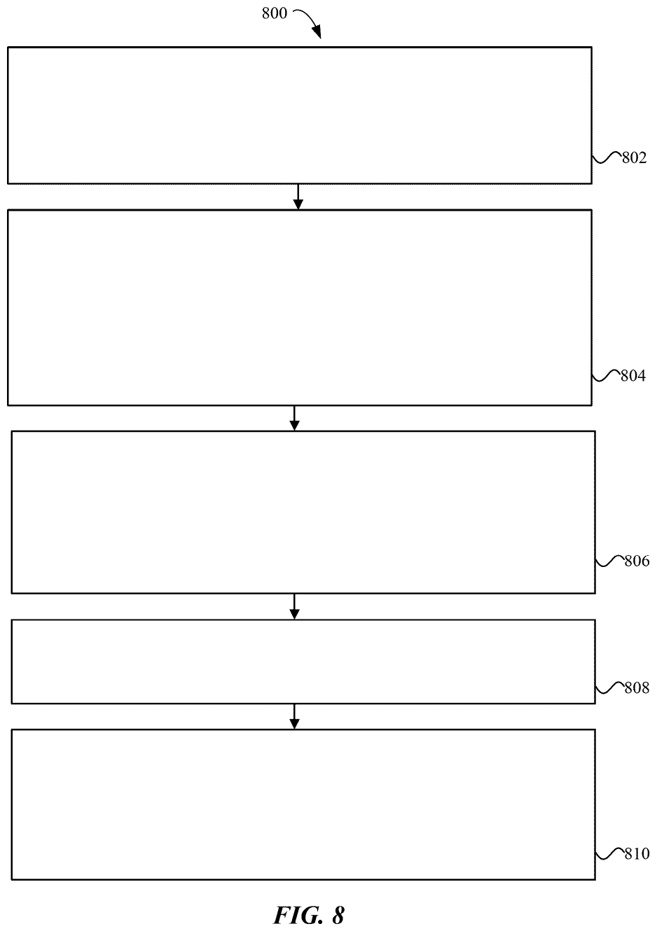

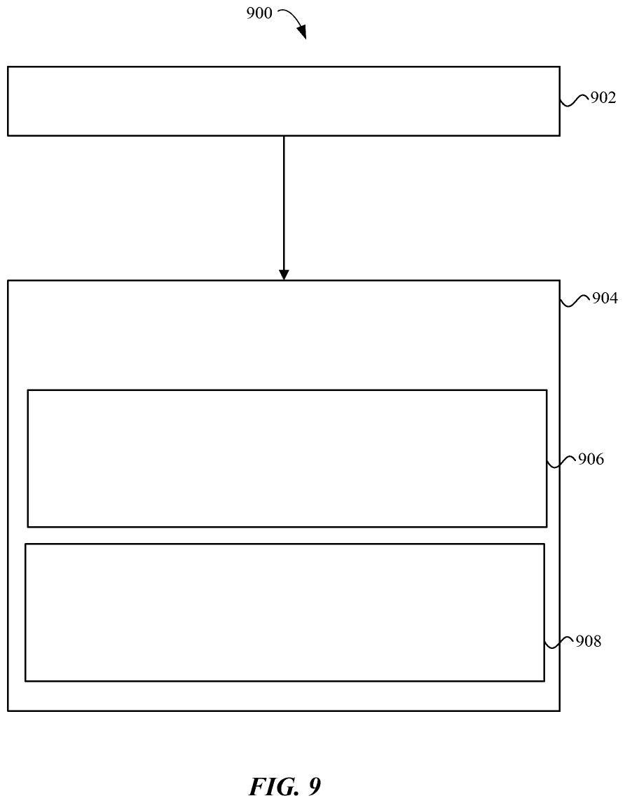

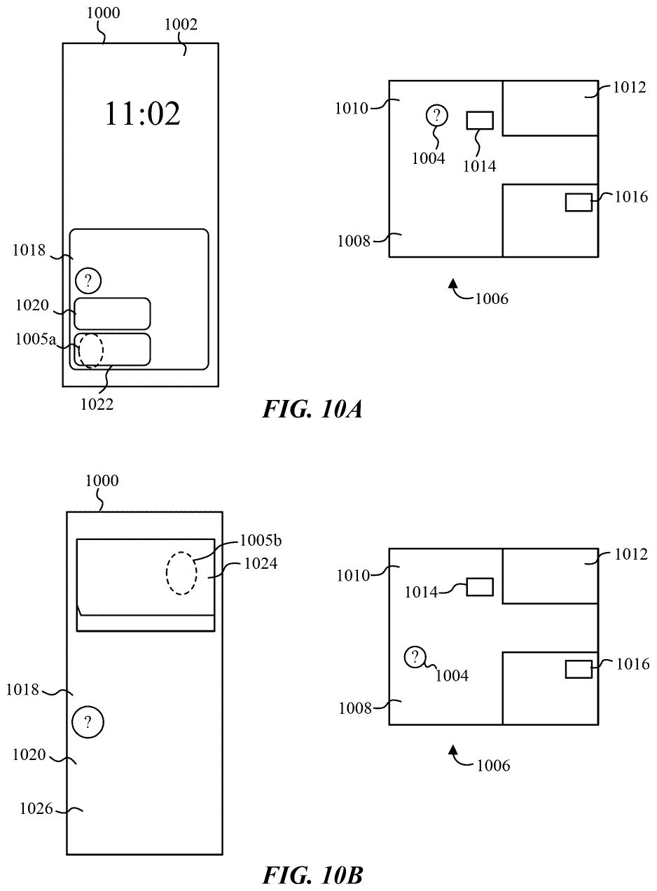

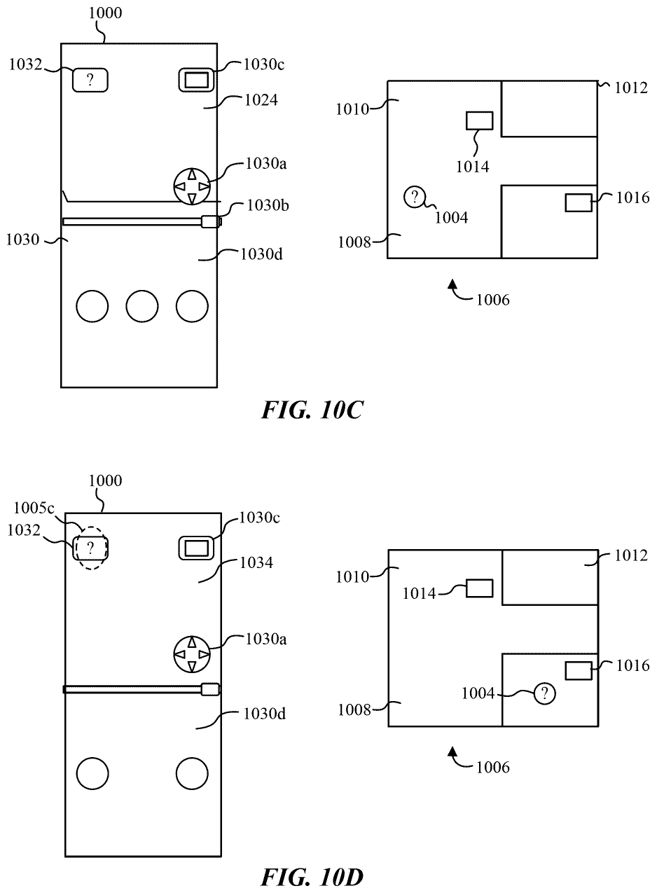

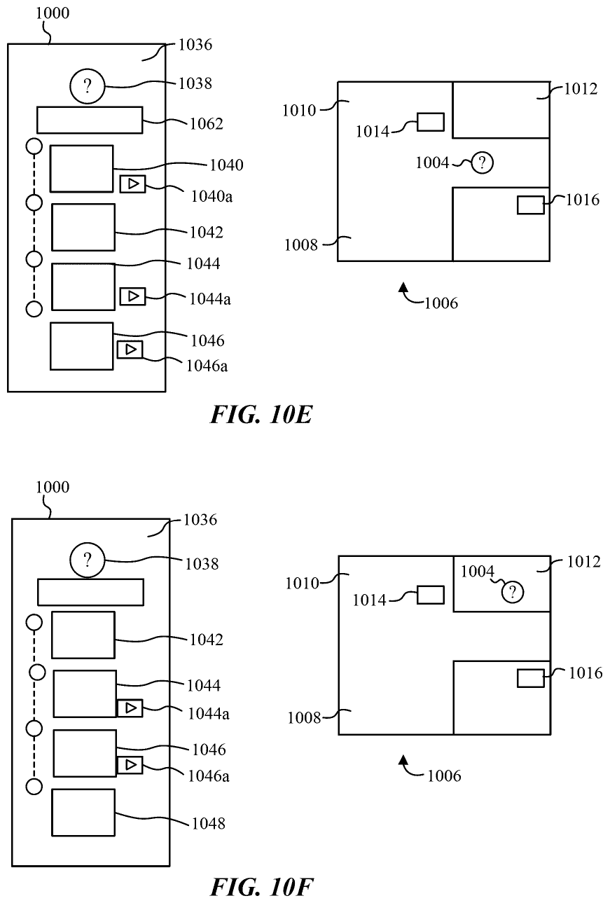

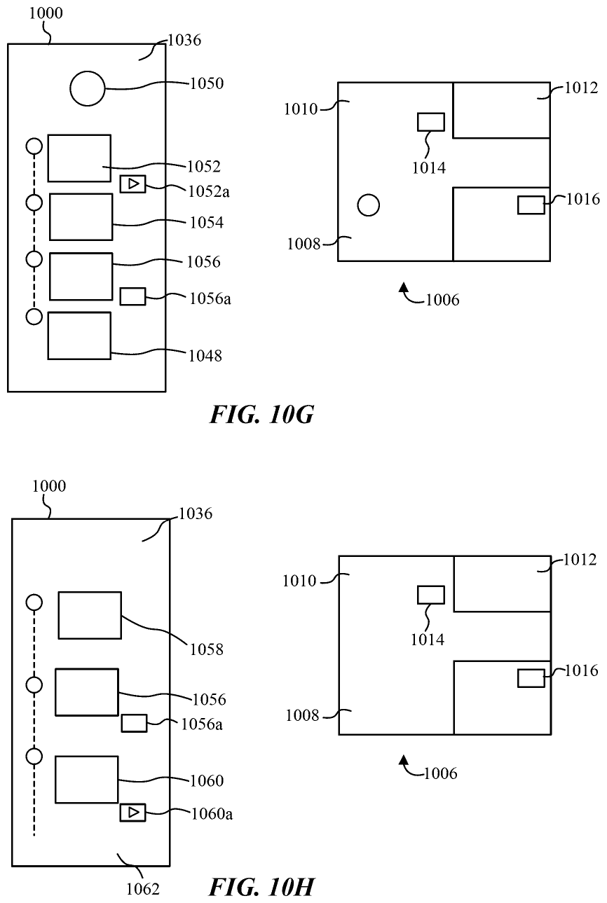

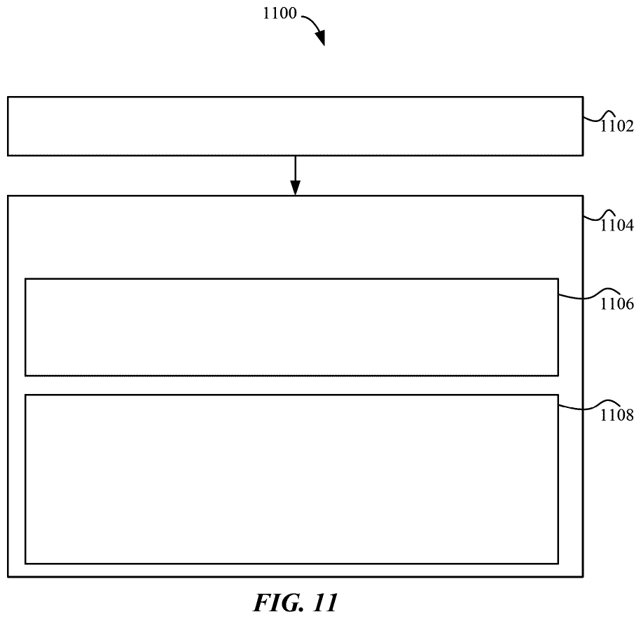

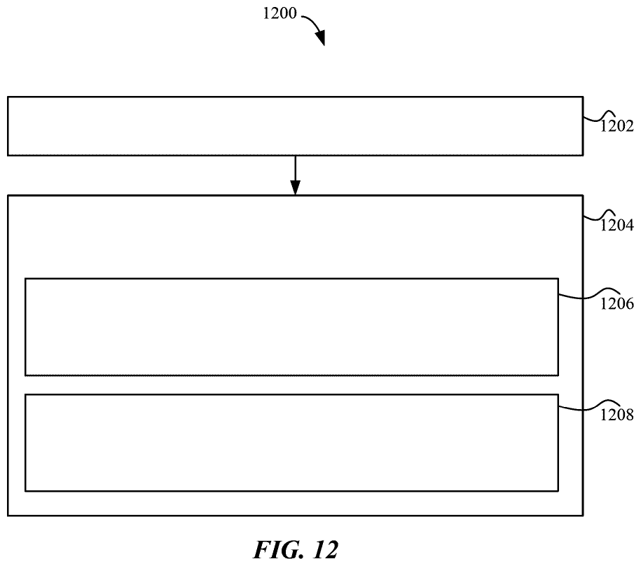

Below, FIGS. 1, 2A-2B, and 3 provide description of exemplary devices for implementing techniques described below. FIGS. 4A-4F illustrate exemplary user interfaces for monitoring guests in accordance with some embodiments. FIG. 5 is a flow diagram illustrating a process for displaying a user interface element to contact guests in accordance with some embodiments. The user interfaces in FIGS. 4A-4F are used to illustrate the processes described below, including the processes in FIG. 5. FIG. 6 is a flow diagram illustrating a process for displaying guest activities in accordance with some embodiments. The user interfaces in FIGS. 4A-4F are used to illustrate the processes described below, including the processes in FIG. 6. FIGS. 7A-7V illustrate exemplary user interfaces for displaying guest activity in accordance with some embodiments. FIG. 8 is a flow diagram illustrating a process for displaying a camera feed corresponding to guest position in accordance with some embodiments. The user interfaces in FIGS. 7A-7V are used to illustrate the processes described below, including the processes in FIG. 8. FIG. 9 is a flow diagram illustrating a process for displaying media based on context in accordance with some embodiments. The user interfaces in FIGS. 7A-7V are used to illustrate the processes described below, including the processes in FIG. 9. FIGS. 10A-10H illustrate exemplary user interfaces for displaying guest activity in accordance with some embodiments. FIG. 11 is a flow diagram illustrating a process for displaying a camera feed corresponding to guest position in accordance with some embodiments. The user interfaces in FIGS. 7A-7V and 10A-10H are used to illustrate the processes described below, including the processes in FIG. 11. FIG. 12 is a flow diagram illustrating a process for displaying media based on context in accordance with some embodiments. The user interfaces in FIGS. 7A-7V and 10A-10H are used to illustrate the processes described below, including the processes in FIG. 12.

FIG. 1 is a block diagram illustrating a computer system in accordance with some embodiments. While FIG. 1 illustrates one computer system, two or more computer systems working together can implement techniques described herein. It should be acknowledged that the computer system (e.g., computer system 100) is sometimes referred to as a device, an electronic device, an electronic system, a compute system, and/or a system. In some embodiments, computer system 100 is a personal computer system, a server system, a smart phone, a system on a chip, a smart watch, a wearable device, a tablet, a laptop computer, a fitness tracking device, a head-mounted display (HMD) device, a desktop computer, a communal device (e.g., a smart speaker, connected thermostat, and/or other home-based computer systems), an accessory (e.g., a switch, light, speaker, air conditioner, heater, window cover, fan, lock, media playback device, and/or television), a controller, a hub device, or a sensor.

As illustrated in FIG. 1, computer system 100 includes CPU subsystem 110, system memory 120, and I/O interface 130. Such components are able to communicate with one another through interconnect 150. In some embodiments, interconnect 150 is an electrical means of communication such as a system bus, one or more memory locations, and/or additional electrical channels for connecting multiple components of computer system 100.

It should be acknowledged that computer system 100 is only one example of a computer system to carry out techniques described below and that one or more other computer systems can carry out such techniques. Furthermore, while FIG. 1 illustrates a particular computer architecture of computer system 100, techniques described herein can be carried out by other computer architectures, such as by incorporating more, less, similar, and/or different components than the components illustrated.

In some embodiments, CPU subsystem 110 includes one or more processing units that can carry out techniques described herein. For example, CPU subsystem 110 can execute system-level and/or application-level instructions to perform an operation. In some embodiments, computer system 100 has several processing subsystems (e.g., multiple instances of CPU subsystem 110).

In some embodiments, CPU subsystem 110 is capable of carrying out instructions stored on a storage medium, such as a non-transitory or transitory computer-readable medium. A computer-readable storage medium (or many physical computer-readable storage media of one or more types) including one or more computer-readable instructions can be used to realize implementations falling partially or fully under the purview of the current disclosure. It should be acknowledged that computer-readable instructions can be arranged in any way, such as components, software, processes, widgets, and/or applications.

It should be acknowledged that the storage medium can be any medium that can physically include or store computer-executable instructions. For example, the storage medium can be temporary or non-temporary. Examples of storage medium include magnetic (e.g., hard drives and/or magnetic disks), optical (e.g., optical drives and/or optical discs based on CD, DVD, and Blu-ray technologies), solid state (e.g., solid state drives and/or flash drives), and/or semiconductor (e.g., random access memory) storages. In some embodiments, the storage medium is system memory 120. In such embodiments, each instruction stored by system memory 120 and executed by CPU subsystem 110 corresponds to an operation for completing functionality described herein. For example, instructions for processes 500, 600, 800, 900, 1100, and/or 1200 (e.g., as described above with respect to FIGS. 5-6, 8-9, and/or 11-12, respectively) can be stored in system memory 120.

In some embodiments, system memory 120 implements a range of distinct physical, non-transitory memory media. Examples of system memory 120 include a storage array, a storage area network (SAN), a removable flash drive, flash memory, hard disk storage, optical drive storage, floppy disk storage, removable disk storage, random access memory (such as SDRAM, DDR SDRAM, RAM-SRAM, EDO RAM, and/or RAMBUS RAM), and/or read-only memory (such as PROM and/or EEPROM). In some embodiments, computer system 100 has several memory components coupled, either directly or via interconnect 150, to CPU subsystem 110.

In some embodiments, computer system 100 communicates with external devices through I/O interface 130, which can be one or more types of interfaces. For example, I/O interface 130 can include a bridge chip that connects a front-side bus to one or more back-side buses. In some embodiments, I/O interface 130 allows communication through one or more appropriate buses or other interfaces with one or more I/O devices, such as I/O device 140. For example, I/O device 140 can include one or more: physical user-interface devices (e.g., a physical keyboard, a mouse, a button, a touch-sensitive surface, a rotatable component, and/or a joystick), storage devices (e.g., as described above with respect to system memory 120), network interface devices (e.g., to a local and/or wide-area network), sensor devices (e.g., a camera, a microphone, a motion detector, and/or a temperature sensor), audio output devices (e.g., speaker, audio jacks, and/or hearing loops), and/or visual output devices (e.g., screen, light, and/or projector). In some embodiments, I/O device 140 includes a network interface device that enables computer system 100 to establish a wired or wireless connection to a network or other computer systems. Examples of network interface devices include Ethernet, USB, Bluetooth, NFC, Wi-Fi, and/or Thunderbolt communication devices. In some embodiments, I/O device 140 is wired or wirelessly connected to I/O interface 130.

In some embodiments, a component of computer system 100 incorporates I/O device 140 with other components. For example, a single component can include I/O interface 130 and I/O device 140. In some embodiments, I/O device 140 is a discrete component, meaning it is not incorporated into another part of computer system 100. In some embodiments, functionality of different components is integrated into a component of computer system 100 that is composed of I/O interface 130 and I/O device 140. Additionally, it should be acknowledged that computer system 100 can include one or more I/O interfaces that connect to one or more I/O devices.

In some embodiments, I/O device 140 can be used to detect a subject (e.g., a user, a person, an animal, another computer system different from computer system 100, and/or an object) and/or an input (e.g., a verbal input, a tap input, a swipe input, a hold-and-drag input, a gaze input, an air-gesture input, a physical input and/or a passive input) from a detected subject. In some embodiments, a user has an account enabled by and/or linked to computer system 100, and computer system 100 can determine if a detected subject is a user with an account (e.g., a known user). Determining if a detected subject has an account includes identifying and/or authenticating the detected subject. In some embodiments, identifying and/or authenticating the detected subject includes comparing detected information to stored information about known users. For example, comparing detected information can include comparing biometric data (e.g., facial scans, iris scans, fingerprint scans, and/or voice recognition data) of detected subjects to stored biometric data of known users. For another example, comparing detected information can include comparing detected identification (e.g., MAC address and/or IP address) of a computer system of a detected subject to known identifications of computer systems of known users. For yet another example, comparing detected information can include comparing detected passcodes (e.g., usernames, passwords, passphrases, and/or PINs). In another example, computer system 100 can detect a known user (e.g., a user that corresponds to an account) and allow access to an environment when the user is identified. In some embodiments, computer system 100 detects unknown subjects and enables guest accounts for the unknown subjects to utilize computer system 100.

In some embodiments, computer system 100 collects information without the need for physical inputs via a sensor of I/O device 140. For example, computer system 100 can recognize subject inputs, including air-gesture inputs and/or passive inputs via a camera. In some embodiments, an air-gesture input is that is a detected intentional motion of a portion of the subject's body without the subject touching an input element in communication with or of the device. In some embodiments, a passive input is a detected input that is not purposefully directed at computer system 100 and/or a component in communication with computer system 100. Examples of passive inputs that can be detected by a camera include, but are not limited to, the subject entering an environment, the motion of the subject through an environment, the location of the subject in the environment, the direction the subject is looking and/or facing, and/or light levels of the environment. In some embodiments, computer system 100 can send visual and/or video data to an application from one or more cameras. For example, computer system 100 can send video data to an application for the purpose of making a video phone call. For another example, computer system 100 can detect the sound of a subject talking, glass breakings, and/or music playing via a microphone of I/O device 140. In some embodiments, computer system 100 recognizes speech as verbal a input from a subject that are detected via a microphone.

In some embodiments, computer system 100 detects information about the environment via other types of sensors of I/O device 140. Examples of such sensors include a flow sensor, a gas sensor, a humidity sensor, a chemical sensor, a contact sensor, a precipitation sensor, a pressure sensor, a proximity sensor, a motion sensor, an occupancy sensor, an electricity sensor, and/or a flood sensor.

In some embodiments, computer system 100 detects a physical input via a physical user-interface device of I/O device 140 that allow a subject to communicate with computer system 100 directly. In some embodiments, computer system 100 includes one or more input devices as described above, and data from one input device is combined with data from one or more other input devices (e.g., that are a part of computer system 100 and/or other computer systems) to gather information about the physical environment.

In some embodiments, computer system 100 outputs visual information via a component of I/O device 140, such as a display screen, a projector, a touch-sensitive display, and/or a light. For example, I/O device 140 can include a light to indicate a status of computer system 100, such as an on/off status. For another example, I/O device 140 can include a display screen for displaying user interface elements. In some embodiments, “outputting” visual information includes sending data (e.g., image and/or video data) to an external display component via a wired or wireless connection, causing the external display component can display the visual information.

In some embodiments, computer system 100 emits sound via an audio output device of I/O device 140, such as a speaker, a headphone, an earbud, an audio jack, an optical audio output, a Bluetooth audio output, an HDMI audio output, and/or a hearing loop. For example, computer system 100 can provide a subject with information and/or audio-based content via speakers of I/O device 140.

In some embodiments, I/O device 140 includes a tactile output device. For example, I/O device 140 can include a haptic element that allows computer system 100 to communicate with a subject who is in close proximity to or in physical contact with computer system 100.

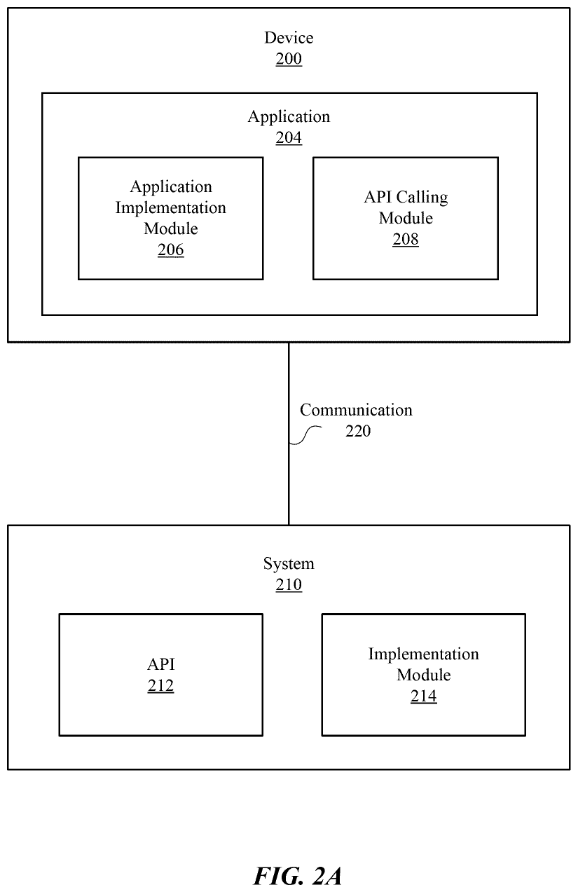

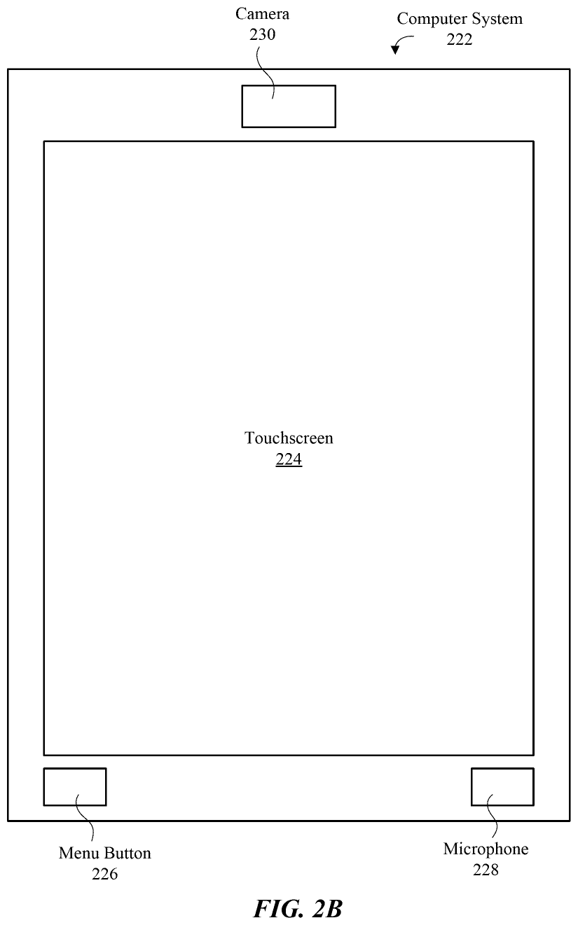

FIG. 2A is a block diagram illustrating a device and a system in accordance with some embodiments. In some embodiments, device 200 is a personal computing device, a server system, a smart phone, a smart watch, a tablet, a laptop computer, a fitness tracking device, a head-mounted display (HMD) device, a desktop computer, a communal device (e.g., a smart speaker, connected thermostat, and/or other home-based computer systems), an accessory (e.g., a switch, light, speaker, air conditioner, heater, window cover, fan, lock, media playback device, and/or television), a controller, a hub device, or a sensor. In some embodiments, system 210 is an operating system hosted on device 200. In some embodiments, system 210 is an operating system hosted on an external device (e.g., a server, a peripheral device, an accessory, and/or a personal computing device). It should be acknowledged that device 200 and/or system 210 can include more, fewer, and/or different components than illustrated in FIG. 2A.

As illustrated in FIG. 2A, device 200 includes an application (e.g., application 204) that, when executed by one or more processing units, causes device 200 to perform one or more processes and/or methods described herein. In some embodiments, application 204 is an application that is pre-installed on device 200 by a manufacture of device 200 (e.g., a first-party application). In some embodiments, application 204 is an application that is provided to device 200 via an operating system update file (e.g., a first-party application or a second-party application). In some embodiments, application 204 is an application that is installed by a user of device 200, such as through an application store installed on device 200. It should be acknowledged that application 204 can be any suitable type of application such a browser application, a fitness application, a health application, a digital payments application, a media application, a social network application, a messaging application, a maps application, and/or an application that functions as an execution environment for plug-ins, widgets and/or other applications. In some embodiments, application 204 causes device 200 to perform processes 500, 600, 800, 900, 1100, and/or 1200 (e.g., as described above with respect to FIGS. 5-6, 8-9, and/or 11-12, respectively).

In some embodiments, a software platform has a set of frameworks that provide objects and/or behaviors that a software developer uses to build applications on the software platform. Software developers use the set of frameworks to display and/or interact with content, and/or manage interactions with the software platform. In some embodiments, an application relies on the set of frameworks for their behavior. In such embodiments, the set frameworks can provide different ways for the software developer to customize behavior of the application to match specific needs of the application.

In some embodiments, interaction with a device includes transfer and/or receipt of one or more API calls between multiple different software processes (e.g., different portions of an operating system, an application and an operating system, or different applications) via one or more APIs. For example, when an input is detected, raw sensor data can be processed into one or more input events that are provided (e.g., via an API) to a receiving software process that makes some determination based on the one or more input events, and then sends (e.g., via an API) information to a software process to perform an operation (e.g., change a device state and/or user interface).

In some embodiments, an object and/or a behavior is accessed via an API, specifying a format for communication between processes, including specifying and grouping available protocols, variables, and/or functions. For example, an API call, sometimes referred to as an API request, can be sent from a first software process to a second software process as a way to accomplish different things. The first software process can request information from the second software process. The first software process can provide information to the second software process. The first software process can request action by the second software process. The first software process can provide information to the second software process about action taken by the first software process.

In some embodiments, while a determination and an operation performed in response can be made by the same software process, alternatively, a determination can be made in a first software process and relayed (e.g., via an API) to a second software process different from the first software process. Relaying the determination can cause an operation to be performed by the second software process. Alternatively, the second software process can relay one or more instructions (e.g., via an API) to a third software process different from the first software process and/or the second software process. The one nor more instructions can be to perform an operation.

It should be acknowledged that some or all subject interactions with a computer system can involve one or more API calls within a step of interacting with the computer system, such as between different software components of the computer system or between a software component of the computer system and a software component of one or more remote computer systems.

As illustrated in FIG. 2A, application 204 includes application implementation module 206 and API calling module 208. In some embodiments, application implementation module 206 includes a set of one or more instructions corresponding to one or more operations performed by application 204. For example, when application 204 is a messaging application, application implementation module 206 can include operations to receive and send messages.

In some embodiments, API calling module 208 is a module that can receive application programming interface (API) calls, respond to API calls, and/or send API calls. In some embodiments, application implementation module 206 communicates with API calling module 208 to communicate with a system, such as system 210. In some embodiments, communication 220 represents one or more API calls and/or one or more other forms of communication between device 200 (e.g., one or more components of device 200) and system 210 (e.g., one or more components of system 210).

As illustrated in FIG. 2A, system 210 includes API 212 and implementation module 214. In some embodiments, API 212 is a software and/or hardware module that can receive API calls, respond to API calls, and/or send API calls. In some embodiments, API 212 is a software module (e.g., a collection of computer-readable instructions) that provides an interface that allows a different module (e.g., API calling module 208) to access and/or use one or more functions, methods, procedures, data structures, classes, and/or other services provided by implementation module 214. For example, API calling module 208 can make an API call to API 212 to access and use a feature of implementation module 214 that is specified by API 212. In some embodiments, API 212 is implemented in part by firmware, microcode, or other low-level logic that executes in part on the hardware component.

In some embodiments, API calling module 208 passes data and/or controls information within implementation module 214 through the one or more API calls via API 212. In some embodiments, API 212 includes one or more features for translating API calls and returns between implementation module 214 and API calling module 208, which allows multiple API-calling modules written in different programming languages to communicate with implementation module 214. For example, API calling module 208 can call using APIs from different providers such as a set of APIs from an OS provider, another set of APIs from a plug-in provider, and/or another set of APIs from another provider (e.g., the provider of a software library) or creator of the other set of APIs.

In some embodiments, implementation module 214 is a system (e.g., operating system, and/or server system) software module that is constructed to perform an operation in response to receiving an API call via API 212. In some embodiments, implementation module 214 is constructed to provide an API response (via API 212) as a result of processing an API call. In some embodiments, implementation module 214 is embodied at least in part in firmware, microcode, or hardware logic. In some embodiments, implementation module 214 calls one or more other components via an underlying API and thus is both an implementation module and an API calling module similar to API calling module 208. For example, implementation module 214 and API calling module 208 can each be any one of an operating system, a library, a device driver, an API, an application program, or other module. It should be acknowledged that implementation module 214 and API calling module 208 can be the same or different type of module from each other.

In some embodiments, various API calls are transferred between API calling module 208 and implementation module 214. It should be acknowledged that transferring API calls can include issuing, initiating, invoking, calling, receiving, returning, and/or responding to a function of calls or messages. In other words, transferring API calls can describe actions by either API calling module 208 or implementation module 214. In some embodiments, in response to an API call from API calling module 208, implementation module 214 returns (via API 212) a value to report to application 204 the capabilities or state of a hardware component of device 200, such as input capabilities and state, output capabilities and state, processing capability, power state, storage capacity and state, and/or communications capability.

In some embodiments, implementation module 214 provides more than one API, with different APIs supplying different aspects of functionality performed by implementation module 214 while protecting some aspects of functionality from view. For example, one API of implementation module 214 can provide a first set of functions and can be exposed to third-party developers while another API of implementation module 214 can be hidden (e.g., not exposed) and provide a subset of the first set of functions and/or provide a different set of functions, such as testing or debugging functions which are not in the first set of functions. It should be acknowledged that implementation module 214 can include additional functions, methods, classes, data structures, and/or other features that are not specified through API 212 and are not available to API calling module 208. In some embodiments, implementation module 214, API 212, and/or API calling module 208 are stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, in response to and/or after receiving information from one or more hardware components of device 200, one or more software modules of device 200, and/or one or more hardware components external to device 200 (e.g., a peripheral device, an accessory device, and/or a server), application 204 executes a task with the information. In some embodiments, the tasks executed include: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling API 212 of system 210 based on the information. In some embodiments, after receiving the information, application 204 executes the task in response to a trigger, such as a detection of an event, a notification received from system 210, an input, and/or a response to a call to an API provided by system 210.

In some embodiments, application 204 calling API 212 (e.g., as part of a task executed by application 204 in response to and/or after receiving information) includes using one or more parameters defined by API 212. In some embodiments, the one or more parameters include a constant, a key, a data structure, an object, an object class, a variable, a data type, a pointer, an array, a list or a pointer to a function or method, and/or another way to reference a data or other item to be passed via API 212.

In some embodiments, in response to and/or after receiving the information, application 204 transfers the information to system 210 via communication 220. In some embodiments, after receiving the information, application 204 transfers the information to system 210 in response to a trigger.

FIG. 2B illustrates a computer system with a touch screen in accordance with some embodiments. In some embodiments, computer system 222 is a portable multifunction device that is a personal device of a user. It should be acknowledged that computer system 222 can be computer system 100 and/or device 200 as described above.

As illustrated in FIG. 2B, computer system 222 includes touch screen 224, touch screen 230, menu button 226, and microphone 228. In some embodiments, computer system 222 displays, via touch screen 224, a user interface (UI) including one or more user interface elements, such as controls, graphics, and/or content. Computer system 222 can then detect an input, such as a tap input using a finger of a user or a stylus, on a user interface element to select the user interface element. In some embodiments, the user interface element is selected when touch screen 223 no longer detects the input.

In some embodiments, microphone 228 is an input device for detecting sounds near computer system 222, including verbal inputs from a user. For example, computer system 222 can detect a subject making a verbal request and/or command to computer system 222 via microphone 228. In some embodiments, computer system 222 collects data and/or information about a subject via microphone 228. For example, computer system 222 can confirm an identity of a subject by matching a verbal input of the subject to a voice profile of a user. At FIG. 2B, microphone 228 is part of computer system 222. In some embodiments, microphone 228 is not part of but is in communication (e.g., via a wired and/or wireless communication) with computer system 222.

In some embodiments, camera 230 is an input device that includes an image or video sensor (such as one or more optical sensors and/or one or more depth sensors) that allows computer system 222 to detect objects and/or inputs (e.g., hand and/or air-gesture inputs) near computer system 222. In some embodiments, computer system 222 collects data and/or information about a subject via camera 230. For example, computer system 222 can confirm an identity a subject by matching a facial scan of a subject to a biometric profile of a user. At FIG. 2B, camera 230 is part of computer system 222. In some embodiments, camera 230 is not part of computer system 222 but is in communication (e.g., via a wired and/or wireless connection) with computer system 222. In some embodiments, camera 230 is always on and continuously capturing images (e.g., periodically and/or without interruption). In some embodiments, camera 230 begins to capture an image when an input and/or interaction is detected.

In some embodiments, menu button 226 is a physical button that, when depressed, provides a physical input for computer system 222. In some embodiments, touch screen 224 and/or menu button 226 are used for turning computer system 222 on and off and/or locking it. For example, menu button 226 can be used to lock computer system 222 by pressing and releasing menu button 226 before a predetermined amount of time (e.g., 2-10 seconds) has passed. For another example, menu button 226 can be used to unlock computer system 222 or start an unlocking process, or to turn computer system 222 on or off by pressing and holding menu button 226 in the depressed state for longer than the predetermined amount of time. In some embodiments, microphone 228 allows computer system 222 to detect a verbal input for turning on or off certain features. Additionally, computer system 222 can optionally have one or more tactile output devices to provide tactile outputs (e.g., haptic outputs) to the user and/or one or more contact intensity sensors to detect the intensity of contacts on touch screen 224

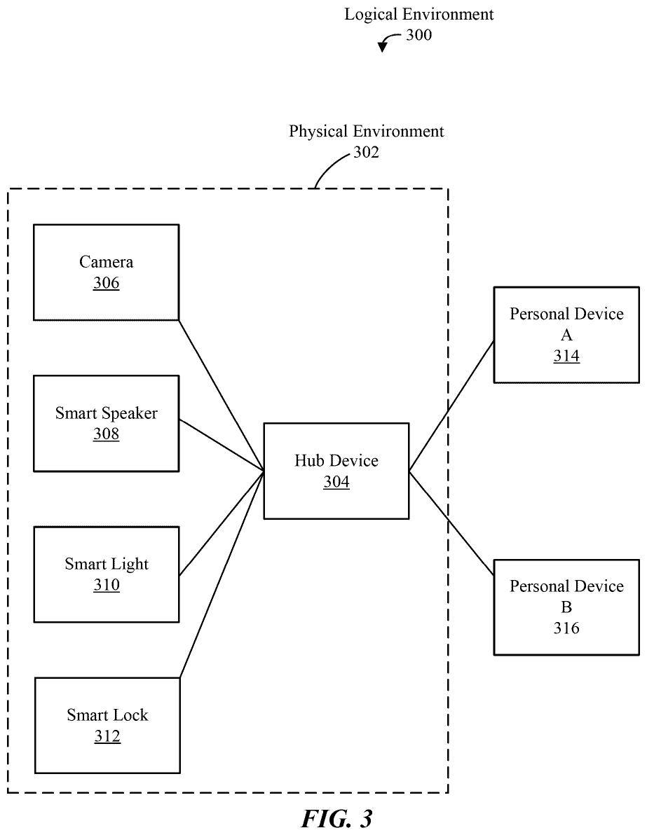

FIG. 3 is a block diagram illustrating a logical environment in accordance with some embodiments. As illustrated in FIG. 3, logical environment 300 includes multiple devices that are in communication (e.g., wired and/or wirelessly) with each other. In some embodiments, logical environment 300 is a software-defined construct that represents state, capabilities, and/or permissible interactions of devices within logical environment 300. For example, logical environment 300 can maintain a data model including (1) unique identifiers for different devices and/or assigned roles for each device, (2) a capability map describing supported functions and/or data formats, (3) a relationship graph indicating pairing status, hierarchy, and/or authorized communication paths, (4) contextual state parameters such as operating modes, user profiles, and/or session data, and/or (5) policy constraints that govern security, power management, and/or permissible commands. In some embodiments, logical environment 300 enables controller devices (e.g., hub device 304, personal device A 314, and/or personal device B 316) to discover, address, control, and/or configure accessory devices (e.g., camera 306, smart speaker 308, smart light 310, smart lock 312, and/or hub device 304). In such embodiments, logical environment 300 can be independent of underlying physical transports and/or physical location. In some embodiments, logical environment 300 includes a server. In such embodiments, a server is a remotely accessible digital storage system capable of communicating with devices within logical environment 300.

As illustrated in FIG. 3, logical environment 300 includes (e.g., involves) devices within physical environment 302 (e.g., camera 306, smart speaker 308, smart light 310, smart lock 312, and hub device 304). In some embodiments, physical environment 302 is a physical location, such a home, an office building, a warehouse, and/or an apartment building. It should be acknowledged that techniques described herein can be used with any type of physical location.

In some embodiments, the devices within logical environment 300 work together using one or more of the techniques described herein for detecting an activity in, interacting with, capturing sensor data related to, and/or communicating data about physical environment 302. Such control and/or communication can be via a homeowner and/or administrator of physical environment 302 and/or logical environment 300. In some embodiments, detecting an activity includes detecting and/or identifying a subject within physical environment 302. In some embodiments, in response to detecting the activity, a device (e.g., camera 306, smart speaker 308, smart light 310, smart lock 312, and/or hub device 304) within physical environment 302 captures sensor data in physical environment 302 and/or performs an operation. In such embodiments, the operation can includes allowing or denying a subject access to all or part of physical environment 302, turning on a light, and/or playing music.

At FIG. 3, devices illustrated within the dashed box of physical environment 302 are located within physical environment 302. Such devices include hub device 304, camera 306, smart speaker 308, smart light 310, and smart lock 312. In some embodiments, such devices and are in communication via one or more local area networks (e.g., WiFi and/or ethernet), one or more personal area network (e.g., Bluetooth, Zigbee, and/or Thread), one or more wide area networks (e.g., Internet and/or cellular), and/or one or more peer-to-peer connections.

At FIG. 3, devices illustrated outside the dashed box of physical environment 302 are located outside of physical environment 302 or are mobile with the ability to be inside or outside of physical environment 302. Such devices include personal device A 314 and personal device B 316. It should be acknowledged that logical environment 300 and physical environment 302 are described for explanatory purposes and that techniques described below can be carried out with more, less, similar, and/or different devices than the devices and/or the configurations discussed above.

In some embodiments, hub device 304 is a stationary or semi-stationary computer system that communicates with accessory devices located within physical environment 302 including, but not limited to, camera 306, smart speaker 308, smart light 310 and/or smart lock 312. In some embodiments, hub device 304 communicates with one or more accessory devices on behalf of (e.g., communicates information to and/or from) one or more controller devices, such as personal device A 314 and/or personal device B 316. In some embodiments, hub device 304 provides centralized coordination, routing, and/or persistent data storage for physical environment 302. In some embodiments, hub device 304 includes a component for detecting other devices, such as a camera, a microphone, and/or Bluetooth and/or Ultra-Wideband (UWB) component. While hub device 304 is depicted in FIG. 3 as a single device, the functionality described below can be implemented with two or more resident devices operating together. Examples of hub device 304 include a smart speaker, a set-top box, a router, a home-automation bridge, a television, and/or a desktop computer.

In some embodiments, hub device 304 communicates with devices outside of physical environment 302. For example, hub device 304 can communicate with other hub devices that belong to different environments. For another example, hub device 304 can communicate with other accessory devices and/or other controller devices. In such embodiments, hub device 304 communicates with other devices through one or more communication channels described above (e.g., a local area network, a personal area network, a peer-to-peer connection, and/or a wide area network).

In some embodiments, hub device 304 includes and/or is in communication with one or more cameras with which hub device 304 can capture an image and/or a video of a subject and/or activity within physical environment 302. In some embodiments, hub device 304 includes and/or is in communication with one or more microphones with which hub device 304 can detect noise (e.g., glass breaking, an alarm going off, and/or a subject talking) within physical environment 302. In some embodiments, a microphone enables hub device 304 to detect verbal inputs from a subject, enabling the subject to interact with hub device 304 without making physical contact with hub device 304 or another computer system within physical environment 302.

In some embodiments, hub device 304 includes and/or is in communication with one or more sensors. In some embodiments, a sensor includes a hardware component capable of detecting (e.g., sensing and/or processing) information about physical environment 302 in proximity to the hardware component. For example, a sensor can be configured to detect information surrounding the sensor, detect information in one or more directions away from the sensor, and/or detect information based on contact of the sensor with an element of physical environment 302. In some embodiments, a hardware component of a sensor includes a sensing component (e.g., a temperature and/or image sensor), a transmitting component (e.g., a radio transmitter and/or laser transmitter), and/or a receiving component (e.g., a radio receiver and/or laser receiver). It should be acknowledged that a sensor can be multiple types of sensors. For example, a sensor can be an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a motion sensor, a range or depth sensor (e.g., RADAR and/or LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. In some embodiments, hub device 304 combines data from multiple sensors to generate information about physical environment 302.

In some embodiments, hub device 304 includes and/or is in communication with one or more speakers that can output audio content into physical environment 302. In some embodiments, hub device 304 includes and/or is in communication with one or more display component, such as a display, a projector, a touch-sensitive display, a head-mounted display (HMD), and/or another device component that presents visual content to a subject. In some embodiments, hub device 304 includes and/or is in communication with a touch-sensitive surface (such as a touchpad or a touch screen display) from which hub device 304 detects inputs.

In some embodiments, camera 306 is a computer system for capturing and/or recording images in the form of digital photos and/or videos. In some embodiments, camera 306 includes and/or is in communication with one or more sensors, such as those mentioned above with respect to hub device 304. In some embodiments, camera 306 captures an image and/or a video continuously and/or in response to detecting an activity via a sensor. In some embodiments, camera 306 combines data from multiple sensors (e.g., that are part of camera 306 and/or one or more additional devices in communication with camera 306) to generate information about physical environment 302. While camera 306 is presented as an individual device, it should be acknowledged that camera 306 can represent multiple devices capable of capturing images and/or videos. For example, camera 306 can include cameras positioned to observe important areas of physical environment 302, such as an entrance, a hallway, and/or a living room area.

In some embodiments, smart speaker 308 is a computer system that converts electrical signals into sound and includes one or more components for outputting audio, such as speakers, audio distributors, soundbars, headphones, earphones, earbuds, television speakers, HMD speakers, audio jacks, optical audio outputs, Bluetooth audio outputs, and/or HDMI audio outputs. For example, smart speaker 308 can output audio content to provide information to a subject. In some embodiments, smart speaker 308 includes one or more microphones that can be used by smart speaker 308 to obtain data and/or information from a subject and/or about physical environment 302. For example, smart speaker 308 can detect if a subject is in the room by detecting a subject talking via a microphone. In some embodiments, the information that smart speaker 308 obtains via the microphone includes verbal inputs from a subject. For example, a subject can request smart speaker 308 to perform an action and/or obtain information for the subject. While smart speaker 308 is presented as an individual device, it should be acknowledged that smart speaker 308 can represent multiple devices capable of outputting audio.

In some embodiments, smart light 310 is a computer system for outputting light and includes one more components for outputting light, such as an incandescent, LED, fiber optic, fluorescent, halogen, and/or neon light. In some embodiments, smart light 310 includes and/or is in communication with one or more sensors, such as those mentioned above with respect to hub device 304. In some embodiments, smart light 310 outputs light or ceases outputting light in response to detecting an activity via a sensor. For example, smart light 310 can turn on in response to detecting a sound via a microphone. For another example, smart light 310 can turn off in response to detecting light from another light source via a light sensor. While smart light 310 is presented as an individual device, it should be acknowledged that smart light 310 can represent multiple devices capable of outputting light.

In some embodiments, smart lock 312 is a computer system for locking and unlocking an area and includes one or more components for such locking, such as a deadbolt, mortise, electromagnet, and/or latch lock. In some embodiments, smart lock 312 includes and/or is in communication with one or more sensors, such as those mentioned above with respect to hub device 304, and locks or unlocks in response to detecting an activity via a sensor. For example, smart lock 312 can lock in response to detecting a contact sensor close, indicating that a door has closed. In some embodiments, smart lock 312 includes and/or is in communication with an input component capable of detecting physical inputs, such as a physical input mechanism (e.g., one or more buttons) and/or a touch sensitive surface and/or screen, and locks or unlocks in response to detecting inputs via the input component. For example, smart lock 312 can unlock in response to detecting a correct PIN code being entered via the input component. In some embodiments, smart lock 312 includes a component for detecting other devices, such as Bluetooth, UWB, and/or Near Field Communication (NFC) component, and locks or unlocks in response to detecting another device. For example, smart lock 312 can unlock in response to detecting, via UWB, a personal device of a user approach smart lock 312. While smart lock 312 is presented as an individual device, it should be acknowledged that smart lock 312 can represent multiple devices capable of locking and unlocking areas.

Personal device A 314 and personal device B 316 are computer systems belonging to users and/or groups of users. For example, personal device A 314 and/or personal device B 316 can be a smart phone, a tablet, a smart watch, a laptop, a communal device, a personal gaming system, a desktop computer, a fitness tracking device, and/or an HMD. In some embodiments, personal device A 314 and personal device B 316 are the same type of device. For example, both personal device A 314 and personal device B 316 can both be smart phones. In other embodiments, personal device A 314 and personal device B 316 are different types of devices. For example, personal device A 314 can be a smartwatch while personal device B 316 can be a smart phone.

In some embodiments, one or more devices within logical environment 300 communicate with hub device 304 about an activity detected within physical environment 302. For example, in response to unlocking, smart lock 312 can communicate the unlocking to hub device 304. In some embodiments, in response to a device communicating a detected activity, hub device 304 captures a photo and/or a video of physical environment 302 (e.g., via camera 306 and/or a camera of hub device 304). For example, in response to smart speaker 308 communicating about detecting a noise, hub device 304 can send a command to camera 306 to capture video of physical environment 302 near smart speaker 308. In some embodiments, one or more devices within logical environment 300 send information (e.g., images, video, audio, inputs and/or status updates from sensors) regarding an activity to hub device 304 and, in response, hub device 304 analyzes the information. For example, when camera 306 captures a video in response to detecting motion (e.g., as discussed above), camera 306 can send the video to hub device 304 to analyze. For example, hub device 304 can analyze a captured image of physical environment 302 that includes smoke and determine a fire is in physical environment 302.

In some embodiments, devices outside of hub device 304 analyze data to make determination. For example, camera 306 can determine an identity of a subject within an image and send the identity to hub device 304 rather than sending the image. For another example, in response to smart lock 312 detecting the presence of a personal device of a user (e.g., personal device A 314), hub device 304 can request camera 306 to capture an image. After capturing the image, camera 306 can identify a subject in the image to determine whether the image includes the user.

In some embodiments, after a subject is identified (e.g., such as using camera 306 as described above), hub device 304 initiates an authentication process to authenticate the subject. The authentication process can verify and/or confirm the identity of the subject in physical environment 302. For example, if the subject is registered with hub device 304, in conjunction with identifying the subject (e.g., via camera 306 as described above), hub device 304 communicates with a personal device (e.g., personal device A 314 or personal device B 316) registered to the subject through wireless signal (e.g., UWB signal, Bluetooth signal, and/or Wi-Fi signal) to authenticate the subject. In some embodiments, hub device 304 captures and/or receives multiple types of information at once and is able to identify and authenticate the subject simultaneously. For example, in a scenario where the subject in physical environment 302 is speaking while being within the field-of-view of camera 306, hub device 304 can identify the subject using an image captured via camera 306 using facial recognition and authenticate the subject using audio captured via smart speaker 308 to match voice biometrics. In some embodiments, hub device 304 receives an authentication key (e.g., PIN code and/or key fob authenticator) for a user (such as when the user enters the authentication key at smart lock 312) and uses the fact that the authentication key corresponds to same user as detected in physical environment 302 via another device, such as camera 306, to authenticate the user.

In some embodiments, when a subject is identified and not authenticated, hub device 304 sends an authentication request to a personal device (e.g., personal device A 314 or personal device B 316) of the subject. For example, hub device 304 can send a request for a facial scan and/or a PIN to personal device A 314, and consider the subject authenticated upon receiving a notification from personal device 412 that correct information has been entered and/or received. In some embodiments, hub device 304 sends an authentication request to a personal device detected within physical environment 302.

In some embodiments, personal device B 316 is a personal device (e.g., phone, watch and/or tablet) belonging to an administrator (e.g., a resident, owner, and/or caretaker) of logical environment 300. Personal device B 316 can be in communication with hub device 304, and allow the administrator to view and/or remotely control aspects of logical environment 300, such as managing camera views and/or visitor access. In some embodiments, in response to detecting an inquiry (e.g., “Who is at the door?” and/or “Is anyone home?”), personal device B 316 sends a request to hub device 304 to capture an image (e.g., via camera 306) and send the image to personal device B 316. It should be acknowledged that communication between devices within physical environment 302 and personal device B 316 can occur even when personal device B 316 is outside physical environment 302, such as through a secure outside internet or cellular connection.

In some embodiments, hub device 304 sends a notification to personal device B 316 in response to detecting (e.g., directly and/or via another device of ecosystem 400) an activity. For example, hub device 304 can send a notification to personal device B 316 in response to not being able to identify a subject detected in physical environment 302. In some embodiments, the notification sent by hub device 304 to personal device B 316 includes information corresponding to a time and/or a location that the activity and/or subject was detected. In some embodiments, the notification includes an image and/or a video of the activity. For example, the notification can include a video of smoke filling a room where smoke was detected. In some embodiments, the notification includes identifying information (e.g., name, photo, and/or video) of the subject in physical environment 302. In some embodiments, hub device 304 sends a notification without sending images to personal device B 316. For example, an administrator might want to be notified if someone they recognize is at the front door without showing a video feed of a camera at the front door. For another example, the notification might not require an image, such as a notification that a thermostat has detected a temperature outside of a predetermined range. In other embodiments, hub device 304 does not send a notification if certain identified subjects are detected, thus avoiding unnecessary notifications (e.g., an administrator might not care to be notified if their spouse or roommate is detected at the front door).

In some embodiments, the notification sent by hub device 304 to personal device B 316 includes an option to authenticate a detected subject via the notification (e.g., a control within the notification and/or an application corresponding the notification). In some embodiments, if the detected subject is identified, the notification includes a control to initiate communication (e.g., text and/or call) with the detected subject. In some embodiments, the notification includes a control to initiate communication with a subject detected in physical environment 302 via smart speaker 308. In some embodiments, the notification includes escalation options such as a control contacting emergency services. In some embodiments, the administrator corresponding to personal device B 316 creates a profile for a subject in physical environment 302 that automatically authenticates the subject.

In some embodiments, devices within physical environment 302 output content to communicate information to a subject within physical environment 302. For example, in response to a subject being identified but not authenticated, hub device 304 can output via smart speaker 308 a request for the subject to authenticate themselves. For another example, in response to detecting a door being opened, hub device 304 can indicate the door is opened by outputting light via smart light 310 near the door. In some embodiments, devices within physical environment 302 output content to communicate an event escalation. For example, in response to personal device B 316 detecting an input on the control to contact emergency services (e.g., as described above), smart light 310 can flash its lights and smart speaker 308 can output alarm noises.

In some embodiments, hub device 304 allows communication with administrators of logical environment 300. For example, a person in physical environment 302 can request to call an administrator of logical environment 300 (e.g., initiate a call to personal device B 316) to request access to physical environment 302 and/or devices within physical environment 302. In some embodiments, hub device 304 detect such a request directly or via an input on a personal device (e.g., personal device A 314). In such embodiments, the administrator can give allowance to subject in physical environment 302 and personal device B 316 communicates to hub device 304 that the subject in physical environment 302 has been authenticated.

In some embodiments, after the subject in physical environment 302 is identified and authenticated, hub device 304 enables the subject access to physical environment 302 and/or one or more devices with physical environment 302. In some embodiments, hub device 304 enables the subject access to physical environment 302s for a predefined amount of time (e.g., 1 hour to 10 days). In such embodiments, the predefined amount of time can vary depending on the type of authorization provided to the subject. For example, a guest of physical environment 302 can have access for less time than a temporary resident of physical environment 302.

In some embodiments, data about activities detected within physical environment 302 is recorded and stored. Some or all of such activity data can be stored locally (e.g., via hub device 304) and/or remotely (e.g., via a server). Storing activity data can allow an administrator of physical environment 302 to review a history of activity in physical environment 302.

Reference is made herein to environmental context (also referred to herein as a “context of an environment” and/or “a context corresponding to an environment”). In some embodiments, an environmental context is a context based on one or more characteristics of physical environment 302 (e.g., subjects, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) by detecting input (e.g., via one or more input devices) and/or receiving data (e.g., from one or more other devices and/or components in communication with the device).

Reference is made herein to user context (also referred to herein as a “context of a user” and/or “a context corresponding to a user”). In some embodiments, a user context is a context based on one or more characteristics of a user. For example, a user context can include a subject's appearance and/or clothing, personality, actions, behavior, movement, location, and/or pose. In some embodiments, a device (e.g., using an agent) determines a user context (e.g., to be currently true, occurring, and/or applicable) by detecting input (e.g., via one or more input devices) and/or receiving data (e.g., from one or more other devices and/or components in communication with the device). In some embodiments, a device determines user context based on historical context and/or learned characteristics of the subject, where one or more characteristics of the subject are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include an internal state of the device (and/or of one or more components of the device), an internal dialogue of the device (e.g., the device's understanding of a context), operations being performed by the device, applications and/processes that are executing (e.g., running and/or open) on the device. In some embodiments, a device (e.g., using an agent) determines an operational context (e.g., to be currently true, occurring, and/or applicable) by detecting input (e.g., via one or more input devices) and/or receiving data (e.g., from one or more other devices and/or components in communication with the device). In some embodiments, a device (e.g., using an agent) determines an operational context (e.g., to be currently true, occurring, and/or applicable) by assessing one or more internal states (e.g., accessed, retrieved, and/or queried by a process of the device).

Reference is made herein to “performing output,” “causing output,” “outputting,” and/or similar phrases. Such phrases can be interchangeable and/or include computer system itself performing such output or causing another computer system perform such output. Reference is made herein to “displaying,” “causing display of,” “outputting visual content,” and/or similar phrases. Such phrases can be interchangeable and/or include computer system itself displaying or causing another computer system perform such display. Reference is made herein to “outputting audio,” “causing output of audio,” “providing audio output,” and/or similar phrases. Such phrases can be interchangeable and/or include computer system itself outputting audio or causing another computer system perform such output.

Attention is now directed towards embodiments of user interfaces (“UI”) and associated processes that are implemented on an electronic device, such as computer system 100, device 200, computer system 222, hub device 304, camera 306, smart speaker 308, smart light 310, smart lock 312, personal device A 314, or personal device B 316.

FIGS. 4A-4F illustrate exemplary user interfaces for monitoring guests in accordance with some embodiments. The user interfaces in these figures are used to illustrate the processes described below, including the processes in FIGS. 5-6.

In some embodiments, monitoring a guest is performed by an administrator of a location receiving a notification of a resident and/or a guest at the location. In such embodiments, the location can be any environment, such as a house, apartment, outside area, a room, and/or a business. In some embodiments, the location includes one or more accessories in communication with one or more controllers, such as a personal device of the administrator, a resident device of the location, and/or a server. Examples of the one or more accessories include a camera, a speaker, a television, and a lock. In some embodiments, the one or more accessories are in communication with the resident device, which is in communication with one or more other controllers that are configured to control the one or more accessories via the resident device. For example, a camera accessory can detect a guest and communicate with the resident device that the guest has been detected without communicating any media captured via the camera accessory. In such an example, in response to receiving the communication that the guest has been detected, the resident device can communicate with a personal device (e.g., computer system 400) of the administrator to notify the personal device that the guest has been detected. In some embodiments, in response to receiving a notification, the administrator is able to monitor the guest at the location. In such embodiments, monitoring the guest can include monitoring guest activities and/or contacting the guest. As will be discussed further below with reference to FIGS. 4B and 4D, the administrator can view guest activity (e.g., devices used and/or places visited at the location) and/or contact the guest that is detected at the location. For the purposes of this application, an activity is an action performed by a guest within the location and detected by the resident device.

In some embodiments, an administrator is a resident of the location with control of access to the location and/or to the one or more accessories in the location for others. In some embodiments, a resident is a person and/or a device with access to the location and/or to the one or more accessories in the location but does not have control of access for others. In some embodiments, similar to a resident, a guest is a person and/or a device without control of access for others. In such embodiments, the guest might have different access to the location and/or to the one or more accessories in the location than a resident.

FIGS. 4A-4F illustrate computer system 400 as a smart phone. It should be recognized that computer system 400 can be other types of computer systems such as a tablet, a smart watch, a laptop, a communal device, an accessory, a personal gaming system, a desktop computer, a fitness tracking device, and/or a head-mounted display (HMD) device. In some embodiments, computer system 400 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 400 includes and/or is in communication with one or more output devices (e.g., a display screen, a projector, a touch-sensitive display, and/or a speaker).

While the examples in FIGS. 4A-4F include computer system 400 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras. In some embodiments, another computer system within the environment detects one or more inputs.

At FIG. 4A, a camera (e.g., separate from computer system 400 and, in some embodiments, not in communication with computer system 400 but rather only in communication with a resident device of the location) (e.g., the camera accessory) detects a first guest (e.g., Sandra) at the location. In response to detecting the first guest at the location, the camera attempts to identify the first guest. In some embodiments, the camera attempts to identify the first guest by recognizing the first guest through visual, auditory, and/or other biometric information captured by the camera. For example, the camera can attempt to identify the first guest by comparing an image and/or a video of the first guest with images of known users. In other embodiments, the camera attempts to identify the first guest by attempting to communicate with a personal device of the first guest to receive identity information from the personal device. Such communication can be via Bluetooth, WiFi, Thread, NFC, UWB, and/or another type of communication. It should be recognized that other techniques can be used to identify the first guest.

At FIG. 4A, the camera was able to identify the first guest as Sandra and, in response, sends a communication indicating that the first guest is Sandra to the resident device. In response to receiving the communication that the first guest is Sandra, the resident device communicates to computer system 400 the indication that Sandra is at the location.

In some embodiments, where a guest cannot be identified via the camera, the resident device can attempt to identify the first guest using other accessories. For example, if the camera is unable to identify the guest, the resident device can output a request for the first guest to verify using a PIN code and/or bring a personal device of the guest near the resident device. For another example, if the guest does not have a valid PIN code, the resident device may use a microphone to authenticate a user biometrically, by matching the voice of the guest to known voices of the guest.

As illustrated in FIG. 4A, computer system 400 displays lock screen user interface 412. Lock screen user interface 412 includes an indication of the date and time “Saturday, October 12” and “9:39” as well as, in response to receiving the communication from the resident device, notification 424. In some embodiments, before receiving the communication from the resident device, computer system 400 displays lock screen user interface 412 without notification 424. In some embodiments, more, fewer, and/or different elements can be included in lock screen user interface 412. In some embodiments, another user interface different from lock screen user interface 412 can be displayed with notification 424, including an application specific to notification 424 (such as an accessory management application) or an application not specific to notification 424 (such as a music or internet browser application).

As illustrated in FIG. 4A, notification 424 includes information about the first guest (e.g., “Sandra”) being detected at the location and/or controls to cause different operations to occur. For example, as illustrated in FIG. 4A, notification 424 includes guest status indication 436, image 448, view activity control 460, and message control 472. In some embodiments, only the administrator receives notification 424. In other embodiments, multiple administrators and/or residents of the location receive notification 424. In some embodiments, computer system 400 displays notification 424 when no administrators and/or residents are at the location. For example, if the first guest is at the location and the administrator is not at the location, computer system 400 displays notification 424. For another example, if the first guest is at the location and a resident is at the location, computer system 400 does not display notification 424. In some embodiments, a determination is made that no administrator and/or resident is at the location via the resident device. For example, the resident device communicates with cameras at the location to determine if a resident is at the location.

As illustrated in FIG. 4A, guest status indication 436 indicates that the first guest is at the location (e.g., “Sandra is at your home”) and the time the first guest arrived (e.g., “Arrived at 9:39 AM”). At FIG. 4A, guest status indication 436 includes an identification of Sandra based on identification information received from the resident device. At FIG. 4A, guest status indication 436 also includes an indication if the guest is arriving or leaving (e.g., “Arrived . . . ”). In some embodiments, guest status indication 436 includes an indication of if the guest is leaving or arriving at the location based on communications from the resident device. For example, the resident device receives a communication from the camera that the first guest is moving away from a front door. In this example, the resident device determines the first guest is leaving and communicates an indication of the status to computer system 400. In this example, in response to receiving the status, computer system 400 displays guest status indication 436 (e.g., “Left at 9:39”). In some embodiments, guest status indication 436 includes an indication of how a guest was detected. For example, if a guest was detected via a camera (e.g., the camera detects and identifies the guest), the resident device communicates how the guest was identified (e.g., “Detected by camera”) to computer system 400. For another example, if the guest was detected via biometrics (e.g., a microphone detects and identifies the guest), the resident device communicates how the guest was identified (e.g., “Detected via voice authentication”) to computer system 400.

As illustrated in FIG. 4A, image 448 is an image of Sandra. In some embodiments, image 448 is an image taken from a live feed captured by the camera. In some embodiments, image 448 is a profile image, indicating that Sandra has a profile set up with the resident device, is registered with the resident device by the administrator, and/or is registered as a contact with the administrator. For example, image 448 can be a photo captured by the resident device. In some embodiments, the image 448 is captured when Sandra was detected in the location. In some embodiments, rather than or in addition to image 448, computer system 400 displays a live feed captured by the camera of the first guest at the location. In some embodiments, rather than or in addition to image 448, computer system 400 displays a recorded video of the first guest at the location captured by the camera.

In some embodiments, in response to detecting an input directed to view activity control 460, computer system 400 ceases display of lock screen user interface 412 and displays an activity user interface as will be discussed with reference to FIGS. 4B-4C. In some embodiments, in response to detecting an input directed to message control 472, computer system 400 ceases display of lock screen user interface 412 and displays a messaging user interface as will be discussed with reference to FIG. 4D.

At FIG. 4A, computer system 400 detects input 405al directed to view activity control 460 and input 405a2 directed to message control 472. It should be recognized that input 405al and input 405a2 are examples of a selection input as tap inputs but can be other inputs, such as a mouse click, a verbal input (e.g., “Show me Sandra's activity.”) and (e.g., “Message Sandra.”), and/or a button press.

In between FIGS. 4A and 4B, the resident device detected Sandra enter the location and walk into the living room. In response to detecting Sandra enter the location and walk into the living room, the resident device communicates Sandra's detected activity to computer system 400.

As illustrated in FIG. 4B, in response to detecting input 405a1, computer system 400 ceases display of lock screen user interface 412 and displays home user interface 484. Additionally, computer system 400 displays overlay 496 over home user interface 484. As illustrated in FIG. 4B, overlay 496 includes user interface elements corresponding to the detected activity of Sandra in response to receiving communication of detected activities from the resident device. As illustrated at the top of overlay 496, overlay 496 includes an identification of whose activities are displayed (e.g., “Sandra”). In some embodiments, if a guest could not be identified, overlay 496 includes an identification that the activities are by that unknown guest (e.g., “Someone,”). In some embodiments, computer system 400 displays an indication of the location as a part of overlay 496. For example, “Your home,” “Smith household,” and/or “Your apartment.” In some embodiments, overlay 496 is a separate user interface than home interface 484.

As illustrated in FIG. 4B, overlay 496 includes activity region 408, guest activity control 456, and home activity control 468. As illustrated in FIG. 4B, activity region 408 includes first activity 420, second activity 432, and third activity 444. First activity 420 indicates that Sandra is in the living room in the location. Additionally, computer system 400 displays time indicator 420a next to first activity 420 to indicate that Sandra was detected in the living room at 9:40 AM. Second activity 432 indicates that Sandra closed the front door. Additionally, computer system 400 displays time indicator 432a next to second activity 432 to indicate that the front door was closed at 9:40 AM and displays status indicator 432b to indicate the status of the front door (e.g., “Closed”). Third activity 444 indicates that Sandra opened the front door (e.g., the oldest activity is detecting Sandra entering the location). Additionally, computer system 400 displays time indicator 444a next to third activity 444 to indicate that the front door was opened at 9:39 AM and displays status indicator 444b to indicate the status of the front door (e.g., “Opened”). As illustrated in FIG. 4B, computer system 400 displays each activity with an indication of where the activity took place at the location. For example, first activity 420 was detected in the living room and second activity 432 and third activity 444 were detected at the entryway front door. As illustrated in FIG. 4B, first activity 420, second activity 432, and third activity 444 are different types of activities (e.g., a location of a guest in a specific location, an opening of a door, and a closing of a door, respectively). Although the above describes first activity 420, second activity 432, and third activity 444 as different activities, in some embodiments, each of first activity 420, second activity 432, and/or third activity 444 are the same activities at different points in time.

As illustrated in FIG. 4B, computer system 400 displays activities for Sandra only from the time where she entered the location in overlay 496 on that day. In some embodiments, computer system 400 displays the entirety of every activity Sandra has performed at the location. For example, computer system 400 displays activities from multiple sessions of Sandra at the location. One session of Sandra at the location can be the day before and another session of Sandra at the location can be today at 9:40. In this example, computer system 400 displays overlay 496 including activities from yesterday and today. For another example, computer system 400 displays overlay 496 with activities of Sandra since the first time she visited the location. In other embodiments, computer system 400 displays activities for Sandra and any other person detected within the location.

As illustrated in FIG. 4B, computer system 400 displays first activity 420, second activity 432, and third activity 444 in chronological order with the most recent activity (e.g., first activity 420) at the top and the oldest activity (e.g., third activity 444) at the bottom. In some embodiments, computer system 400 display activities grouped by type of activity. For example, computer system 400 displays activities that include detected motion at the top of activity region 408, displays activities that include using an accessory (e.g., a television) in the middle of activity region 408, and displays all other activities at the bottom of activity region 408.

At FIG. 4B, computer system 400 displays activity region 408 including different user interface elements in response to different activities being detected. For example, if the resident device detected Sandra in the kitchen, computer system 400 displays an activity including that information (e.g., “Sandra is in your kitchen”). For another example, if the resident device detected Sandra in the study, computer system 400 displays an activity including that information (e.g., “Sandra is in your kitchen”).

In some embodiments, an activity is detected by one or more accessories at the location. In some embodiments, an activity is detected by a camera in communication with the resident device. For example, the camera captures an image of Sandra entering into the kitchen of the location and communicates with the resident device to record an activity of “Sandra entered the kitchen.” In other embodiments, an activity is detected by a motion system in communication with the resident device. For example, the motion sensor detects the motion of Sandra sitting down in the den of the location and communicates with the resident device to record an activity of “Sandra is in your den.” In other embodiments, an activity is detected through communication with an accessory computer system. For example, a light accessory computer system is in the living room of the location and communicates with the resident device to record an activity of “Sandra turned on a light in your living room.” For another example, a television accessory computer system in the bedroom of the location in communication with the resident device is turned on and communicates with the resident device to record an activity of “Sandra is watching TV in your living room.” In other embodiments, an activity is detected through ultra-wide band (e.g., “UWB”). For example, the resident device detects the personal computer system of Sandra in the hallway of the location through UWB and communicates with the resident device to record an activity of “Sandra is in the hallway.”

In other embodiments, an activity is detected through biometric information. For example, a camera detects facial features of Sandra to verify Sandra moved to a garage and communicates with the resident device to record an activity of “Sandra is in your garage.” For another example, Sandra may make a voice command detected by a microphone to turn off a light in the living room. In this example, Sandra's voice from the voice command may be used to authenticate Sandra as the one who made the command and the microphone communicates with the resident device to record an activity of “Sandra turned the light off.”

In other embodiments, an activity is detected through multiple sources. For example, a motion sensor detects the motion of Sandra laying down in a bed in the guest bedroom. Additionally, a light accessory computer system in the guest bedroom of the location was turned off by Sandra. Furthermore, a camera captures an image of Sandra walking down a hallways to the guest bedroom at a time before detecting the motion in the bed. As a result, in response to receiving communication from the motion sensor, the light accessory computer system, and the camera connected to and/or in communication with the resident device, the resident device makes a determination that Sandra is sleeping in the guest bedroom and record an activity of “Sandra is sleeping in the guest bedroom.”

Two minutes have passed between FIGS. 4B and 4C. In between FIGS. 4B and 4C, the resident device detected Sandra leave the location through the back door. In response to detecting Sandra leave through the back door, the resident device communicates with computer system 400. As illustrated in FIG. 4C, in response to receiving the communication from the resident device, computer system 400 displays activity region 408 including fourth activity 480. Fourth activity 480 indicates that Sandra opened the back door. Additionally, computer system 400 displays time indicator 480a next to fourth activity 480 to indicate that the back door was opened at 9:41 AM and displays status indicator 444b to indicate the status of the back door (e.g., “Opened”).

FIG. 4D illustrates an embodiment separate from the one illustrated in FIG. 4B-4C. As illustrated in FIG. 4D, in response to detecting input 405a2 (e.g., as described with respect to FIG. 4A), computer system 400 ceases display of lock screen user interface 412 and displays messaging user interface 492. As illustrated in FIG. 4D, messaging user interface 492 includes user interface elements to allow the administrator to send instant messages. As illustrated in FIG. 4D, computer system 400 displays messaging user interface 492 with Sandra prepopulated as the recipient to the message. In some embodiments, computer system 400 prepopulates Sandra as the recipient to the message because Sandra was identified in the environment. In some embodiments, computer system 400 does not prepopulate Sandra as the recipient, and a user of computer system 400 manually enters a person or guest to contact. For example, if the administrator doesn't have Sandra's contact information, in response to detecting input 405a2, computer system 400 displays messaging user interface 492 but without a recipient populated.

In some embodiments, in response to detecting input 405a2, computer system 400 initiates a call instead of sending a message. For example, in response to detecting input 405a2, computer system 400 ceases display of lock screen user interface 412 and displays an audio call user interface to allow the administrator to start an audio call with the guest. In some embodiments, in response to detecting input 405a2, computer system 400 ceases display of lock screen user interface 412 and displays a video call user interface to allow the administrator to start a video call with the guest.

In some embodiments, computer system 400 displays a user interface to contact a guest via a particular medium based on settings. For example, the administrator has preconfigured settings to always message Sandra. In some embodiments, computer system 400 displays messaging user interface 492 rather than an audio or video call user interface based on the time of day. For example, after 8:00 PM, computer system 400 displays messaging user interface 492. In other embodiments, computer system 400 displays messaging user interface 492 rather than an audio or video call user interface based on the status of the guest's personal device. For example, if Sandra's personal device is in a do-not-disturb mode, computer system 400 displays messaging user interface 492.

FIG. 4E illustrates a separate embodiment where a second guest is at the location. As illustrated in FIG. 4E, computer system 400 displays lock screen user interface 412. Lock screen user interface 412 includes an indication of the date and time “Saturday, October 12” and “9:50” as well as notification 424. As illustrated in FIG. 4E, notification 424 includes information that a second guest (e.g., “Johnny”) was detected and identified at the administrator's location by the camera and communicated to computer system 400 via the resident device. It should be recognized that the detection and identification of the second guest occurred before FIG. 4E.

As illustrated in FIG. 4E, notification 424 includes guest status indication 436, image 404, view activity control 460, and message control 472. As illustrated in FIG. 4E, image 404 is an image of Johnny. As illustrated in FIG. 4E, guest status indication 436 indicates that the second guest is at the administrator's location (e.g., “Johnny is at your home”), and how the second guest was detected and authenticated (e.g., “Entered PIN at 9:49 AM”).

FIG. 4F illustrates a separate embodiment where a third guest is at the location. In response to detecting the third guest is at the location, the camera attempts to identify the third guest. At FIG. 4F, the camera is unable to identify the third guest and, in response, sends a communication indicating that the third guest is an unknown guest to the resident device. In response to receiving the communication, the resident device communicates with computer system 400 that the third guest is an unknown guest and is at the location. In other embodiments, the resident device can attempt to identify the third guest using other accessories and, if still unable, can proceed as described below.

As illustrated in FIG. 4F, in response to receiving the communication that the camera is unable to identify the third guest, computer system 400 displays notification 424. Notification 424 includes guest status indication 436, image 416, get help control 428, and allow control 440. In some embodiments, computer system 400 does not display view activity control 460 and message control 472 due to the camera being unable to identify the third guest.

Guest status indication 436 indicates to the administrator that the unknown guest is at the location (e.g., “Someone is at the front door”), and how and when the unknown guest was detected (e.g., “Motion detected at the front door at 11:01 AM”). As illustrated in FIG. 4F, image 416 is an icon of a person and is not a profile picture or picture of the unknown guest due to the resident device being unable to identify the third guest. In some embodiments, image 416 is an image or video captured of the third guest by a camera at the location. For example, a camera captures an image of the third guest and communicates the image to computer system 400 via the resident device.

As illustrated in FIG. 4F, computer system 400 displays get help control 428 and allow control 440 as part of notification 424 due to the resident device being unable to identify the third guest. In some embodiments, in response to detecting an input directed to get help control 428, computer system 400 displays a menu that allows the administrator to contact an emergency contact and/or emergency services. For example, the administrator's emergency contact can be Jane. In this example, in response to detecting an input directed to get help control 428, computer system 400 displays a menu of various means to contact Jane. For another example, in response to detecting an input directed to get help control 428, computer system 400 displays a menu of multiple emergency contacts (e.g., “Jane” and “Steve”). In some embodiments, in response to detecting an input directed to get help control 428, computer system 400 initiates a call the emergency contact and/or emergency services. For example, in response to detecting an input directed to get help control 428, computer system 400 initiates a call to emergency services. In some embodiments, in response to detecting an input directed allow control 440, computer system 400 communicates with the resident device to grant access to the unknown guest. In some embodiments, in response to receiving communication that the camera is unable to identify and/or authenticate the unknown guest, computer system 400 displays notification 424 including a control to allow the administrator to speak with the unknown guest through the resident device, the camera accessory, and/or an accessory computer system within the location.

FIG. 5 is a flow diagram illustrating a process (e.g., process 500) for displaying a user interface element to contact guests in accordance with some embodiments. Some operations in process 500 are, optionally, combined, the orders of some operations are, optionally, changed, and some operations are, optionally, omitted.

As described below, process 500 provides an intuitive way for displaying a user interface element to contact guests in accordance with some embodiments. Process 500 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

In some embodiments, process 500 is performed at a computer system (e.g., 400) that is in communication (e.g., wired communication and/or wireless communication) with (and/or includes) one or more display components (e.g., a display screen, a projector, and/or a touch-sensitive display). In some embodiments, the computer system is in communication with (and/or includes) one or more input devices (e.g., a camera, a depth sensor, a microphone, a hardware input mechanism, a rotatable input mechanism, a heart monitor, a temperature sensor, and/or a touch-sensitive surface). In some embodiments, the computer system is a phone, a watch, a tablet, a fitness tracking device, a wearable device, an accessory, a speaker, a light, a head-mounted display (HMD), and/or a personal computing device.

The computer system receives (502) a notification (e.g., as described above with respect to FIG. 4A) that a respective subject (e.g., such as described above with respect to FIG. 4A) (e.g., a user, a person, an animal, another computer system different from the computer system, a device, and/or an object) has been detected in (e.g., present in, located at and/or at a position corresponding to) an environment (e.g., location, such as described above with respect to FIG. 4A) (e.g., a predefined area, a location, a home, a room, a yard, and/or a building). In some embodiments, the notification that the respective subject has been detected in the environment is received from the computer system or another computer system (e.g., resident device, such as described above with respect to FIG. 4A) external to the computer system. In some embodiments, the computer system receives the notification that the respective subject has been detected in the environment via the one or more input devices.

In response to (504) receiving the notification that the respective subject has been detected in the environment, in accordance with a determination that the respective subject is a first subject (e.g., “Sandra,” represented by 448, such as described above with respect to FIG. 4A), the computer system displays (506), via the one or more display components, a user interface element (e.g., 472, such as described above with respect to FIG. 4A) (e.g., a virtual button, an icon, a widget, a control, and/or a window) to contact (and/or communicate with) the first subject. In some embodiments, the user interface element to contact the first subject was not previously displayed. In some embodiments, before displaying the user interface element to contact the first subject, the computer system displays, via the one or more display components, a user interface element to review the notification different from the user interface element to contact the first subject. In some embodiments, in conjunction with (e.g., before, after, and/or while) displaying the user interface element to contact the first subject, the computer system ceases display of the user interface element to review the notification.

In response to (504) receiving the notification that the respective subject has been detected in the environment, in accordance with a determination that the respective subject is a second subject (e.g., “Johnny,” such as described above with respect to FIG. 4E), the computer system displays (508), via the one or more display components, a user interface element (e.g., 472, such as described above with respect to FIG. 4E) to contact (and/or communicate with) the second subject without displaying the user interface element to contact the first subject, wherein the first subject is different from the second subject, and wherein the user interface element to contact the first subject is separate from the user interface element to contact the second subject. In some embodiments, in conjunction with (e.g., before, after, and/or while) displaying the user interface element to contact the first subject, the computer system forgoes display of the user interface element to contact the second subject. In some embodiments, the user interface element to contact the second subject was not previously displayed. In some embodiments, before displaying the user interface element to contact the first subject, the computer system displays, via the one or more display components, a user interface element to review the notification different from the user interface element to contact the second subject. In some embodiments, in conjunction with (e.g., before, after, and/or while) displaying the user interface element to contact the second subject, the computer system ceases display of the user interface element to review the notification. Displaying different user interface elements to contact different subjects depending on which subject is detected in an environment allows the computer system to customize its communication for who is being detected, thereby reducing the number of inputs needed to perform an operation and/or performing an operation when a set of conditions has been met without requiring further user input.

In some embodiments, in response to receiving the notification that the respective subject has been detected in the environment and in accordance with a determination that the respective subject is unknown (e.g., as described above with respect to FIG. 4F) (e.g., unrecognized, not authenticated, and/or unable to be authenticated by the computer system or another computer system separate from the computer system), the computer system forgoes display of, via the one or more display components, a (and/or any) user interface element to contact a subject (e.g., the user interface element to contact the first subject, the user interface element to contact the second subject, and/or a user interface element to contact any subject). In some embodiments, in response to receiving the notification that the respective subject has been detected in the environment and in accordance with the determination that the respective subject is unknown, the computer system displays, via the one or more display components, a representation (e.g., 436 indicates “Someone,” such as described above with respect to FIG. 4F) (e.g., a graphical representation, an image, user interface element, and/or button) that includes an indication that the respective subject is unknown. In some embodiments, in response to receiving the notification that the respective subject has been detected in the environment and in accordance with the determination that the respective subject is unknown, the computer system displays, via the one or more display components, a user interface element (e.g., a virtual button, an icon, a widget, a control, and/or a window) to contact emergency services (e.g., 911, an emergency contact, and/or a security service). Not displaying a control to contact a subject when a subject detected in an environment is unknown allows the computer system to only suggest communication when the subject is known, thereby providing improved visual feedback to the user and/or performing an operation when a set of conditions has been met without requiring further user input.

In some embodiments, in response to receiving the notification that the respective subject has been detected in the environment and in accordance with a determination that the respective subject is unknown (e.g., as described above with respect to FIG. 4F) (e.g., unrecognized, not authenticated, and/or unable to be authenticated by the computer system or another computer system separate from the computer system), the computer system displays, via the one or more display components, a user interface element (e.g., 428, such as described above with respect to FIG. 4F) (e.g., a virtual button, an icon, a widget, a control, and/or a window) to contact an accessory device (e.g., within the environment). In some embodiments, the accessory device is a phone, a watch, a tablet, a fitness tracking device, a wearable device, an accessory, a speaker, a light, a head-mounted display (HMD), and/or a personal computing device. In some embodiments, the accessory device corresponds to (e.g., associated with, logged into, and/or owned by) the second subject. In some embodiments, the user interface element to contact the accessory was not previously displayed while and/or before receiving the notification that the respective subject has been detected in the environment. In some embodiments, the computer system is in communication with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, while displaying the user interface element to contact the accessory device, the computer system detects, via the one or more input devices, an input (e.g., as described above with respect to FIG. 4F) (e.g., a tap input, a voice input, and/or an air gesture) corresponding to the user interface element to contact the accessory device. In some embodiments, in response to detecting the input corresponding to the user interface element to contact the accessory device, the computer system displays, via the one or more display components, a user interface (e.g., a user interface of a calling application and/or a user interface of a messaging application) to initiate contact (e.g., calling and/or messaging) with the accessory device. In some embodiments, in response to detecting the input corresponding to the user interface element to contact the accessory device, the computer system initiates communication with the accessory device. Displaying a control to contact an accessory device when a subject detected in an environment is unknown allows the computer system to suggest communication with a subject via known channels even when the subject is unknown, thereby providing improved visual feedback to the user and/or performing an operation when a set of conditions has been met without requiring further user input.

In some embodiments, the computer system is in communication with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, while displaying the user interface element to contact the first subject, the computer system detects, via the one or more input devices, an input (e.g., 405a2) (e.g., a tap input, a voice input, and/or an air gesture) corresponding to the user interface element to contact the first subject. In some embodiments, the tap input is on the user interface element to contact the first subject. In some embodiments, the voice input includes a request corresponding to the user interface element to contact the first subject (e.g., “Select contact,” and/or “Call them,”). In some embodiments, the air gesture includes a gesture corresponding to a request to select the user interface element to contact the first subject (e.g., a pinch and/or swipe). In some embodiments, in response to detecting the input corresponding to the user interface element to contact the first subject, the computer system displays, via the one or more display components, a messaging user interface (e.g., 492) (e.g., a user interface corresponding to a messaging application) to send a message (e.g., a text and/or social media message) to the first subject. Displaying a messaging user interface to contact a subject when the subject is detected in an environment allows the computer system to customize its communication mechanism (e.g., texting rather than calling) for who is being detected, thereby reducing the number of inputs needed to perform an operation and/or performing an operation when a set of conditions has been met without requiring further user input.

In some embodiments, the computer system is in communication with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, while displaying the user interface element to contact the first subject, the computer system detects, via the one or more input devices, an input (e.g., 405a2) (e.g., a tap input, a voice input, and/or an air gesture) corresponding to the user interface element to contact the first subject. In some embodiments, the tap input is on the user interface element to contact the first subject. In some embodiments, the voice input includes a request to select the user interface element to contact the first subject (e.g., “Select contact”). In some embodiments, the air gesture includes a gesture corresponding to a request to select the user interface element to contact the first subject (e.g., a pinch and/or swipe). In some embodiments, in response to detecting the input corresponding to the user interface element to contact the first subject, the computer system displays, via the one or more display components, a calling user interface (e.g., audio call user interface and/or video call user interface, such described above with respect to FIG. 4D) (e.g., a user interface corresponding to a calling application) to initiate a call (e.g., a cellular call, video call, and/or audio call) with the first subject. Displaying a calling user interface to contact a subject when the subject is detected in an environment allows the computer system to customize its communication mechanism (e.g., calling rather than calling) for who is being detected, thereby reducing the number of inputs needed to perform an operation and/or performing an operation when a set of conditions has been met without requiring further user input. Displaying a calling user interface for certain subjects and a messaging user interface for other subjects allows the computer system to cater its communication mechanism to which subject is being detected (e.g., some get calls and others get messages), thereby reducing the number of inputs needed to perform an operation and/or performing an operation when a set of conditions has been met without requiring further user input.

In some embodiments, the notification that the respective subject has been detected in the environment is received from a resident device (e.g., such as described above with respect to FIG. 4A) (e.g., a communication hub, a controller, a home hub, and/or a hub device). In some embodiments, the resident device is in communication with (and/or includes) one or more accessories (e.g., a light, a lock, a speaker, a television, a fan, an air conditioner, and/or a heater) within the environment. In some embodiments, the resident device and the one or more accessories are on the same wireless network, such as a local area network or a mesh network. Displaying different user interface elements to contact different subjects depending on which subject is detected in an environment in response to receiving a notification received from a resident device allows a device local to the environment to communicate with the computer system about the environment, thereby reducing the number of inputs needed to perform an operation and/or performing an operation when a set of conditions has been met without requiring further user input.

In some embodiments, while receiving the notification that the respective subject has been detected in the environment, the computer system displays, via the one or more display components, a user interface (e.g., 412, such as described above with respect to FIG. 4A) (e.g., a lock screen, user interface corresponding to an application, and/or a home screen) without displaying (e.g., not including and/or forgoes display of) the user interface element to contact the first subject. Displaying a user interface while receiving a notification allows the computer system to display a user interface without different user interface elements to contact different subjects until (in response to and/or after) the notification is received, thereby reducing the number of inputs needed to perform an operation and/or performing an operation when a set of conditions has been met without requiring further user input.

In some embodiments, the user interface is a lock screen (e.g., a user interface that is displayed while the computer system is in a locked state). In some embodiments, in response to receiving the notification that the respective subject has been detected in the environment, the computer system displays, via the one or more display components, the notification (e.g., 424) in the lock screen.

In some embodiments, the computer system is in communication with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, in response to receiving the notification that the respective subject has been detected in the environment, the computer system displays, via the one or more display components, a user interface element (e.g., a virtual button, an icon, a widget, a control, and/or a window) to view indications of activities (e.g., 460) (e.g., video, image, textual descriptions, motion sense, and/or door opening/closing) of (e.g., by and/or associated with) the respective subject in the environment. In some embodiments, while displaying the user interface element to view indications of activities of the respective subject in the environment, the computer system detects, via the one or more input devices, an input (e.g., 405a1) (e.g., a tap input, a voice input, and/or an air gesture) corresponding to the user interface element to view indications of activities of the respective subject in the environment. In some embodiments, the tap input is on the user interface element to view indications of activities of the subject in the environment. In some embodiments, the voice input includes a request to select the user interface element to view indications of activities of the subject in the environment (e.g., “Select ‘view activity”). In some embodiments, the air gesture includes a gesture corresponding to a request to select the user interface element to view indications of activities of the subject in the environment (e.g., a pinch and/or swipe). In some embodiments, in response to detecting the input corresponding to the user interface element to view indications of activities of the respective subject in the environment, the computer system displays, via the one or more display components, a plurality of representations of activities (e.g., 408) performed by the respective subject (and/or ceasing display of the user interface element to view indications of activities of the respective subject in the environment), wherein the plurality of representations of activities includes a first representation of a first activity (e.g., 420, 432) and a second representation of a second activity (e.g., 444) (e.g., separate from the first activity), wherein the first representation is separate from the second representation. In some embodiments, in response to detecting the input corresponding to the user interface element to view indications of activities, the computer system displays a user interface (e.g., 496) (e.g., different from or the same as a user interface previously displayed) including the plurality of representations of activities. In some embodiments, each of the plurality of representations of activities correspond to an activity (e.g., an action performed with context) (e.g., entering a room, leaving a room, being identified, being authenticated, changing a state of an accessory device, walking to an area, sleeping, and/or the like) associated with the respective subject. In some embodiments, each of the plurality of representations of activities include media (e.g., video and/or photo) corresponding to the activity (e.g., media captured before, after, and/or while the activity performed by the respective subject). In some embodiments, each of the plurality of representations of activities are detected by an external computer system and/or the computer system (e.g., via the one or more input devices). Displaying a representation of different activities performed by a particular subject in an environment in response to detecting an input on a notification that the subject has been detected in the environment allows the computer system to provide quick access to understand what is occurring within the environment as directed by a user, thereby reducing the number of inputs needed to perform an operation and/or performing an operation when a set of conditions has been met without requiring further user input.

In some embodiments, the respective subject is a first respective subject. In some embodiments, in response to receiving a notification that a second respective subject has been detected in the environment and in accordance with a determination that a registered user (e.g., resident and/or administrator, such as described above with respect to FIG. 4A) (e.g., an authorized user, and/or homeowner) is not detected in the environment, the computer system displays, via the one or more display components, a user interface element (e.g., 472) (e.g., a virtual button, an icon, a widget, a control, and/or a window) to contact the second respective subject. In some embodiments, in response to receiving the notification that the second respective subject has been detected in the environment and in accordance with the determination that a registered user is detected in the environment, the computer system forgoes display of, via the one or more display components, the user interface element to contact the second respective subject. In some embodiments, the second respective subject is different from the first respective subject. In some embodiments, the second respective subject is the same as the first respective subject. Displaying a user interface element to contact a subject when a registered user is not detected in an environment allows the computer system to reduce what is displayed and cater what is displayed to a current context of the environment and provide an option to contact the subject when a homeowner or authorized user is not present (e.g., to manage the subject themselves), thereby providing improved visual feedback to the user and/or performing an operation when a set of conditions has been met without requiring further user input.

In some embodiments, in response to receiving the notification that the respective subject has been detected in the environment and in accordance with the determination that the respective subject is the first subject, the computer system concurrently displays via the one or more display components, the user interface element to contact the first subject and an identification (e.g., “Sandra” and/or “Johnny” in 436) (e.g., name, username, and/or contact information) of the respective subject. With an identification of a detected subject, displaying different user interface elements to contact different subjects depending on which subject is detected in an environment allows the computer system to enable a user to contact personal devices of identified different subjects depending on who is being detected, thereby reducing the number of inputs needed to perform an operation and/or performing an operation when a set of conditions has been met without requiring further user input.

In some embodiments, in response to receiving the notification that the respective subject has been detected in the environment and in accordance with the determination that the respective subject is the first subject, the computer system concurrently displays via the one or more display components, the user interface element to contact the first subject and an identification (e.g., “your home” in 436) (e.g., name, ownership, nickname, and/or location) of the environment. In some embodiments, the indication of the environment includes a name (e.g., “your home” and/or “John's home”) of the environment. With an identification of an environment, displaying different user interface elements to contact different subjects depending on which subject is detected in the environment allows the computer system to enable a user to contact personal devices of different subjects who are in an identified environment depending on who is being detected, thereby reducing the number of inputs needed to perform an operation and/or performing an operation when a set of conditions has been met without requiring further user input.

In some embodiments, in response to receiving the notification that the respective subject has been detected in the environment and in accordance with the determination that the respective subject is the first subject, the computer system concurrently displays via the one or more display components, the user interface element to contact the first subject and a representation (e.g., 404 and/or 448) (e.g., a graphical representation, video, and/or image) of the respective subject. In some embodiments, the representation of the respective subject includes a profile image (e.g., assigned to the first subject and/or from a contacts list of a user of the computer system) and/or a photo from an external device (e.g., of the respective subject) when the respective subject was detected in the environment. With a representation of a detected subject, displaying different user interface elements to contact different subjects depending on which subject is detected in an environment allows the computer system to enable a user to identify different subjects and contact personal devices of the different subjects depending on who is being detected, thereby reducing the number of inputs needed to perform an operation and/or performing an operation when a set of conditions has been met without requiring further user input.

In some embodiments, in response to receiving the notification that the respective subject has been detected in the environment and in accordance with the determination that the respective subject is the first subject, the computer system concurrently displays via the one or more display components, the user interface element to contact the first subject and an identification of when (e.g., “9:39” and/or “9:49” in 436) (e.g., a time of day, and/or amount of time that has passed since) the first subject was detected. With an identification of when a subject was detected, displaying different user interface elements to contact different subjects depending on which subject is detected in the environment allows the computer system to enable a user to contact personal devices of different subjects depending on who is being detected while also displaying the current time of day and identifying if the detected subject is present at a time they are not permitted to be there, thereby reducing the number of inputs needed to perform an operation and/or performing an operation when a set of conditions has been met without requiring further user input.

In some embodiments, in response to receiving the notification that the respective subject has been detected in the environment and in accordance with the determination that the respective subject is the first subject, the computer system concurrently displays via the one or more display components, the user interface element to contact the first subject and an indication of how (e.g., “Entered PIN” in 436) (e.g., PIN code, camera identification, and/or voice authentication) the subject was detected. With an indication of how a subject was detected, displaying different user interface elements to contact different subjects depending on which subject is detected in an environment allows the computer system to enable a user to contact the personal devices of different subjects depending on who is identified while also verifying the accuracy of the identification to distinguish false positives and confirming whether the detected subject is in a location where they are permitted to be, thereby reducing the number of inputs needed to perform an operation and/or performing an operation when a set of conditions has been met without requiring further user input.

Note that details of the processes described above with respect to process 500 (e.g., FIG. 5) are also applicable in an analogous manner to other processes described herein. For example, process 500 optionally includes one or more of the characteristics of the various processes described above with reference to process 500. For example, displaying the user interface element to view indications of activities of process 600 can occur in response to receiving the notification that the respective subject has been detected of process 400. For brevity, these details are not repeated herein.

FIG. 6 is a flow diagram illustrating a process (e.g., process 600) for displaying guest activities in accordance with some embodiments. Some operations in process 600 are, optionally, combined, the orders of some operations are, optionally, changed, and some operations are, optionally, omitted.

As described below, process 600 provides an intuitive way for displaying guest activities in accordance with some embodiments. Process 600 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

In some embodiments, process 600 is performed at a computer system (e.g., 400) that is in communication (e.g., wired communication and/or wireless communication) with (and/or includes) one or more input devices (e.g., a camera, a depth sensor, a microphone, a hardware input mechanism, a rotatable input mechanism, a heart monitor, a temperature sensor, and/or a touch-sensitive surface) and one or more display components (e.g., a display screen, a projector, and/or a touch-sensitive display). In some embodiments, the first computer system is a phone, a watch, a tablet, a fitness tracking device, a wearable device, an accessory, a speaker, a light, a head-mounted display (HMD), and/or a personal computing device.

The computer system receives (602) a notification (e.g., as described above with respect to FIG. 4A) that a subject (e.g., as described above with respect to FIG. 4A) (e.g., a user, a person, an animal, another computer system different from the computer system, a device, and/or an object) has been detected in (e.g., present in, located at and/or at a position corresponding to) an environment (e.g., location, such as described above with respect to FIG. 4A) (e.g., a home, a room, a yard, and/or a building). In some embodiments, the notification that the subject has been detected in the environment is received from (1) a process of the computer system or (2) another computer system external to the computer system. In some embodiments, the computer system receives the notification that the subject has been detected in the environment via the one or more input devices.

In response to receiving the notification that the subject has been detected in the environment, the computer system displays (604), via the one or more display components, a user interface element (e.g., 460) (e.g., a virtual button, an icon, a widget, a control, and/or a window) to view indications of activities (e.g., video, image, textual descriptions, motion sense, and/or door opening/closing) of (e.g., by and/or associated with) the subject in the environment. In some embodiments, the user interface element to view indications of activities of the subject in the environment was not previously displayed before receiving the notification that the subject has been detected in the environment. In some embodiments, before displaying the user interface element to view indications of activities of the subject in the environment, the computer system displays, via the one or more display components, a user interface element to review the notification different from the user interface element to view indications of activities of the subject in the environment. In some embodiments, in conjunction with (e.g., before, while, and/or after) displaying the user interface element to view indications of activities of the subject in the environment, the computer system ceases display of the user interface element to review the notification.

While displaying the user interface element to view indications of activities of the subject in the environment, the computer system detects (606), via the one or more input devices, an input (e.g., 405a1) (e.g., a tap input, a voice input, and/or an air gesture) corresponding to the user interface element to view indications of activities of the subject in the environment. In some embodiments, the tap input is on the user interface element to view indications of activities of the subject in the environment. In some embodiments, the voice input includes a request to select the user interface element to view indications of activities of the subject in the environment (e.g., “Select ‘view activity”). In some embodiments, the air gesture includes a gesture corresponding to a request to select the user interface element to view indications of activities of the subject in the environment (e.g., a pinch and/or swipe).

In response to detecting the input corresponding to the user interface element to view indications of activities, the computer system displays (608), via the one or more display components, a plurality of representations of activities (e.g., 408) performed by the subject (and/or ceasing display of the user interface element to view activity of the subject in the environment), wherein the plurality of representations of activities includes a first representation (e.g., 420, 432) of a first activity and a second representation (e.g., 444) of a second activity (e.g., separate from the first activity), wherein the first representation is separate from the second representation. In some embodiments, in response to detecting the input corresponding to the user interface element to view indications of activities, the computer system displays a user interface (e.g., different from or the same as a user interface previously displayed while displaying the user interface element to view activity of the subject in the environment) including the plurality of representations of activities. In some embodiments, each of the plurality of representations of activities correspond to an activity (e.g., an event, action, operation, and/or detection) associated with the subject. In some embodiments, each of the plurality of representations of activities include media (e.g., video and/or photo) corresponding to the activity (e.g., media captured before, after, and/or while the activity performed by the subject). In some embodiments, each of the plurality of representations of activities are detected by an external computer system and/or the computer system (e.g., via the one or more input devices). In response to receiving a notification that a subject has been detected in an environment, displaying a control to concurrently display multiple different representations of different activities performed by the subject in the environment allows the computer system to notify a user of activities being performed in the environment through an intuitive flow from a notification that the subject has been detected in the environment as directed by the user, thereby reducing the number of inputs needed to perform an operation and/or performing an operation when a set of conditions has been met without requiring further user input.

In some embodiments, in accordance with a determination that the first activity was performed before the second activity, the first representation (e.g., 420, 432) of the first activity is ordered (e.g., visually ordered and/or displayed such that an order is implied) ahead of (e.g., before, above, below, and/or to the side of) the second representation (e.g., 444) of the second activity. In some embodiments, the first representation of the first activity is ordered ahead of the second representation of the second activity by displaying the first representation of the first activity at a position relative to the second representation of the second activity in an arrangement (e.g., orientation and/or position) corresponding to when the respective activity (e.g., first activity and/or second activity) was performed. In some embodiments, in accordance with a determination that the second activity was performed before the first activity, the second representation of the second activity is ordered ahead (e.g., as described above with respect to FIG. 4B) of the first representation of the first activity. Ordering representations of activities based on when the activities were performed allows the computer system to better organize such representations in a manner that is intuitive for review, thereby providing improved visual feedback to the user and/or performing an operation when a set of conditions has been met without requiring further user input.

In some embodiments, in accordance with a determination the first activity and the second activity satisfy a set of one or more criteria (e.g., similar type of activity, same day, and/or at the same location in the environment), the first representation of the first activity and the second representation of the second activity are displayed in a first group (e.g., as described above with respect to FIG. 4B) (e.g., a location and/or arrangement). In some embodiments, displaying the first representation of the first activity and the second representation of the second activity includes displaying the first representation of the first activity at a position relative to the second representation of the second activity in an arrangement (e.g., orientation and/or position) adjacent to and/or close to one another (and/or relative to other representations of other activities of the plurality of representations of activities). In some embodiments, in accordance with a determination that the first activity and the second activity do not satisfy the set of one or more criteria, the first representation of the first activity is displayed in a second group (e.g., as described above with respect to FIG. 4B) (e.g., a location and/or arrangement) and the second representation of the second activity is displayed in a third group (e.g., as described above with respect to FIG. 4B) (e.g., a location and/or arrangement) different from the second group. In some embodiments, the second group is different from the first group. In some embodiments, the third group is different from the first group. In some embodiments, the second group is the same as the first group. In some embodiments, the third group is the same as the first group. Grouping representations of activities allows the computer system to better organize such representations in a manner that is intuitive for review, thereby providing improved visual feedback to the user and/or performing an operation when a set of conditions has been met without requiring further user input.

In some embodiments, the first representation of the first activity includes an indication of when (e.g., 420a, 432a) (e.g., time of day and/or time since entering the environment) the first activity was performed. In some embodiments, the second representation of the second activity includes an indication of when (e.g., 444a) (e.g., time of day and/or time since entering the environment) the second activity was performed. Displaying an indication of when different activities are performed along with representations of the different activities allows the computer system to notify of occurrences in an environment, thereby providing improved visual feedback to the user and/or performing an operation when a set of conditions has been met without requiring further user input.

In some embodiments, the user interface element to view indications of activities of the subject in the environment includes an identification (e.g., “your home” in 436) (e.g., name, ownership, nickname, and/or location) of the environment. Displaying an identification of an environment along with representations of different activities performed in the environment allows the computer system to notify of locations of occurrences, thereby providing improved visual feedback to the user and/or performing an operation when a set of conditions has been met without requiring further user input.

In some embodiments, the first representation of the first activity includes an identification (e.g., “Entryway,” “Living Room” in 420 and 432) (e.g., name and/or image) of a first portion (e.g., segment, and/or location) of the environment. In some embodiments, the second representation of the second activity includes an identification (e.g., “Entryway” in 444) of a second portion (e.g., segment, and/or location) of the environment. In some embodiments, the first portion of the environment is different from the second portion of the environment. Displaying an identification of a portion of an environment that an activity is performed along with representations of different activities performed in the environment allows the computer system to notify of occurrences in different areas of the environment and enables a user to know with more detail the location of the occurrence, thereby providing improved visual feedback to the user and/or performing an operation when a set of conditions has been met without requiring further user input.

In some embodiments, the user interface element to view indications of activities of the subject in the environment is displayed in a first user interface (e.g., 412) (e.g., a lock screen, user interface corresponding to an application, and/or a home screen). In some embodiments, the first representation of the first activity and the second representation of the second activity are displayed in a second user interface (e.g., 496) (e.g., an application user interface and/or a settings user interface) different from the first user interface. In some embodiments, in response to detecting the input corresponding to the user interface element to view indications of activities, the computer system displays, via the one or more display components, the second user interface and ceases display of, via the one or more display components, the first user interface. Separating a user interface element to view indications of activities of a subject in an environment from representations of different activities allows the computer system to compartmentalize different functionality, thereby providing improved visual feedback to the user and/or performing an operation when a set of conditions has been met without requiring further user input.

In some embodiments, in response to detecting the input corresponding to the user interface element to view indications of activities, the computer system displays, via the one or more display components, an indication (e.g., as described above with respect to FIG. 4B) (e.g., text, image, and/or emphasis) that the subject is unknown (e.g., unrecognized, not authenticated, unable to authenticate) (and/or to the computer system). In some embodiments, displaying the plurality of representations of activities performed by the subject includes the computer system concurrently displaying, via the one or more display components, the plurality of representations of activities performed by the subject including a representation the subject is unknown. Displaying an indication that a subject is unknown with representations of different activities performed in an environment allows the computer system to notify of the actor of the occurrences is unknown and enables a user to potentially intervene, thereby providing improved visual feedback to the user and/or performing an operation when a set of conditions has been met without requiring further user input.

In some embodiments, in response to detecting the input corresponding to the user interface element to view indications of activities, the computer system concurrently displays, via the one or more display components, the plurality of representations of activities performed by the subject and an identification (e.g., “Sandra,” in 496, such as described above with respect to FIG. 4B) (e.g., name, username, and/or contact information) of the subject. Concurrently displaying different representations of different activities with an identification of a subject corresponding to the different activities allows the computer system to notify of the identity of a subject and enables a user to potentially intervene, thereby providing improved visual feedback to the user and/or performing an operation when a set of conditions has been met without requiring further user input.

In some embodiments, in response to detecting the input corresponding to the user interface element to view indications of activities, the computer system concurrently displays, via the one or more display components, the plurality of representations of activities performed by the subject and an identification (e.g., “Your home,” such as described above with respect to FIG. 4B) (e.g., name, ownership, nickname, and/or location) of the environment. In some embodiments, the indication of the environment includes a name (e.g., “your home” and/or “John's home”) of the environment. Concurrently displaying different representations of different activities with an identification of an environment corresponding to the different activities allows the computer system to indicate what activities are being performed and in which environment, thereby providing improved visual feedback to the user and/or performing an operation when a set of conditions has been met without requiring further user input.

In some embodiments, in response to detecting the input corresponding to the user interface element to view indications of activities, the computer system concurrently displays, via the one or more display components, the plurality of representations of activities performed by the subject and an identification of when (e.g., 420a, 432a, and/or 444a) (e.g., a time of day, and/or amount of time that has passed since) the first subject was detected. Concurrently displaying different representations of different activities with an identification of when a subject was detected allows the computer system to indicate when activities are being performed and enabling a user to review activities at the provided time of the occurrence, thereby providing improved visual feedback to the user and/or performing an operation when a set of conditions has been met without requiring further user input.

In some embodiments, in response to detecting the input corresponding to the user interface element to view indications of activities, the computer system concurrently displays, via the one or more display components, the plurality of representations of activities performed by the subject and an indication of how (e.g., as described above with respect to FIG. 4B) (e.g., PIN code, camera identification, and/or voice authentication) the subject was detected. Concurrently displaying different representations of different activities with an indication of how a subject was detected allows the computer system to indicate what activities are being performed and what proof that the computer system has that the subject is who the computer system thinks, thereby providing improved visual feedback to the user and/or performing an operation when a set of conditions has been met without requiring further user input.

In some embodiments, the first activity is different from the second activity (e.g., as described above with respect to FIG. 4B). In some embodiments, the first activity is a different type (e.g., door open type, accessory device turned on and/or used type, and/or motion detected type) than the second activity.

In some embodiments, the first activity is the same as and separate from the second activity (e.g., as described above with respect to FIG. 4B). In some embodiments, the first activity is the same type (e.g., door open type, accessory device turned on and/or used type, and/or motion detected type) as the second activity.

In some embodiments, the first activity includes detecting the subject in the environment. In some embodiments, the second activity includes detecting the subject in the environment.

In some embodiments, the subject is a first subject. In some embodiments, in response to receiving a notification that a second subject has been detected in the environment and in accordance with a determination that a registered user (e.g., resident and/or administrator, such as described above with respect to FIG. 4A) (e.g., an authorized user, and/or homeowner) is not detected in the environment (and/or after displaying the plurality of representations of activities performed by the subject), the computer system displays, via the one or more display components, a user interface element (e.g., 460) (e.g., a virtual button, an icon, a widget, a control, and/or a window) to view indications of activities of the second subject in the environment. In some embodiments, in response to receiving the notification that the second subject has been detected in the environment and in accordance with a determination that a registered user is detected in the environment, the computer system forgoes display of, via the one or more display components, the user interface element to view indications of activities of the second subject in the environment. In some embodiments, the second subject is different from the first subject. In some embodiments, the second subject is the same as the first subject. Only displaying a control to view indications of activities of a subject when a registered user is not detected in an environment allows the computer system to reduce notifications being sent by providing information about the environment when a registered user is not already present, thereby providing improved visual feedback to the user and/or performing an operation when a set of conditions has been met without requiring further user input.

In some embodiments, the notification that the subject has been detected in the environment is received from a resident device (e.g., as described above with respect to FIG. 4A) (e.g., a communication hub, a controller, a home hub, and/or a hub device). In some embodiments, the resident device is in communication with (and/or includes) one or more accessories (e.g., a light, a lock, a speaker, a television, a fan, an air conditioner, and/or a heater) within the environment. In some embodiments, the resident device and the one or more accessories are on the same wireless network, such as a local area network or a mesh network. In some embodiments, in response to receiving the notification from the second computer system that the subject has been detected in the environment (and/or in conjunction with displaying the user interface element to view indications of activities of the subject in the environment and/or in conjunction with detecting the input corresponding to the user interface element to view indications of activities of the subject in the environment), the computer system displays, via the one or more display components, a representation (e.g., 424) (e.g., a graphical representation, an image, user interface element, and/or button) of the notification that the subject has been detected in the environment. In some embodiments, in conjunction with includes before, after, and/or while. Displaying a representation of a notification that a subject has been detected in an environment in response to receiving the notification from a resident device allows the computer system to communicate with a device local to the environment when obtaining information about the environment, thereby providing improved visual feedback to the user and/or performing an operation when a set of conditions has been met without requiring further user input.

In some embodiments, the subject is a respective subject. In some embodiments, in response to receiving the notification that the respective subject has been detected in the environment, in accordance with a determination that the respective subject is a third subject, the computer system concurrently displays, via the one or more display components, the user interface element to view indications of activities of the third subject in the environment and a user interface element (e.g., 472) (e.g., a virtual button, an icon, a widget, a control, and/or a window) to contact (and/or communicate with) the third subject. In some embodiments, the user interface element to contact the third subject was not previously displayed. In some embodiments, in response to receiving the notification that the respective subject has been detected in the environment, in accordance with a determination that the respective subject is a fourth subject, the computer system concurrently displays, via the one or more display components, the user interface element to view indications of activities of the fourth subject in the environment and a user interface element (e.g., 472) to contact (and/or communicate with) the fourth subject without displaying the user interface element to contact the third subject, wherein the third subject is different from the fourth subject, and wherein the user interface element to contact the third subject is separate from the user interface element to contact the fourth subject. In some embodiments, in conjunction with (e.g., before, after, and/or while) displaying the user interface element to contact the third subject, the computer system forgoes display of the user interface element to contact the fourth subject. In some embodiments, the user interface element to contact the fourth subject was not previously displayed. Concurrently displaying a control to contact a subject currently being detected with a control to view different activities performed by the subject allows the computer system enable a user to contact personal devices of different subjects who are performing activities depending on who is being detected, thereby providing improved visual feedback to the user and/or performing an operation when a set of conditions has been met without requiring further user input.

In some embodiments, the plurality of representations of activities performed by the subject include activities performed since the subject was detected in the environment (e.g., the start of detected activity) until the subject is detected as exiting the environment (e.g., the end of detected activity) (e.g., such as described above with respect to FIG. 4B). In some embodiments, the first representation of the first activity and the second representation of the second activity are from separate times after detecting the subject in the environment (and/or before detecting the subject exit the environment). Displaying activities that were performed since a subject was detected in an environment and until the subject is detected as exiting the environment allows the computer system to reduce amount of information provided, thereby providing improved visual feedback to the user and/or performing an operation when a set of conditions has been met without requiring further user input.

In some embodiments, the first activity was detected during a first session and the second activity was detected during a second session separate from the first session (e.g., such as described above with respect to FIG. 4B). In some embodiments, the first session is different from the second session. In some embodiments, the first session is the same as the second session. In some embodiments, the first session includes a first period of time from when the subject was detected in the environment. In some embodiments, the first period of time is from the time the subject was detected in the environment to when the subject exits the environment. In some embodiments, the notification that the subject was detected in the environment occurred at a first occurrence. In some embodiments, the second session includes a second period of time from when the subject was detected in the environment on a second occurrence different from the first occurrence. In some embodiments, the first period of time is from the time the subject was detected in the environment on the second occurrence to when the subject exits the environment. Displaying different representations of different activities from different sessions allows the computer system to compile everything that a particular subject has done in an environment (and/or despite if the subject has left the environment) and provide such information in a user interface, thereby providing improved visual feedback to the user and/or performing an operation when a set of conditions has been met without requiring further user input.

In some embodiments, the subject is a respective subject. In some embodiments, while displaying the plurality of representations of activities performed by the respective subject, the computer system receives an indication (e.g., such as described above with respect to FIG. 4C) of a third activity of a fifth subject (e.g., the respective subject and/or a subject different from the respective subject), wherein the third activity of the fifth subject is separate from the first activity of the respective subject and the second activity of the respective subject. In some embodiments, the third activity of the fifth subject is different from the first activity of the respective subject and/or the second activity of the respective subject. In some embodiments, the third activity of the fifth subject is the same as the first activity of the respective subject and/or the third activity of the respective subject. In some embodiments, in response to receiving the indication of the third activity of the fifth subject (and/or without detection of an input via the one or more input devices), the computer system updates display of, via the one or more display components, the plurality of representations of activities performed by the respective subject to include a third representation (e.g., 480) of the third activity, wherein the third representation of the third activity is separate from the first representation of the first activity and the second representation of the second activity. In some embodiments, updating display of the plurality of representations of activities includes maintaining display of, via the one or more display components, the plurality of representations of activities performed by the respective subject and adding the third representation of the third activity. Updating representations of activities being performed by a subject as the subject performs additional activities allows the computer system to stay current with what is occurring in an environment, thereby providing improved visual feedback to the user and/or performing an operation when a set of conditions has been met without requiring further user input.

Note that details of the processes described above with respect to process 600 (e.g., FIG. 6) are also applicable in an analogous manner to other processes described herein. For example, process 600 optionally includes one or more of the characteristics of the various processes described above with reference to process 600. For example, displaying the user interface element to contact the first subject of process 500 can occur in response to detecting the subject in the environment of process 600. For brevity, these details are not repeated herein.

FIGS. 7A-7V illustrate exemplary user interfaces for displaying and ceasing to display content in response to input in accordance with some embodiments. The user interfaces in these figures are used to illustrate the processes described below, including the processes in FIGS. 8 and 9.

FIGS. 7A-7V illustrate computer system 700 as a smart phone. It should be recognized that computer system 700 can be other types of computer systems such as a tablet, a smart watch, a laptop, a communal device, a smart speaker, an accessory, a personal gaming system, a desktop computer, a fitness tracking device, and/or a head-mounted display (HMD) device. In some embodiments, computer system 700 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 700 includes and/or is in communication with one or more output devices (e.g., a display screen, a projector, a touch-sensitive display, a speaker, and/or a movement component). In some embodiments, computer system 700 includes one or more components and/or features described above in relation to computer system 100 and/or electronic device 200.

FIGS. 7A-7V are split between a left side and a right side to illustrate a subject in a physical environment interacting with computer system 790 via computer system 700. In some embodiments, computer system 790 a hub device that coordinates subject detection and management within physical environment 706. In such embodiments, the hub device can be present in the home and/or selected from a device within physical environment 706 based on known techniques for selecting an active hub device. In other embodiments, the hub device can be server outside of physical environment 706. In some embodiments, the hub device is in communication with multiple accessories represented in FIGS. 7A-7V. In such embodiments, the hub device, using information from the multiple accessories can facilitate detection and identification of subjects through various methods, such as visual recognition, biometric authentication, motion sensing, ultra-wideband (UWB), or communication with one or more of the multiple accessories, as described above with respect to FIGS. 4A-4F. In some embodiments, the hub device receives data from these accessories to determine guest presence, activities, or status changes, and communicates notifications or updates to computer system 700 for display.

In the examples illustrated in FIGS. 7A-7V, the right side illustrates a top-down schematic view of physical environment 706 that includes tablet representation 708 (e.g., representing a tablet located in the environment, and first user representation 704 (e.g., a person interacting with computer system 700 by providing inputs, the first user). In some embodiments, the relative positioning of first user representation 704 is indicative of relative physical positioning of the first user in a physical environment. The left side of FIGS. 7A-7V illustrate output of computer system 700. While FIGS. 7A-7V illustrate computer system 700 outputting particular content, it should be recognized that such content is merely for explanatory purposes and that such content can be in different forms, at different locations, at different sizes, include different content, and/or that more, fewer, and/or different content can be output in accordance with techniques described herein.

While the examples in FIGS. 7A-7V include computer system 790 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras. In some embodiments, inputs detected by computer system 790 are passive inputs that are not purposefully directed at computer system 790 by a subject (e.g., a person, an animal, an object, and/or a device). Examples of such inputs include, but are not limited to, motion of the subject through the environment, location of the subject within the environment, direction that the subject is facing and/or looking, light levels within the environment, and/or sound levels within the environment.

FIG. 7A illustrates computer system 700 displaying environment activities user interface 702. As illustrated in FIG. 7A, within environment activities user interface 702, computer system 700 displays one or more indications of activities detected by computer system 790 within in the environment in the order that they were detected.

FIG. 7B illustrates computer system 700 displaying user activity user interface 720. As illustrated in FIG. 7B, within user activity user interface 720, computer system 700 displays one or more indications of activities of a registered user (e.g., the first user) that are detected by computer system 790 within the environment. As illustrated in FIG. 7B, computer system 700 displays the indications of activities of the registered user in the order that they were detected.

FIG. 7C illustrates computer system 700 displaying user activity user interface 720 after a recognition scenario. In this recognition scenario, when the first user enters the environment, computer system 790 detects computer system 700, which is associated with the first user, and the first user's face is recognized by computer system 790 via one or more cameras in communication with computer system 790. At FIG. 7C, in response to the first user being detected at the environment, via computer system 790 detecting computer system 700, computer system 790 outputs a chime via living room smart speaker, as indicated by music notes 722. Also at FIG. 7C, in response to the first user being recognized by computer system 790, computer system 790 outputs a greeting to the first user (e.g., “Welcome home, Jane.”) via the living room smart speaker 710, as indicated by output 724. At FIG. 7C, in response to the first user arriving at the environment with computer system 700 and computer system 790 recognizing the first user, computer system 790 activates the cooling of the environmental control system of the environment to 68 degrees. It should be noted that this is just an example and that other automations of the environment can be activated, such as lights, shades, music, televisions, and/or locks.

FIG. 7D illustrates computer system 700 displaying user activity user interface 720 after a first scenario where computer system 790 does not recognize the first user and requires a second form of authentication to confirm the user. At FIG. 7D, the first user arrives at the environment and is detected by computer system 790 by detecting computer system 700. At FIG. 7D, in response to the first user being detected at the environment, via computer system 790 detecting computer system 700, computer system 790 outputs a chime via living room smart speaker, as indicated by music notes 722. At FIG. 7D, in response to the first user arriving at the environment with their face obscured (e.g., wearing a head, scarf, facemask, makeup, and/or glasses), computer system 790 requires the first user to verify their identity in a secondary manner. At FIG. 7D, the first user uses a facial recognition scan to unlock computer system 700 via one or more cameras of computer system 700. At FIG. 7D, in response to the first user unlocking computer system 700 via facial recognition scan, computer system 790 makes a determination that the first user is authenticated. At FIG. 7D, in response to computer system 790 making a determination that the first user is authenticated, computer system 790 computer system 790 outputs a greeting to the first user (e.g., “Welcome home, Jane.”) via the living room smart speaker, as indicated by output 724. At FIG. 7D, in response to the first user arriving at the environment with computer system 700 and computer system 790 making the determination that the first user is authenticated, computer system 790 activates the cooling of the environmental control system of the environment to 68 degrees. It should be noted that this is just an example and that other automations of the environment can be activated, such as lights, shades, music, televisions, and/or locks.

FIG. 7E illustrates computer system 700 displaying user activity user interface 720 after a second scenario where computer system 790 does not recognize the first user and requires a second form of authentication to confirm the user. At FIG. 7E, the first user arrives at the environment and is detected by computer system 790 by detecting computer system 700. At FIG. 7E, in response to the first user being detected at the environment, via computer system 790 detecting computer system 700, computer system 790 outputs a chime via living room smart speaker, as indicated by music notes 722. At FIG. 7E, in response to the first user arriving at the environment with their face obscured (e.g., wearing a head, scarf, facemask, makeup, and/or glasses), computer system 790 requires the first user to verify their identity in a secondary manner. At FIG. 7E, the first user walks up the tablet and the first user's face is recognized by the camera of the tablet. At FIG. 7E, in response to the tablet recognizing the first user's face, computer system 790 makes a determination that the first user is authenticated. At FIG. 7E, in response to making a determination that the first user is authenticated, computer system 790 outputs a greeting to the first user (e.g., “Welcome home, Jane.”) via the living room smart speaker, as indicated by output 724. At FIG. 7E, in response to the first user arriving at the environment with computer system 700 and computer system 790 making the determination that the first user is authenticated, computer system 790 activates the cooling of the environmental control system of the environment to 68 degrees. It should be noted that this is just an example and that other automations of the environment can be activated, such as lights, shades, music, televisions, and/or locks.

FIG. 7F illustrates computer system 700 displaying user activity user interface 720 after a third scenario where computer system 790 does not recognize the first user and requires a second form of authentication to confirm the user. At FIG. 7F, the first user arrives at the environment and is detected by computer system 790 by detecting computer system 700. At FIG. 7F, in response to the first user being detected at the environment, via computer system 790 detecting computer system 700, computer system 790 outputs a chime via living room smart speaker, as indicated by music notes 722. At FIG. 7F, in response to the first user arriving at the environment with their face obscured (e.g., wearing a head, scarf, facemask, makeup, and/or glasses), computer system 790 requires the first user to verify their identity in a secondary manner. At FIG. 7F, computer system 790 sends a notification to the first user's devices requesting that the first user confirm that it is them at the environment. At FIG. 7F, the first user confirms on the first user's smart watch that it is the first user in the environment. At FIG. 7F, in response to receiving a notification of the user confirming on the first user's smart watch that it is the first user in the environment, computer system 790 makes a determination that the first user is authenticated. At FIG. 7F, in response to making a determination that the first user is authenticated, computer system 790 outputs a greeting to the first user (e.g., “Welcome home, Jane.”) via the living room smart speaker, as indicated by output 724. At FIG. 7F, in response to the first user arriving at the environment with computer system 700 and computer system 790 making the determination that the first user is authenticated, computer system 790 activates the cooling of the environmental control system of the environment to 68 degrees. It should be noted that this is just an example and that other automations of the environment can be activated, such as lights, shades, music, televisions, and/or locks.

FIG. 7G illustrates computer system 700 displaying user activity user interface 720 after a scenario where the first user arrives at the environment without computer system 700. At FIG. 7F, the first user arrives at the environment and is identified by computer system 790 via one or more cameras in communication with computer system 790. At FIG. 7G, in response to computer system 790 detecting the first user at the environment while not detecting computer system 700, computer system 790 outputs a chime via living room smart speaker, as indicated by music notes 722. At FIG. 7G, in response to computer system 790 detecting the first user at the environment while not detecting computer system 700, computer system 790 outputs content via the living room smart speaker requesting that the first user verify their identity in a secondary manner (e.g., “Hi, Jane. Can you confirm it is you by verifying your PIN.”), as indicated by content 726. At FIG. 7G, the first user enters their PIN via the tablet. At FIG. 7G, in response to the first user entering their PIN via the tablet, computer system 790 makes a determination that the first user is authenticated. In some embodiments, in response to making a determination that the first user is authenticated, computer system 790 outputs a greeting to the first user (e.g., “Welcome home, Jane.”) via the living room smart speaker. At FIG. 7G, in response to the first user arriving at the environment with computer system 700 and computer system 790 making the determination that the first user is authenticated, computer system 790 activates the cooling of the environmental control system of the environment to 68 degrees. It should be noted that this is just an example and that other automations of the environment can be activated, such as lights, shades, music, televisions, and/or locks.

FIG. 7H illustrates computer system 700 displaying user activity user interface 720 after a scenario where the first user arrives at the environment while another registered occupant of the environment (e.g., a second user) is already recognized by computer system 790 at the environment. At FIG. 7H, in response to detecting the first user in the environment, via detecting computer system 700 and/or identifying the first user via one or more cameras in communication with computer system 790, while the second user is already in the environment, computer system 790 outputs a chime via living room smart speaker, as indicated by music notes 722. At FIG. 7H, in response to detecting the first user in the environment while detecting the second user is already in the environment, computer system 790 outputs content via the living room smart speaker alerting the second user that the first user has arrived at the environment (e.g., “Jane is home.”), as indicated by content 728. At FIG. 7H, in response to the second user already being in the environment when the first user is detected, computer system 790 does not activate the cooling of the environmental control system.

FIG. 7I illustrates computer system 700 displaying lock screen user interface 732. At FIG. 7I, a first guest (e.g., Phil), who is registered with computer system 790, arrives at the environment, as indicated by first guest representation 734 being illustrated within physical environment 706, and is recognized by computer system 790. As illustrated in FIG. 7I, in response to computer system 790 recognizing the first guest, computer system 700 displays recognized guest indicator 734 overlayed on lockscreen user interface 732. As illustrated in FIG. 7I, in response to computer system 790 continuing to detect the first guest at the environment, computer system 700 displays recognized guest indicator 734 indicating that the first guest is at the environment (e.g., Phil is at your home).

At FIG. 7J, at a time after FIG. 7I, the first guest (e.g., Phil) who is registered with computer system 790 is no longer at the environment, as indicated by first guest representation 734 not being illustrated within physical environment 706, and is no longer detected by computer system 790. As illustrated in FIG. 7H, in response to computer system 790 no longer detecting the first guest, computer system 700 displays recognized guest indicator 734 overlayed on lock screen user interface 732. As illustrated in FIG. 7H, in response to computer system 790 no longer detecting the first guest at the environment, computer system 700 displays a recognized guest indicator indicating that the first guest was formerly at the environment (e.g., Phil visited your home).

FIG. 7K illustrates computer system 700 displays recognized guest activity user interface 746. As illustrated in FIG. 7K, within recognized guest activity user interface 746, computer system 700 displays one or more indications of activities of a recognized guest (e.g., the first guest) that are detected by computer system 790 within the environment. As illustrated in FIG. 7J, computer system 700 displays the indications of activities of a recognized guest in the order that they were detected.

FIG. 7L illustrates computer system 700 displaying lock screen user interface 732. At FIG. 7K, a second guest (e.g., John the plumber), who is not registered with computer system 790, arrive at the environment. In response, computer system 790 outputs content requesting that the unregistered guess

FIG. 8 is a flow diagram illustrating a process (e.g., process 800) for displaying a camera feed corresponding to guest position in accordance with some embodiments. Some operations in process 800 are, optionally, combined, the orders of some operations are, optionally, changed, and some operations are, optionally, omitted.

As described below, process 800 provides an intuitive way for displaying a camera feed corresponding to guest position. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a computer system that is in communication with (and/or includes) one or more display components (e.g., a display screen, a projector, a head mounted display, and/or a touch-sensitive display) and one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the computer system is a watch, a phone, a tablet, a fitness tracking device, a processor, a head-mounted display (HMD) device, a communal device, a media device, a speaker, a television, and/or a personal computing device.

The computer system displays (802), via the one or more display components, a representation (e.g., a graphical and/or textual representation) of a notification of a subject being detected in an environment (e.g., a physical environment, such as a home, a room, a yard, and/or a building) with a user interface element (e.g., an icon, a widget, and/or a control) to review the subject being detected in the environment. In some embodiments, the subject is a user, a person, an animal, another computer system different from the computer system, a device, and/or an object. In some embodiments, the subject is an unknown subject, a recognized subject, and/or an identified subject. In some embodiments, the representation of the notification of the subject being detected in the environment is displayed within and/or adjacent to the user interface element to review the subject being detected in the environment. In some embodiments, the representation of the notification of the subject being detected in the environment includes a live view, a photo and/or a video of the subject captured by a camera.

While displaying the representation of the notification of the subject being detected in the environment with the user interface element to review the subject being detected in environment, the computer system detects (804), via the one or more input devices, an input (e.g., a tap input, a voice input, and/or an air gesture) corresponding to the user interface element to review the subject being detected in the environment. In some embodiments, the input is a tap input on the user interface element to review the subject being detected in the environment and/or a voice input requesting that an operation be performed (e.g., “Hey software agent, select the check-in button”). In some embodiments, the input includes an air gesture of a hand wave and/or pointing in a direction (e.g., pointing down) corresponding to selection of the user interface element to review the subject being detected in the environment.

In response to detecting the input corresponding to the user interface element to review the subject being detected in the environment and in accordance with a determination that the subject is in a first portion of the environment, the computer system displays (806), via the one or more display components, a representation of a first camera feed corresponding to (and/or from an external device located at) the first portion of the environment. In some embodiments, the first camera feed is the camera feed or a camera feed different from the camera feed. In some embodiments, in response to detecting the input corresponding to the user interface element to review the subject being detected in the environment and in accordance with a determination that the subject is in another portion of the environment different from the first portion of the environment, the computer system displays, via the one or more display components, a representation of a different camera feed corresponding to the other portion of the environment (e.g., without displaying the representation of the first camera feed corresponding to the first portion of the environment).

While displaying the first camera feed corresponding to the first portion of the environment, the computer system receives (808) an indication that the subject is at a second portion of the environment, wherein the second portion of the environment is different from the first portion of the environment.

In response to receiving the indication that the subject is in the second portion of the environment, the computer system displays (810), via the one or more display components, a representation of a second camera feed corresponding to (and/or from an external device located at) the second portion of the environment (and/or ceases display of the representation of the first camera feed corresponding to the first portion of the environment) (e.g., without displaying the representation of the first camera feed corresponding to the first portion of the environment), wherein the first camera feed is different from the second camera feed.

In some embodiments, in response to detecting the input corresponding to the user interface element to review the subject being detected in the environment and in accordance with the determination that the subject is in the first portion of the environment, the computer system displays (and/or concurrently displays), via the one or more display components, the representation of the first camera feed corresponding to the first portion of the environment and a representation (e.g., a graphical representation and/or a textual representation) of a first activity (and/or additional representations of activities) that occurred in the first portion of the environment corresponding to the subject. In some embodiments, in response to receiving the indication that the subject is in the second portion of the environment, the computer system displays (and/or concurrently displays), via the one or more display components, the representation of the second camera feed corresponding to the second portion of the environment and the representation of the first activity that occurred in the first portion of the environment corresponding to the subject. In some embodiments, in response to receiving the indication that the subject is in the second portion of the environment, the computer system displays (and/or concurrently displays), via the one or more display components, the representation of the second camera feed corresponding to the second portion of the environment and a representation of a different activity that occurred in the environment (e.g., the first portion of the environment, the second portion of the environment, and/or a different portion of the environment) corresponding to the subject.

In some embodiments, in response to receiving the indication that the subject is in the second portion of the environment, the computer system displays (and/or concurrently displays), via the one or more display components, the representation of the second camera feed corresponding to the second portion of the environment and a representation of a second activity that occurred in the second portion of the environment.

In some embodiments, while displaying the representation of the first camera feed corresponding to the first portion of the environment, the computer system displays (and/or concurrently displays), via the one or more display components, an indication that an administrator (e.g., an authenticated subject, homeowner, and/or resident) was sent a notification (and/or an additional administrator was sent the notification). In some embodiments, the indication that the administrator was sent the notification includes an identification of the administrator.

In some embodiments, the computer system is a first computer system. In some embodiments, the indication that the administrator was notified includes an identification of a second computer system corresponding to (e.g., owned by and/or of) the administrator that was sent the notification.

In some embodiments, the representation of the first activity that occurred in the first portion of the environment corresponding to the subject is displayed in accordance with a determination that a context of the subject detected in the environment satisfies a first set of one or more criteria, with media content of the first activity. In some embodiments, the representation of the first activity that occurred in the first portion of the environment corresponding to the subject is displayed in accordance with a determination that the context of the subject detected in the environment satisfies a second set of one or more criteria, without the media content of the first activity, wherein the second set of one or more criteria is different from the first set of one or more criteria.

In some embodiments, in response to detecting the input corresponding to the user interface element to review the subject being detected in the environment and in accordance with the determination that the subject is in the first portion of the environment, the computer system displays (and/or concurrently displays), via the one or more display components, an indication (e.g., a representation, an identification, a graphical icon, and/or a textual description) of the first portion of the environment (e.g., with the representation of the first camera feed corresponding to the first portion of the environment). In some embodiments, in response to receiving the indication that the subject is in the second portion of the environment, the computer system displays (and/or concurrently displays), via the one or more display components, an indication (e.g., a representation, an identification, a graphical icon, and/or a textual description) of the second portion of the environment (e.g., with the representation of the second camera feed corresponding to the second portion of the environment).

In some embodiments, in response to detecting the input corresponding to the user interface element to review the subject being detected in the environment and in accordance with the determination that the subject is in the first portion of the environment, the computer system displays (and/or concurrently displays), via the one or more display components, a user interface element (e.g., a virtual button, an icon, a widget, a control, and/or a window) to contact the subject (e.g., with the representation of the first camera feed corresponding to the first portion of the environment). In some embodiments, in response to receiving the indication that the subject is in the second portion of the environment, the computer system displays (and/or concurrently displays and/or maintains display of), via the one or more display components, the user interface element to contact the subject (e.g., with the representation of the second camera feed corresponding to the second portion of the environment). In some embodiments, while displaying the user interface element to contact the subject, the computer system detects, via the one or more input devices, an input (e.g., a tap input and/or a voice input) corresponding to the user interface element to contact the subject. In some embodiments, in response to detecting the input corresponding to the user interface element to contact the subject, the computer system initiates a communication (e.g., a video call, text message, and/or phone call) with the subject. In some embodiments, initiating a communication with the subject includes displaying, via the one or more display components, a user interface corresponding to a communications application (e.g., a messaging application or a calling application).

In some embodiments, in response to detecting the input corresponding to the user interface element to review the subject being detected in the environment and in accordance with the determination that the subject is detected in the first portion of the environment, the computer system displays (and/or concurrently displays), via the one or more display components, a user interface element (e.g., a virtual button, an icon, a widget, a control, and/or a window) to contact emergency services (e.g., with the representation of the first camera feed corresponding to the first portion of the environment). In some embodiments, in response to detecting the indication that the subject is in the second portion of the environment, the computer system displays (and/or concurrently displays and/or maintains display of), via the one or more display components, the user interface element to contact the emergency services (e.g., with the representation of the second camera feed corresponding to the second portion of the environment). In some embodiments, while displaying the user interface element to contact emergency services, the computer system detects, via the one or more input devices, an input (e.g., a tap input and/or a voice input) corresponding to the user interface element to contact the emergency services. In some embodiments, in response to detecting the input corresponding to the user interface element to contact emergency services, the computer system initiates a communication (e.g., a video call, text message, and/or phone call) with the emergency services. In some embodiments, initiating a communication with the emergency services includes displaying, via the one or more display components, a user interface corresponding to a communications application (e.g., a messaging application or a calling application).

In some embodiments, in response to detecting the input corresponding to the user interface element to review the subject being detected in the environment and in accordance with the determination that the subject is in the first portion of the environment, in accordance with a determination that the first portion of the environment includes a speaker, the computer system displays, via the one or more display components, a user interface element to unmute (e.g., enable inputs to a microphone of the one or more input devices) (e.g., with the representation of the first camera feed corresponding to the first portion of the environment). In some embodiments, in response to detecting an input (e.g., a tap input and/or a voice input) corresponding to the user interface element to unmute, the computer system enables voice inputs detected via a microphone. In some embodiments, in response to detecting a voice input, the computer system sends an indication of the voice input to the speaker in the first portion of the environment for output by the speaker. In some embodiments, in response to detecting the input corresponding to the user interface element to review the subject being detected in the environment and in accordance with the determination that the subject is in the first portion of the environment, in accordance with a determination that the first portion of the environment does not include a speaker, the computer system forgoes display of, via the one or more display components, the user interface element to unmute.

In some embodiments, the computer system is a first computer system. In some embodiments, in response to detecting the input corresponding to the user interface element to review the subject being detected in the environment and in accordance with the determination that the subject is in the first portion of the environment, the first computer system displays, via the one or more display components, a control of a third computer system associated with the first camera feed, wherein the third computer system is different from the first computer system. In some embodiments, in response to receiving the indication that the subject is in the second portion of the environment, the first computer system displays, via the one or more display components, a control of a fourth computer system associated with the second camera feed, wherein the fourth computer system is different from the first computer system and the third computer system, and wherein the control of the third computer system is separate from the control of the fourth computer system.

In some embodiments, the computer system is a first computer system. In some embodiments, after displaying the representation of the first camera feed and before receiving the indication that the subject is at the second portion of the environment, the first computer system detects, via the one or more input devices, an input corresponding to a request to speak to the subject. In some embodiments, in response to detecting the input corresponding to the request to speak to the subject, the first computer system sends, to a fifth computer system associated with the first portion of the environment, audio content detected by the first computer system, wherein the fifth computer system is different from the first computer system, and wherein the fifth computer system is in the first portion of the environment.

In some embodiments, while displaying the representation of the second camera feed, the computer system detects, via the one or more input devices, an input corresponding to a request to review the subject being detected in the environment at a previous time. In some embodiments, in response to detecting the input to review the subject being detected in the environment at the previous time and in accordance with a determination that the subject was at the first portion of the environment at the previous time, the computer system displays, via the one or more display components, a representation of the first camera feed at the previous time. In some embodiments, in response to detecting the input to review the subject being detected in the environment at the previous time and in accordance with a determination that the subject was at a third portion of the environment at the previous time, the computer system displays, via the one or more display components, a representation of a third camera feed at the previous time, wherein the third camera feed corresponds to a third portion of the environment, wherein the third camera feed is different from the first camera feed, and wherein the third portion of the environment is different from the first portion of the environment.

In some embodiments, while displaying the representation of the second camera feed, the computer system detects, via the one or more input devices, an input corresponding to a request to review the second camera feed at a respective time. In some embodiments, in response to detecting the input corresponding to the request to review the second camera feed at the respective time and in accordance with a determination that the respective time is a first time, the computer system displays, via the one or more display components, a representation of the second camera feed at the first time, wherein the representation of the second camera feed at the first time is different from the representation of the second camera feed displayed in response to receiving the indication that the subject is in the second portion of the environment. In some embodiments, in response to detecting the input corresponding to the request to review the second camera feed at the respective time and in accordance with a determination that the respective time is a second time, the computer system displays, via the one or more display components, a representation of the second camera feed at the second time, wherein the second time is different from the first time, wherein the representation of the second camera feed at the second time is different from the representation of the second camera feed at the first time and the representation of the second camera feed displayed in response to receiving the indication that the subject is in the second portion of the environment.

In some embodiments, the computer system is a first computer system, the determination that the subject is detected in the first portion of the environment includes receiving from a seventh computer system an indication that the subject has been detected by the seventh computer system, the seventh computer system is different from the first computer system, the seventh computer system captures the first camera feed, receiving the indication that the subject is in the second portion of the environment is detected in the second portion of the environment includes receiving from an eighth computer system the indication that the subject has been detected in the second portion of the environment by the eighth computer system, the eighth computer system is different from the first computer system and the seventh computer system, and the eighth computer system captures the second camera feed.

In some embodiments, in response to detecting the input corresponding to the user interface element to review the subject being detected in the environment and in accordance with the determination that the subject is in the first portion of the environment, the computer system displays, via the one or more display components, a user interface including the representation of the first camera feed corresponding to the first portion of the environment. In some embodiments, in response to receiving the indication that the subject is in the second portion of the environment, the computer system displays, via the one or more display components, the user interface including the representation of the second camera feed corresponding to the second portion of the environment.

In some embodiments, after displaying the representation of the second camera feed, the computer system detects, via the one or more input devices, an input to review the subject being detected in the environment. In some embodiments, in response to detecting the input to review the subject being detected in the environment and in accordance with a determination that the subject is being detected at a fifth portion of the environment, the computer system displays, via the one or more display components, a representation of a fifth camera feed corresponding to the fifth portion of the environment. In some embodiments, in response to detecting the input to review the subject being detected in the environment and in accordance with a determination that the subject is being detected at a sixth portion of the environment, displaying, via the one or more display components, a representation of a sixth camera feed corresponding to the sixth portion of the environment, wherein the sixth camera feed corresponding to the sixth portion of the environment is different from the fifth camera feed corresponding to the fifth portion of the environment.

In some embodiments, after displaying the representation of the second camera feed, the computer system detects, via the one or more input devices, an input to review a seventh camera feed corresponding to a seventh portion of the environment. In some embodiments, in response to detecting the input to review the seventh camera feed corresponding to the seventh portion of the environment, the computer system displays, via the one or more display components, a representation of the seventh camera feed corresponding to the seventh portion of the environment.

Note that details of the processes described above with respect to process 800 (e.g., FIG. 8) are also applicable in an analogous manner to other processes described herein. For example, process 900 optionally includes one or more of the characteristics of the various processes described above with reference to process 800. For example, displaying the media content based on the criteria of process 900 can be displayed while displaying the representation of the second camera feed of process 800. For brevity, these details are not repeated herein.

FIG. 9 is a flow diagram illustrating a process (e.g., process 900) for displaying media based on context in accordance with some embodiments. Some operations in process 900 are, optionally, combined, the orders of some operations are, optionally, changed, and some operations are, optionally, omitted.

As described below, process 900 provides an intuitive way for displaying media based on context. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a computer system that is in communication (e.g., wired or wirelessly) with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) and one or more display components (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

The computer system detects (902), via the one or more input devices, an input (e.g., a tap input and/or a voice input) corresponding to a request to display an activity log (e.g., a list of activity performed in an environment and/or in an area, such as lit of activity performed by a single subject or any subject).

In response to detecting the input corresponding to the request to display the activity log, the computer system displays (904), via the one or more display components, an indication of a subject (and/or an indication of when and/or where the subject was detected in an environment): (906) in accordance with a determination that authentication of the subject detected in an environment satisfies a first set of one or more criteria (e.g., that the subject is not identified, not authenticated via a first factor of authentication, and/or is authenticated via the first factor of authentication but is not authenticated via a second factor of authentication different from the first factor of authentication), with media content (e.g., audio, a video, and/or an image) captured of the subject; and in accordance with (908) a determination that authentication of the subject detected in the environment satisfies a second set of one or more criteria (e.g., that the subject is identified and/or authenticated, such as via the first factor of authentication and/or the second factor of authentication), without media content (e.g., audio, a video, and/or an image) captured of the subject. In some embodiments, the computer system displays an indication of a number of events that correspond to the subject. In some embodiments, in response to detecting an input corresponding to the indication of the number of events that correspond to the subject, the computer system displays representations of each event.

In some embodiments, in response to detecting the input corresponding to the request to display the activity log, the computer system displays, via the one or more display components, an indication (e.g., a representation, an identification, a graphical icon, and/or a textual description) of an activity (e.g., entering a room, leaving a room, being identified, being authenticated, changing a state of an accessory device, walking to an area, sleeping, and/or the like) that occurred within the environment (e.g., by the subject and/or another subject different from the subject), wherein the activity does not correspond to (and/or is not represented in) the media content (e.g., the media content corresponds to another activity different from the activity that occurred within the environment).

In some embodiments, in response to detecting the input corresponding to the request to display the activity log, the computer system displays, via the one or more display components, an indication (e.g., a representation, an identification, a graphical icon, and/or a textual description) of an activity (e.g., entering a room, leaving a room, being identified, being authenticated, changing a state of an accessory device, walking to an area, sleeping, and/or the like) performed by the subject (and/or another subject different from the subject), wherein the activity does not correspond to (and/or is not represented in) the media content (e.g., the media content corresponds to another activity different from the activity performed by the subject). In some embodiments, the indication of the activity performed by the subject is separate from the indication of the activity that occurred within the environment.

In some embodiments, the first set of one or more criteria includes a criterion that is satisfied when the subject is not able to be identified (e.g., by the computer system, such as (1) the subject is an unidentified subject, (2) an identity of the subject is an unknown subject, and/or (3) an identity of the subject is not able to be identified). In some embodiments, the second set of one or more criteria includes a criterion that is satisfied when the subject is able to be identified (e.g., by the computer system, such as (1) the subject is an identified subject, (2) an identity of the subject is detected, and/or (3) an identity of the subject is able to be identified).

In some embodiments, the media content displayed with the indication of the subject is first media content (e.g., an image, an audio recording, and/or a video). In some embodiments, the indication of the subject is displayed with second media content (e.g., an image, an audio recording, and/or a video), different from the first media content, in accordance with a determination that authentication of the subject detected in the environment satisfies a third set of one or more criteria (e.g., that the subject is not identified, not authenticated via a first factor of authentication, and/or is authenticated via the first factor of authentication but is not authenticated via a second factor of authentication different from the first factor of authentication). In some embodiments, the first set of one or more criteria includes a criterion that is satisfied when the subject has a first level of authentication (e.g., that a first form of authentication has been satisfied for the subject but a second form of authentication, separate from the first form of authentication, has not been satisfied for the subject). In some embodiments, the third set of one or more criteria includes a criterion that is satisfied when the subject has a second level of authentication (e.g., that the first form of authentication and the second form of authentication has been satisfied for the subject). In some embodiments, the second level of authentication is different from the first level of authentication. In some embodiments, the third set of one or more criteria is different from the first set of one or more criteria and the second set of one or more criteria.

In some embodiments, in response to detecting the input corresponding to the request to display the activity log, the computer system displays, via the one or more display components, an indication that a notification has been sent to a set of one or more people. In some embodiments, the set of one or more people is an administrator of the computer system and/or the environment. In some embodiments, the indication that the notification has been sent to the set of one or more people includes an identification of each person in the set of one or more people.

Note that details of the processes described above with respect to process 900 (e.g., FIG. 9) are also applicable in an analogous manner to the processes described herein. For example, process 800 optionally includes one or more of the characteristics of the various processes described herein with reference to process 900. For example, detecting the input to display the activity log of process 900 can occur while displaying the representation of the second camera feed of process 600. For brevity, these details are not repeated herein.

FIGS. 10A-10H illustrate exemplary user interfaces for displaying information about an environment in accordance with some embodiments. The user interfaces in these figures are used to illustrate the processes described below, including the processes in FIGS. 11 and 12.

FIGS. 10A-10H illustrate computer system 1000 as a smart phone. At FIGS. 10A-10H, computer system 1000 is configured to receive notifications from a home (physical environment 1006, described below). It should be recognized that computer system 1000 can be other types of computer systems such as a tablet, a smart watch, a laptop, a communal device, a smart speaker, an accessory, a personal gaming system, a desktop computer, a fitness tracking device, and/or a head-mounted display (HMD) device. In some embodiments, computer system 1000 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 1000 includes and/or is in communication with one or more output devices (e.g., a display screen, a projector, a touch-sensitive display, a speaker, and/or a movement component). In some embodiments, computer system 1000 includes one or more components and/or features described above in relation to computer system 100 and/or electronic device 200.

FIGS. 10A-10H are split between a left side and a right side. In the examples illustrated in FIGS. 10A-10H, the right side illustrates a top-down schematic view of physical environment 1006 (e.g., the “home”) that includes a main room, an office, and a bedroom. The main room of physical environment 1006 includes kitchen tablet 1008 (e.g., representing a tablet located in the main room), speaker 1010 (e.g., representing a speaker located in the main room), and camera 1014 (e.g., representing a camera located in the main room). The bedroom includes speaker 1012 (e.g., representing a speaker located in the bedroom). The office includes office camera 1016 (e.g., representing a camera located in the office). The left side of FIGS. 10A-10H illustrate output of computer system 1000. While FIGS. 10A-10H illustrate computer system 1000 outputting particular content, it should be recognized that such content is merely for explanatory purposes and that such content can be in different forms, at different locations, at different sizes, include different content, and/or that more, fewer, and/or different content can be output in accordance with techniques described herein.

In some embodiments, computer system 1000 is in communication with a hub device that coordinates subject detection and management within the home. In such embodiments, the hub device can be present in the home and/or selected from a device within the home based on known techniques for selecting an active hub device. In other embodiments, the hub device can be server outside of the home. In some embodiments, the hub device is in communication with multiple accessories represented in FIGS. 10A-10H, including speaker 1010, entry camera 1014, kitchen tablet 1008, office camera 1016, and bedroom speaker 1012. In such embodiments, the hub device, using information from the multiple accessories can facilitate detection and identification of subjects through various methods, such as visual recognition, biometric authentication, motion sensing, ultra-wideband (UWB), or communication with one or more of the multiple accessories, as described above with respect to FIGS. 4A-4F. In some embodiments, the hub device receives data from these accessories to determine guest presence, activities, or status changes, and communicates notifications or updates to computer system 1000 for display.

While the examples in FIGS. 10A-10H include computer system 1000 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras. In some embodiments, inputs detected by computer system 1000 are passive inputs that are not purposefully directed at computer system 1000 by a subject (e.g., a person, an animal, an object, and/or a device). Examples of such inputs include, but are not limited to, motion of the subject through the environment, location of the subject within the environment, direction that the subject is facing and/or looking, light levels within the environment, and/or sound levels within the environment.

As illustrated in FIG. 10A, computer system 1000 displays lock screen user interface 1002 including a time of “11:02.” At FIG. 10A, unknown person 1004 (hereinafter referred to as John) is detected by entry camera 1014 in the main room of the home.

At FIG. 10A, John is unable to be identified once within the home. In some embodiments, John cannot be identified because a portion of his face is covered. For example, John is wearing a scarf and/or a hat such that one or more facial features (e.g., eyes, mouth, nose and/or ears) of John are covered. In some embodiments, John cannot be identified because John's personal device is not within a predetermined distance of a computer system responsible for identifying subjects within the home. For example, a smart phone and/or a smart watch belonging to John is not within a predetermined distance of kitchen tablet 1008 so the smart phone and/or smart watch cannot be identified by kitchen tablet 1008. In some embodiments, John cannot be identified because John is not registered with a computer system that is responsible for identifying subjects who enter the home (e.g., the hub device or kitchen tablet 1008).

At FIG. 10A, because John is detected in the home and cannot be identified, the hub device sends a notification to computer system 1000 (e.g., the smartphone of the homeowner, an administrator, or a designated recipient of the notification). In some embodiments, the designated recipient of the notification is a resident (e.g., a homeowner, an administrator, or long-term occupant) of the home. In some embodiments, the designated recipient of the notification is a guest (e.g., a person who is allowed to be in the home for a period of time) of the home.

As illustrated in FIG. 10A, in response to receiving the notification, computer system 1000 displays notification 1018 overlaid on lock screen user interface 1002. Notification 1018 includes text that an unknown person is in the home. Notification 1018 includes control 1020 to resolve the notification, labeled “It's OK,” and control 1022 to check in, labeled “Check In”. In some embodiments, in response to detecting a selection of control 1020, computer system 1000 ceases display of notification 1018. In some embodiments, in response to detecting a selection of control 1020, computer system 1000 cancels an alarm caused by John since he cannot be identified. For example, in response to detecting John in the home, an alarm in the home is pending confirmation and/or denial of the unknown person. In such an example, in response to detecting a selection of control 1020, computer system 1000 sends a request to cancel the alarm. For another example, in response to detecting John in the home, an alarm is ringing in the home. In such an example, in response to detecting a selection of control 1020, computer system 1000 sends a request to stop the alarm from ringing in the home. In some embodiments, in response to detecting a selection of control 1020, computer system 1000 modifies notification 1018 to cease display of control 1020 and control 1022 while maintaining text of the unknown person in the house.

In some embodiments, computer system 1000 displays lock screen user interface 1002 including notification 1018 with additional elements, such as an image captured by entry camera 1014 or an indication of the time of detection. For example, in response to not identifying John, computer system 1000 displays notification 1018 with an image captured of John in the home. In such an example, providing an image captured of John in the notification enables a user to identify an action to take without requiring additional taps to review further information corresponding to the notification. For another example, in response to identifying John as a known guest or resident, computer system 1000 displays text indicating the identity of the person (e.g., “John”).

At FIG. 10A, computer system 1000 detects input 1005a on control 1022. It should be recognized that input 1005a is an example of a tap input (e.g., a selection input), but can be other inputs, such as a verbal input or an air gesture directed to computer system 1000. For example, a verbal input of, “Check that out”. For another example, an air gesture directed to control 1022 such as pointing down to select the bottom control.

As illustrated in FIG. 10B, John has moved in the main room from the entry towards the kitchen, as illustrated by unknown person 1004 now being closer to kitchen tablet 1008 than entry camera 1014. In response to detecting input 1005a on control 1022, computer system 1000 expands notification 1018 to: include camera feed 1024 from a camera that is currently detecting John, which is kitchen tablet 1008, cover the entire display of computer system 1000, cease display of the time, and replace control 1022 with control 1026 labeled “See Activity” while maintaining display of control 1020. As illustrated in FIG. 10B, notification 1018 includes text identifying the feed is coming from kitchen tablet 1008 (e.g., “kitchen tablet”) under camera feed 1024.

At FIG. 10B, entry camera 1014 still captures John, but computer system 1000 displays the live feed from kitchen tablet 1008. In some embodiments, computer system 1000 displays the live feed from a camera that currently detects John. For example, computer system 1000 displays the live feed from kitchen tablet 1008 because John is detected by kitchen tablet 1008 and not entry camera 1014. For another example, computer system 1000 displays the live feed from entry camera 1014 because John is detected by entry camera 1014 and not kitchen tablet 1008. In some embodiments, multiple devices detect John, and computer system 1000 displays the live feed of a camera that provides the highest fidelity capture of John. For example, computer system 1000 displays the live feed from kitchen tablet 1008 because John is closer to kitchen tablet 1008 than other cameras in the main room. For another example, computer system 1000 displays the live feed from kitchen tablet 1008 because John is facing kitchen tablet 1008 and not other cameras in the home.

In some embodiments, computer system 1000 displays the live feed from a camera that detected John, regardless of their movement in the home. For example, computer system 1000 displays the live feed from entry camera 1014 because John was detected by entry camera 1014. In such an example, computer system 1000 displays the live feed from camera 1014 despite John being closer to kitchen tablet 1008. In such an example, computer system 1000 displays the live feed from entry camera 1014 even when input 1005a on control 1002 is detected at a later time when John is no longer detected by entry camera 1014. For another example, John is detected in the office and computer system 1000 displays the live feed from entry camera 1014 because John was detected by entry camera 1014 initially.

At FIG. 10B, computer system 1000 detects input 1005b on camera feed 1024. It should be recognized that input 1005b is an example of a tap input (e.g., a selection input), but can be other inputs, such as a verbal input or an air gesture directed to computer system 1000. For example, a verbal input of, “Show me the camera feed”. For another example, an air gesture directed to camera feed 1024 such as pressing a finger and thumb together.

As illustrated in FIG. 10C, in response to detecting input 1005b on camera feed 1024, computer system 1000 replaces notification 1018 with camera feed user interface 1030. At FIG. 10C, camera feed user interface 1030 is a user interface of an application that manages and/or views alerts and activities. Camera feed user interface 1030 includes camera feed 1024, camera controls 1030a, scrub control 1030b, button 1030c to bring up a list of all cameras available, a “get help” button, a “talk” button, and an “it's ok” button. In some embodiments, in response to detecting an input on camera controls 1030a, computer system 1000 causes a corresponding device to physically move (e.g., pan, tilt, and/or zoom) to adjust a camera's field of view. In some embodiments, in response to detecting an input on camera controls 1030a, computer system 1000 crops or digitally adjusts the live feed displayed in camera feed 1024 without physically moving the corresponding device. For example, in response to a tap input on the up arrow in camera control 1030a, computer system 1000 causes kitchen tablet 1008 to pan physically upwards. For another example, in response to a press and hold on a left arrow in camera control 1030a, computer system 1000 causes the live feed displayed in camera feed 1024 to digitally pan to the left. In some embodiments, camera controls 1030a are not displayed if the corresponding device cannot be moved or digitally adjusted. Camera feed user interface 1030 also includes text label 1030d of the status of the unknown person (e.g., “Seen”) and the corresponding device that detected the person (e.g., “on kitchen tablet”). In some embodiments, the status of the unknown person changes based on a device that detected the person. For example, text label 1030d indicates “Heard” if the detected person's voice is captured by a microphone of the device. For another example, text label 1030d indicates “Detected motion” if the unknown person is identified through motion sensing by the device. The subject within camera feed 1024 is the unknown person, John, detected in the home and that is reflected by activities button 1032 being labeled with a “?”. In some embodiments, John is identified and activities button 1032 includes a label (“John”) to review activities of John.

In some embodiments, in response to detecting selection of the “get help” button, computer system 1000 initiates a call to emergency services. For example, in response to detecting selection of the “get help” button, computer system 1000 displays a button that allows the user to contact an emergency contact and/or emergency services. For another example, in response to detecting selection of the “get help” button, computer system 1000 initiates a call to emergency services without displaying a menu. In some embodiments, in response to detecting selection of the “talk” button, computer system 1000 sends voice content to a device within the home to be output in the home. For example, in response to detecting selection of the “talk” button, computer system 1000 initiates a walky-talky mode that allows the user to send voice content to the device in real time. For another example, in response to detecting selection of the “talk” button, computer system 1000 toggles an on/off mode that allows the user to send voice content to the device.

In some embodiments, in response to detecting a drag and hold input on scrub control 1030b, computer system 1000 scrubs the timeline of recording of the unknown person. For example, in response to detecting a drag and hold input on scrub control 1030b, computer system 1000 displays a combined feed where scrubbing rewinds between multiple cameras at each instance corresponding to a device closest to or best capturing the unknown person. For another example, in response to detecting a drag and hold input on scrub control 1030b, computer system 1000 displays only the feed for a camera currently displayed in camera feed 1024, in which case is kitchen tablet 1008.

In some embodiments, camera feed user interface 1030 is displayed in response to detecting input 1005a on control 1022 instead of expanded notification 1018 such as described above with respect to FIG. 10B. In some embodiments, camera feed user interface 1030 includes an indication that the live camera feed is live (e.g., a red dot and/or a text label of “live”) (e.g., and an indication that a camera feed is not live, such as a time of the camera feed, when the camera feed is not live). In some embodiments, camera feed 1024 includes a label for the camera streaming to live camera feed 1024 (e.g., a label of “tablet” or “entry camera”).

As illustrated in FIG. 10D, John has moved from the kitchen to the office, as illustrated by unknown person 1004 now being closer to office camera 1016. At FIG. 10D, John is detected in the office. In some embodiments, John is detected in the office by office camera 1016. In response to John being detected in the office, computer system 1000 updates display of camera feed user interface 1030 and replaces display of camera feed 1024 with camera feed 1034. Stated differently, in response to John being detected by office camera 1016, computer system 1000 (1) displays the live feed from office camera 1016 and stops displaying the live feed from kitchen tablet 1008 and (2) changes text label 1030d to reflect that (now reading “Seen on Office Camera”). At FIG. 10D, computer system 1000 maintains display of the “get help” and “it's ok” buttons. At FIG. 10D, office camera 1016 does not have a speaker. Because there is no speaker in the office, computer system 1000 stops showing the “talk” button. The tablet has speakers that can be used to speak to the unknown person in FIG. 10C, so computer system 1000 displays the “talk” button.

In some embodiments, computer system 1000 displays a previous feed from a different user interface. For example, John moved to the entry and is captured by entry camera 1014. In such an example, computer system 1000 replaces display of camera feed 1024 with a camera feed from entry camera 1014.

In some embodiments, instead of computer system 1000 changing the camera feed in response to detecting John move to the office, a user of computer system 1000 manually selects office camera 1016. For example, computer system 1000 detects an input on button 1030c and in response displays a list of devices in the home, including buttons to display the feed from office camera 1016 and a separate button to display the live feed from entry camera 1014. In such an example, in response to detecting an input on the button to display the live feed from office camera 1016, computer system 1000 ceases display of the list and displays camera feed 1034. For another example, in response to detecting an input on the button to display the live feed from entry camera 1014, computer system 1000 ceases display of the list and displays the live feed from entry camera 1014.

At FIG. 10D, computer system 1000 detects an input on activities button 1032. It should be recognized that the input is an example of a tap input (e.g., a selection input), but can be other inputs, such as a verbal input or an air gesture directed to computer system 1000. For example, a verbal input of, “See activities”. For another example, an air gesture directed to activities button 1032 such as pressing a finger and thumb together.

As illustrated in FIG. 10E, John has moved from the office towards the bedroom, as illustrated by unknown person 1004 now being in front of the door to the bedroom. At FIG. 10E, in response to detecting the input on activities button 1032, computer system 1000 displays activities user interface 1036 and ceases display of camera feed user interface 1030. Activities user interface 1036 includes icon 1038 for the unknown person and text label 1062 “Unrecognized Person.” Although the unknown person is displayed including a “?” in some embodiments, icon 1038 is replaced with an image of the unrecognized person captured by a camera. For example, icon 1038 can be replaced with an image from the video captured of John in the entry. In some embodiments, icon 1038 updates as better images of John are captured as he moves in the home. For example, the image of John in the entry can be replaced with an image of John captured by kitchen tablet 1008. For another example, the image of John in the entryway can be replaced with an image of John captured by office camera 1016.

As illustrated in FIG. 10E, activities user interface 1036 includes a chronological list of activities of John detected within the home (e.g., as described above, including being detected by entry camera 1014, detected by the kitchen tablet, being detected by the office camera) under text label 1062. At FIG. 10E, the list of activities includes (1) indication 1040 of John (again, not identified) being detected in the entry by entry camera 1014, (2) indication 1042 that the hub device sent a notification to the homeowner (e.g., computer system 1000), (3) indication 1044 that John was seen in the kitchen by kitchen tablet 1008, and (4) indication 1046 that John was seen in the office by office camera 1016. Indication 1040, indication 1042, indication 1044, and indication 1046 include a time of when they were detected and/or notified, 11:02, 11:02, 11:05, and 11:06 respectively. Indication 1042 includes text that the hub device sent a notification to the homeowner, to indicate that there was a notification sent. In some embodiments, indication 1042 includes an indication of which device that the notification was sent. For example, indication 1042 can include an identification of a homeowner's phone. For another example, indication 1042 can include an identification of a resident's tablet. In some embodiments, the notification is sent to a device of the homeowner that is closest to the home. In some embodiments, if additional residents to the home are notified, the chronological list of activities include other indications of other notifications that were sent to the residents, such other indications including name corresponding to the residents. For example, the chronological list of activities can include an indication that a notification was sent to a resident named Jane and/or Steve.

At FIG. 10E, in each indication of the unknown person being seen, computer system 1000 includes a video of the subject from that event and from a corresponding device, such as indication 1040 including a video control 1040a, indication 1044 including video control 1044a, and indication 1046 including a video control 1046a. At FIG. 10E, an unknown person event warrants video controls for each detected event. In some embodiments, video controls are provided depending on a context of the event. For example, when an event identifies the detected subject is a resident of the home, the event and additional events do not include video controls because there is no triggered alarm. For another example, when the event is a fire alarm, the event and includes video controls for manual review so a user can look around a space to understand the scope of the fire alarm. In some embodiments, in response to detecting an input on a video control, computer system 1000 displays captured video of the event despite if the user is in another room. For example, in response to selecting video control 1040a, computer system 1000 displays a recorded video of when John was detected in the entry, despite John currently being in front of the bedroom door. For another example, in response to selecting video control 1044a, computer system 1000 displays a recorded video of when John was detected in the kitchen, despite John currently being in front of the bedroom door. In some embodiments, photos or audio are taken for certain events and a corresponding photo or audio control is displayed. For example, when an event is detected by a speaker without a camera, an audio control is displayed to play the captured audio. For another example, when an event is a motion detection without video, a photo control is displayed to view the captured photo.

As illustrated in FIG. 10F, John has moved into the bedroom, as illustrated by unknown person 1004 now being in front of bedroom speaker 1012. At FIG. 10F, John is detected in the bedroom. In some embodiments, John is detected in the bedroom by bedroom speaker 1012. In response to John being detected in the bedroom, computer system 1000 updates display of activities user interface 1036 to include indication 1048 of John being detected by bedroom speaker 1012. As illustrated in FIG. 10F, computer system 1000 displays indication 1048 while maintain display of indication 1046, video control 1046a, indication 1044, video control 1044a, and indication 1042 and ceases display of indication 1040 and video control 1040a. In some embodiments, John is detected in the bedroom based on sounds in the room via a speaker of bedroom speaker 1012. For example, footsteps are detected in the bedroom, and a determination is made that John is in the bedroom based on the context (e.g., John recently being detected in other rooms and/or John being detected outside the bedroom). For another example, a voice is detected in the bedroom and a determination is made that John is in the bedroom.

In some embodiments, indication 1048 includes a control to play audio captured by bedroom speaker 1012. For example, in response to detecting a selection of the control to play audio, computer system 1000 outputs audio of footstep sounds and/or a voice captured. For another example, in response to detecting a selection of the control to play audio, computer system 1000 displays a user interface for controlling playback of the captured audio.

In some embodiments, while displaying activities user interface 1036, computer system 1000 detects a scroll input (e.g., a swipe up and/or a voice input to scroll). In response to detecting the scroll input, computer system 1000 updates display of activities user interface 1036 to scroll the activities list while the title and the icon remain in place. Because the activities list has scrolled, computer system 1000 now displays the part of the activities that includes (1) indication 1040 that the unknown person was detected in the entryway, (2) indication 1042 that the notification was sent to the owner, (3) indication 1044 that the unknown person was seen in the kitchen by kitchen tablet 1008, and (4) indication 1046 that the unknown person was seen in the office by office camera 1016, such as described above with respect to FIG. 10E.

As illustrated in FIG. 10G, time has passed and John has moved from the bedroom to the kitchen, as illustrated by unknown person 1004 now being in front of kitchen tablet 1008. At FIG. 10G, John moved to the kitchen and entered his PIN on kitchen tablet 1008. At FIG. 10G, because John moved to the kitchen and entered his PIN on kitchen tablet 1008, computer system 1000 updates display of activities user interface 1036 to cease display of icon 1038 and display icon 1050 (illustrated as a “J” with an indication of John's name “John” below icon 1050). In some embodiments, icon 1050 includes a profile picture of John and/or the most recent capture of John in the home (e.g., a picture captured of John while John typed in his PIN). For example, icon 1050 can include a profile picture associated with John's user account. For another example, icon 1050 can include a picture captured by kitchen tablet 1008 of John entering his PIN.

Activities user interface 1036 also updates display of the list of activities, and computer system 1000 displays (1) indication 1052 of John being detected in the entry by entry camera 1014, (2) indication 1054 that hub device sent a notification to the homeowner (e.g., computer system 1000), and (3) indication 1056 that John entered his PIN on kitchen tablet 1008. In indication 1052 where John is detected in the entry, John is seen and identified but not yet authenticated, so computer system 1000 displays video control 1052a. In some embodiments, a video control is removed from past events after the person is recognized. For example, after John enters his PIN and is recognized, computer system 1000 ceases display of video control 1052a for indication 1052. For another example, after John enters his PIN and is recognized, computer system 1000 ceases display of video controls for all past events prior to the recognition.

In the situation where John enters his PIN, the entering of his PIN identifies him, and computer system 1000 displays photo control 1056a of John entering his PIN. In some embodiments, photo control 1056a is displayed because John is a guest and not a resident of the home. For example, if the unrecognized person was Jane, a resident of the home, computer system 1000 does not display any photo of Jane. For another example, if the unrecognized person was a guest named Steve, computer system 1000 displays a photo control of Steve entering his PIN.

At FIG. 10G, indication 1054 of the notification alerts that the unknown person is in the home. In some embodiments, the notification is sent after John enters his PIN, and, at FIG. 10G, indication 1054 of the notification alerts that John is the unknown person in the house and John entered his PIN. At FIG. 10G, the notification that John is detected by entry camera 1014 is sent because a time has passed since the last event of the unknown person. In some embodiments, a notification is sent to the owner for every event in the home. For example, a notification is sent when John is detected in the entry, when the initial notification is sent, when John is detected in the kitchen, and when John enters his PIN. For another example, a notification is sent only for significant events, such as initial detection and identification via PIN.

As illustrated in FIG. 10H, time has passed and John has left, as illustrated by unknown person 1004 now not being present in the home. FIG. 10H illustrates an alternative view of activities user interface 1036. At FIG. 10H, activities user interface 1036 is not activities of just one individual (e.g., John), but rather all activities detected in the home for all subjects. Activities user interface 1036 includes a chronological list of activities in the home that includes multiple people detected within the home. At FIG. 10H, the list of activities includes indication 1058 that the homeowner arrived, indication 1056 including photo control 1056a, and indication 1060 of another unrecognized person detected by entry camera 1014. At FIG. 10H, indication 1058 that the homeowner arrived does not include an image or photo control. At FIG. 10H, indication 1060 of another unrecognized person detected by entry camera 1014 includes video control 1060a.

In some embodiments, the homeowner requires a lower level of security, so no image is included with the event indicator. John is authenticated, so a photo is included with the event indicator for John. The unknown person is not authenticated, so a video is included with the event indicator for the unknown person. For example, for a resident like the homeowner, activities user interface 1036 includes indication 1058 without a photo control because of the lower security level. For another example, for an authenticated guest like John, activities user interface 1036 includes indication 1056 with photo control 1056a.

At FIG. 10H, computer system 1000 does not include some activities in activities user interface 1036 included in the view of individuals in the home. For example, activities user interface 1036 in FIG. 10H does not include indication 1052 or indication 1054. In some embodiments, activities user interface 1036 includes activities of all individuals, including indications 1052 and 1054. For example, activities user interface 1036 can include a full chronological list including indication 1052 of detection in the entry and indication 1054 of the notification sent. For another example, activities user interface 1036 includes all activities without summarization.

In some embodiments, indications are summarized so only some indications are displayed. For example, indication 1056 can be displayed but not indications 1052 and 1054 because indication 1056 summarizes the event within that short period of time (e.g., a few minutes). For another example, multiple detections in quick succession are combined into a single indication summarizing the period.

In some embodiments, a user can navigate between the various views of activities (e.g., between all persons in FIG. 10H and just John in FIG. 10G) by swiping on activities user interface 1036 left or right. For example, a swipe input detected at text label 1062. For another example, a left swipe switches to the individual view of John, while a right swipe switches to another group view.

FIG. 11 is a flow diagram illustrating a process (e.g., process 1100) for displaying a camera feed corresponding to guest position in accordance with some embodiments. Some operations in process 1100 are, optionally, combined, the orders of some operations are, optionally, changed, and some operations are, optionally, omitted.

As described below, process 1100 provides an intuitive way for displaying a camera feed corresponding to guest position in accordance with some embodiments. Process 1100 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

In some embodiments, process 1100 is performed at a computer system (e.g., 700 and/or 1000) that is in communication with (and/or includes) one or more display components (e.g., a display screen, a projector, a head mounted display, and/or a touch-sensitive display) and one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the computer system is a watch, a phone, a tablet, a fitness tracking device, a processor, a head-mounted display (HMD) device, a communal device, a media device, a speaker, a television, and/or a personal computing device.

The computer system displays (1102), via the one or more display components, a representation (e.g., 1018 and/or “Unrecognized Person in Home,” such as illustrated above with respect to FIG. 7P) (e.g., a graphical and/or textual representation) of a notification of a subject being detected in an environment (e.g., home, such as described above with respect to FIGS. 10A-10H and/or “home,” such as illustrated above with respect to FIGS. 7P-7V) (e.g., a physical environment, such as a home, a room, a yard, and/or a building) with a user interface element (e.g., 1022 and/or “check in,” such as illustrated above with respect to FIG. 7P) (e.g., a button, an icon, a widget, and/or a control) to review the subject being detected in the environment. In some embodiments, the subject is a user, a person, an animal, another computer system different from the computer system, a device, and/or an object. In some embodiments, the subject is an unknown subject, a recognized subject, and/or an identified subject. In some embodiments, the representation of the notification of the subject being detected in the environment is displayed within and/or adjacent to the user interface element to review the subject being detected in the environment. In some embodiments, the representation of the notification of the subject being detected in the environment includes the user interface element to review the subject being detected in the environment. In some embodiments, the representation of the notification of the subject being detected in the environment includes a live view, a photo and/or a video of the subject captured by a camera.

While displaying the representation of the notification of the subject being detected in the environment with the user interface element to review the subject being detected in environment, the computer system detects (1104), via the one or more input devices, an input (e.g., 1005a and/or such as illustrated above with respect to FIGS. 7P-7S) (e.g., a tap input, a voice input, and/or an air gesture) corresponding to the user interface element to review the subject being detected in the environment. In some embodiments, the input is a tap input on the user interface element to review the subject being detected in the environment and/or a voice input requesting that an operation be performed (e.g., “Hey software agent, select the check-in button”). In some embodiments, the input includes an air gesture of a hand wave and/or pointing in a direction (e.g., pointing down) corresponding to selection of the user interface element to review the subject being detected in the environment.

In response to detecting the input corresponding to the user interface element to review the subject being detected in the environment and in accordance with a determination that the subject is in a first portion (e.g., kitchen, as described above with respect to FIG. 10B and/or the location of 744, such as illustrated above with respect to FIG. 7S) of the environment, the computer system displays (1106), via the one or more display components, a representation (e.g., 1024 and/or the top portion of 702, such as illustrated above with respect to FIG. 7S) of a first camera feed corresponding to (and/or from an external device located at) the first portion of the environment. In some embodiments, the first camera feed is the live view or a camera feed different from the live view. In some embodiments, in response to detecting the input corresponding to the user interface element to review the subject being detected in the environment and in accordance with a determination that the subject is in another portion of the environment different from the first portion of the environment, the computer system displays, via the one or more display components, a representation of a different camera feed corresponding to the other portion of the environment (e.g., without displaying the representation of the first camera feed corresponding to the first portion of the environment).

While displaying the first camera feed corresponding to the first portion of the environment, the computer system receives (1108) an indication that the subject is at a second portion (e.g., office, such as described above with respect to FIG. 10D and/or the location of 744 near 714, such as illustrated above with respect to FIG. 7S) of the environment, wherein the second portion of the environment is different from the first portion of the environment.

In response to receiving the indication that the subject is in the second portion of the environment, the computer system displays (1110), via the one or more display components, a representation (e.g., 1034, and/or the top portion of 702, such as illustrated above with respect to FIG. 7S) of a second camera feed corresponding to (and/or from an external device located at) the second portion of the environment (and/or ceases display of the representation of the first camera feed corresponding to the first portion of the environment) (e.g., without displaying the representation of the first camera feed corresponding to the first portion of the environment), wherein the first camera feed is different from the second camera feed. Changing camera feed displayed in response to a subject moving to different parts of the environment allows the computer system to display to a user the subject's activities automatically even as the old camera feed no longer captures the activities of the subject as they move out of the respective environment, thereby reducing the number of inputs needed to perform an operation, performing an operation when a set of conditions has been met without requiring further user input, and/or providing improved visual feedback to the user.

In some embodiments, in response to detecting the input corresponding to the user interface element to review the subject being detected in the environment and in accordance with the determination that the subject is in the first portion of the environment, the computer system displays (and/or concurrently displays), via the one or more display components, the representation of the first camera feed corresponding to the first portion of the environment and a representation (e.g., 1030d, such as described above with respect to FIG. 10C and/or such as illustrated above with respect to FIG. 7S) (e.g., a graphical representation and/or a textual representation) of a first activity (and/or additional representations of activities) that occurred in the first portion of the environment corresponding to the subject. In some embodiments, in response to receiving the indication that the subject is in the second portion of the environment, the computer system displays (and/or concurrently displays), via the one or more display components, the representation of the second camera feed corresponding to the second portion of the environment and the representation of the first activity that occurred in the first portion of the environment corresponding to the subject. In some embodiments, in response to receiving the indication that the subject is in the second portion of the environment, the computer system displays (and/or concurrently displays), via the one or more display components, the representation of the second camera feed corresponding to the second portion of the environment and a representation (e.g., 1030d, such as described above with respect to FIG. 10D and/or such as illustrated above with respect to FIG. 7S) of a different activity that occurred in the environment (e.g., the first portion of the environment, the second portion of the environment, and/or a different portion of the environment) corresponding to the subject. Displaying a camera view of a subject in the environment with a list of activities performed by the subject in the environment allows the computer system to notify a user of activities the subject performed previously and/or currently in the environment without requiring review of the footage, thereby reducing the number of inputs needed to perform an operation, performing an operation when a set of conditions has been met without requiring further user input, and/or providing improved visual feedback to the user.

In some embodiments, in response to receiving the indication that the subject is in the second portion of the environment, the computer system displays (and/or concurrently displays), via the one or more display components, the representation of the second camera feed corresponding to the second portion of the environment and a representation (e.g., 1030d, such as described above with respect to FIG. 10D and/or such as illustrated above with respect to FIG. 7S) of a second activity that occurred in the second portion of the environment. Displaying additional activities performed by the subject as they happen allows the computer system to notify a user of activities with live updates, thereby reducing the number of inputs needed to perform an operation, performing an operation when a set of conditions has been met without requiring further user input, and/or providing improved visual feedback to the user.

In some embodiments, while displaying the representation of the first camera feed corresponding to the first portion of the environment, the computer system displays (and/or concurrently displays), via the one or more display components, an indication (e.g., 1042, “homeowner notified” such as illustrated above with respect to FIG. 7O, and/or “authorities contacted” such as illustrated above with respect to FIG. 7T) that an administrator (e.g., an authenticated subject, homeowner, and/or resident) was sent a notification (and/or an additional administrator was sent the notification). In some embodiments, the indication that the administrator was sent the notification includes an identification of the administrator. Displaying an indication that an administrator was notified of a subject in an environment allows the computer system to notify a user of who was notified and prevent further alerts to the administrator of the subject's presence, thereby reducing the number of inputs needed to perform an operation and/or providing improved visual feedback to the user.

In some embodiments, the computer system is a first computer system. In some embodiments, the indication that the administrator was notified includes an identification of a second computer system (e.g., which device that the notification was sent, such as described above with respect to FIG. 10E, and/or “kitchen tablet” and/or “living room” such as illustrated above with respect to FIG. 7T) corresponding to (e.g., owned by and/or of) the administrator that was sent the notification. In some embodiments, the second computer system is a watch, a phone, a tablet, a fitness tracking device, a processor, a head-mounted display (HMD) device, a communal device, a media device, a speaker, a television, and/or a personal computing device. Displaying an indication that an administrator was notified via a particular device of a subject in an environment allows the computer system to notify a user of who was notified, thereby reducing the number of inputs needed to perform an operation and/or providing improved visual feedback to the user.

In some embodiments, the representation of the first activity that occurred in the first portion of the environment corresponding to the subject is displayed: in accordance with a determination that a context (e.g., identifies the detected subject, such as described above with respect to FIG. 10E) (e.g., authentication, identification, who the subject is, what the subject is doing, where the subject is detected, and/or when the subject is detected) of the subject (and/or of the environment) detected in the environment satisfies a first set of one or more criteria (e.g., that the subject is not identified, not authenticated via a first factor of authentication, and/or is authenticated via the first factor of authentication but is not authenticated via a second factor of authentication different from the first factor of authentication), with media content (e.g., 1040a, 1044a, 1046a, and/or videos, such as illustrated above with respect to FIGS. 70 and/or 7T) (e.g., audio, a video, and/or an image) of the first activity; and in accordance with a determination that the context of the subject detected in the environment satisfies a second set of one or more criteria (e.g., that the subject is identified and/or authenticated, such as via the first factor of authentication and/or the second factor of authentication), without the media content (e.g., audio, a video, and/or an image) of the first activity. In some embodiments, the second set of one or more criteria is different from the first set of one or more criteria. Selectively displaying media with a representation of an activity depending on context allows the computer system to indicate certain activities of subjects with media to aid additional review, thereby reducing the number of inputs needed to perform an operation and/or providing improved visual feedback to the user. In some embodiments, the representation of the first activity includes the media content of the first activity.

In some embodiments, in response to detecting the input corresponding to the user interface element to review the subject being detected in the environment and in accordance with the determination that the subject is in the first portion of the environment, the computer system displays (and/or concurrently displays), via the one or more display components, an indication (e.g., such as described above with respect to FIGS. 10B-10C) (e.g., a representation, an identification, a graphical icon, and/or a textual description) of the first portion of the environment (e.g., with the representation of the first camera feed corresponding to the first portion of the environment). In some embodiments, in response to receiving the indication that the subject is in the second portion of the environment, the computer system displays (and/or concurrently displays), via the one or more display components, an indication (e.g., such as described above with respect to FIG. 10D) (e.g., a representation, an identification, a graphical icon, and/or a textual description) of the second portion of the environment (e.g., with the representation of the second camera feed corresponding to the second portion of the environment). Displaying where a subject is detected allows the computer system to notify a user of which location activities were performed by the subject, thereby reducing the number of inputs needed to perform an operation and/or providing improved visual feedback to the user.

In some embodiments, in response to detecting the input corresponding to the user interface element to review the subject being detected in the environment and in accordance with the determination that the subject is in the first portion of the environment, the computer system displays (and/or concurrently displays), via the one or more display components, an indication (e.g., 1030d, such as described above with respect to FIGS. 10B-10C) (e.g., a representation, an identification, a graphical icon, and/or a textual description) of a camera corresponding to the first camera feed (e.g., with the representation of the first camera feed corresponding to the first portion of the environment). In some embodiments, the one or more input devices include the camera corresponding to the first camera feed. In some embodiments, the camera corresponding to the first camera feed is separate (and/or different) from the one or more input devices and/or the computer system. In some embodiments, in response to receiving the indication that the subject is in the second portion of the environment, the computer system displays (and/or concurrently displays), via the one or more display components, an indication (e.g., 1030d, such as described above with respect to FIG. 10D) (e.g., a representation, an identification, a graphical icon, and/or a textual description) of a camera corresponding to the second camera feed (e.g., with the representation of the second camera feed corresponding to the second portion of the environment), wherein the indication of the camera corresponding to the second camera feed is different from the indication of the camera corresponding to the first camera feed, and wherein the camera corresponding to the second camera feed is different from the camera corresponding to the first camera feed. In some embodiments, the one or more input devices include the camera corresponding to the second camera feed. In some embodiments, the camera corresponding to the second camera feed is separate (and/or different) from the one or more input devices and/or the computer system. Displaying which camera detected a subjects allows the computer system to notify a user of which camera detected the subject, thereby reducing the number of inputs needed to perform an operation and/or providing improved visual feedback to the user.

In some embodiments, in response to detecting the input corresponding to the user interface element to review the subject being detected in the environment and in accordance with the determination that the subject is in the first portion of the environment, the computer system displays (and/or concurrently displays), via the one or more display components, a user interface element (e.g., “talk” button, such as described above with respect to FIG. 10C and/or “talk” button, such as illustrated above with respect to FIG. 7S) (e.g., a virtual button, an icon, a widget, a control, and/or a window) to contact the subject (e.g., with the representation of the first camera feed corresponding to the first portion of the environment). In some embodiments, in response to receiving the indication that the subject is in the second portion of the environment, the computer system displays (and/or concurrently displays and/or maintains display of), via the one or more display components, the user interface element to contact the subject (e.g., with the representation of the second camera feed corresponding to the second portion of the environment). In some embodiments, while displaying the user interface element to contact the subject, the computer system detects, via the one or more input devices, an input (e.g., such as described above with respect to FIG. 10C) (e.g., a tap input and/or a voice input) corresponding to the user interface element to contact the subject. In some embodiments, in response to detecting the input corresponding to the user interface element to contact the subject, the computer system initiates a communication (e.g., such as described above with respect to FIG. 10C) (e.g., a video call, text message, and/or phone call) with the subject. In some embodiments, initiating a communication with the subject includes displaying, via the one or more display components, a user interface corresponding to a communications application (e.g., a messaging application or a calling application). Displaying a user interface element to contact a subject detected in an environment allows the computer system to provide a means for communication with the subject where the subject is located, thereby reducing the number of inputs needed to perform an operation, providing additional control options without cluttering the user interface with additional displayed control, and/or providing improved visual feedback to the user.

In some embodiments, in response to detecting the input corresponding to the user interface element to review the subject being detected in the environment and in accordance with the determination that the subject is detected in the first portion of the environment, the computer system displays (and/or concurrently displays), via the one or more display components, a user interface element (e.g., “Get Help” button, such as described above with respect to FIG. 10C and/or “Get Help” button, such as illustrated above with respect to FIG. 7S) (e.g., a virtual button, an icon, a widget, a control, and/or a window) to contact emergency services (e.g., with the representation of the first camera feed corresponding to the first portion of the environment). In some embodiments, in response to detecting the indication that the subject is in the second portion of the environment, the computer system displays (and/or concurrently displays and/or maintains display of), via the one or more display components, the user interface element to contact the emergency services (e.g., with the representation of the second camera feed corresponding to the second portion of the environment). In some embodiments, while displaying the user interface element to contact emergency services, the computer system detects, via the one or more input devices, an input (e.g., such as described above with respect to FIG. 10C) (e.g., a tap input and/or a voice input) corresponding to the user interface element to contact the emergency services. In some embodiments, in response to detecting the input corresponding to the user interface element to contact emergency services, the computer system initiates a communication (e.g., such as described above with respect to FIG. 10C) (e.g., a video call, text message, and/or phone call) with the emergency services. In some embodiments, initiating a communication with the emergency services includes displaying, via the one or more display components, a user interface corresponding to a communications application (e.g., a messaging application or a calling application). Displaying a user interface element to contact an emergency service based on a subject being detected in an environment allows the computer system to provide a means for communication with emergency services to the environment while displaying media of a subject in the environment, thereby reducing the number of inputs needed to perform an operation, providing additional control options without cluttering the user interface with additional displayed control, and/or providing improved visual feedback to the user.

In some embodiments, in response to detecting the input corresponding to the user interface element to review the subject being detected in the environment and in accordance with the determination that the subject is in the first portion of the environment, in accordance with a determination that the first portion of the environment includes a speaker, the computer system displays, via the one or more display components, a user interface element (e.g., “Get Help” button, such as described above with respect to FIG. 10C and/or “Get Help” button, such as illustrated above with respect to FIG. 7S) (e.g., a virtual button, an icon, a widget, a control, and/or a window) to unmute (e.g., enable inputs to a microphone of the one or more input devices) (e.g., with the representation of the first camera feed corresponding to the first portion of the environment). In some embodiments, in response to detecting an input (e.g., a tap input and/or a voice input) corresponding to the user interface element to unmute, the computer system enables voice inputs detected via a microphone. In some embodiments, in response to detecting a voice input, the computer system sends an indication of the voice input to the speaker in the first portion of the environment for output by the speaker. In some embodiments, in response to detecting the input corresponding to the user interface element to review the subject being detected in the environment and in accordance with the determination that the subject is in the first portion of the environment, in accordance with a determination that the first portion of the environment does not include a speaker, the computer system forgoes display of, via the one or more display components, the user interface element to unmute. Selectively displaying a user interface element to unmute based on if a speaker is in an environment that a subject is in allows the computer system to provide the option to speak with the subject in the environment they are detected in when available, thereby reducing the number of inputs needed to perform an operation, performing an operation when a set of conditions has been met without requiring further user input, providing additional control options without cluttering the user interface with additional displayed control, and/or providing improved visual feedback to the user.

In some embodiments, the computer system is a first computer system. In some embodiments, in response to detecting the input corresponding to the user interface element to review the subject being detected in the environment and in accordance with the determination that the subject is in the first portion of the environment, the computer system displays (and/or concurrently displays), via the one or more display components, a control (1030a, such as described above with respect to FIG. 10C) (e.g., a virtual button, an icon, a widget, and/or a window) of a third computer system associated with (e.g., in the same room as, in the same environment as, in the same floor as, in the same building as, within a field of view of, and/or defined as being associated with) the first camera feed, wherein the third computer system is different from the first computer system. In some embodiments, the third computer system is an accessory device, a door, a lock, a light, a thermostat, a smart blinds, a watch, a phone, a tablet, a fitness tracking device, a processor, a head-mounted display (HMD) device, a communal device, a media device, a speaker, a television, a camera, and/or a personal computing device. In some embodiments, in response to receiving the indication that the subject is in the second portion of the environment, the computer system displays (and/or concurrently displays), via the one or more display components, a control (e.g., 1030a, such as described above with respect to FIG. 10D) (e.g., a virtual button, an icon, a widget, and/or a window) of a fourth computer system associated with (e.g., in the same room as, in the same environment as, in the same floor as, in the same building as, within a field of view of, and/or defined as being associated with) the second camera feed (e.g., with or without displaying the control of the third computer system associated with the first camera feed), wherein the fourth computer system is different from the first computer system and the third computer system, and wherein the control of the third computer system is separate (and/or different) from the control of the fourth computer system. In some embodiments, the fourth computer system is an accessory device, a door, a lock, a light, a thermostat, a smart blinds, a watch, a phone, a tablet, a fitness tracking device, a processor, a head-mounted display (HMD) device, a communal device, a media device, a speaker, a television, a camera, and/or a personal computing device. Displaying a user interface element to control a computer system associated with a camera feed of an environment that a subject is in allows the computer system to provide a user the ability to help the subject in the environment by turning on lights, unlocking doors, and/or playing music, thereby reducing the number of inputs needed to perform an operation, performing an operation when a set of conditions has been met without requiring further user input, and/or providing improved visual feedback to the user.

In some embodiments, the computer system is a first computer system. In some embodiments, after (and/or while) displaying the representation of the first camera feed and before receiving the indication that the subject is at the second portion of the environment, the computer system detects, via the one or more input devices, an input (e.g., selection of the “talk” button, such as described above with respect to FIG. 10C and/or selection of the “talk” button, such as illustrated above with respect to FIG. 7S) (e.g., a tap input and/or a voice input) corresponding to a request to speak to the subject. In some embodiments, the input is on a user interface element (e.g., a virtual button, an icon, a widget, a control, and/or a window) to unmute (e.g., enable inputs to a microphone of the one or more input devices) (e.g., with the representation of the first camera feed corresponding to the first portion of the environment). In some embodiments, in response to detecting the input corresponding to the request to speak to the subject, the computer system sends, to a fifth computer system (e.g., 1008 and/or 708) associated with (e.g., located in, nearby, and/or otherwise assigned to) the first portion of the environment, audio content (e.g., audible content and/or voice content) detected by the first computer system, wherein the fifth computer system is different from the first computer system, and wherein the fifth computer system is in the first portion of the environment. In some embodiments, the input corresponding to the request to speak to the subject is a first portion of a voice input. In some embodiments, the audio content is a second portion of the voice input different from the first portion of the voice input. In some embodiments, after (and/or while) displaying the representation of the second camera feed, the first computer system detects, via the one or more input devices, an input (e.g., a tap input and/or a voice input) corresponding to a request to speak to the subject. In some embodiments, the input is on a user interface element (e.g., “talk” button, such as described above with respect to FIG. 10C) (e.g., a virtual button, an icon, a widget, a control, and/or a window) to unmute (e.g., enable inputs to a microphone of the one or more input devices) (e.g., with the representation of the first camera feed corresponding to the first portion of the environment). In some embodiments, in response to detecting the input corresponding to the request to speak to the subject, the computer system sends, to a sixth computer system associated with the second portion of the environment (e.g., without sending, to the fifth computer system, audio content (e.g., audible content and/or voice content), wherein the sixth computer system is different from the first computer system, and wherein the sixth computer system is in the second portion of the environment). Sending, to another computer system, audio content in response to a request to speak to a subject allows the computer system to provide a user with an option to communicate with the subject in an environment where the subject is detected, thereby reducing the number of inputs needed to perform an operation, performing an operation when a set of conditions has been met without requiring further user input, and/or providing improved visual feedback to the user.

In some embodiments, while (and/or after) displaying the representation of the second camera feed, the computer system detects, via the one or more input devices, an input (e.g., drag, such as described above with respect to FIG. 10C) (e.g., a tap input, a drag input, and/or a voice input) corresponding to a request to review the subject being detected in the environment (and/or a respective portion of the environment) at a previous time (e.g., a time before displaying the first camera feed corresponding to the first portion of the environment or the second camera feed corresponding to the second portion of the environment). In some embodiments, the input is a drag input on a user interface element to scrub a camera feed (e.g., the first camera feed corresponding to the first portion of the environment, the second camera feed corresponding to the second portion of the environment, and/or a different camera feed corresponding to a different portion of the environment). In some embodiments, in response to detecting the input to review the subject being detected in the environment at the previous time, in accordance with a determination that the subject was at the first portion of the environment at the previous time, the computer system displays, via the one or more display components, a representation of the first camera feed at the previous time. In some embodiments, the representation of the first camera feed at the previous time includes recorded content (e.g., video and/or photo) recorded at the previous time. In some embodiments, in response to detecting the input to review the subject being detected in the environment at the previous time, in accordance with a determination that the subject was at a third portion of the environment at the previous time, the computer system displays, via the one or more display components, a representation of a third camera feed at the previous time, wherein the third camera feed corresponds to (and/or from an external device located at) a third portion of the environment, wherein the third camera feed is different from the first camera feed (and/or the second camera feed), and wherein the third portion of the environment is different from the first portion of the environment (e.g., scrubbing rewinds between multiple cameras, such as described above with respect to FIG. 10C) (and/or the second portion of the environment). In some embodiments, the third camera feed is the second camera feed. In some embodiments, the representation of the third camera feed at the previous time includes recorded content (e.g., video and/or photo) recorded at the previous time. Displaying different camera feeds based on a time selected by a user allows the computer system to display actions of a subject from different camera feeds based on where the subject was at a time as directed by the user, thereby reducing the number of inputs needed to perform an operation and/or providing improved visual feedback to the user.

In some embodiments, while (and/or after) displaying the representation of the second camera feed, the computer system detects, via the one or more input devices, an input (e.g., 1030b, such as described above with respect to FIG. 10C) (e.g., a tap input, a drag input, and/or a voice input) corresponding to a request to review the second camera feed at a respective time (e.g., a time before displaying the first camera feed corresponding to the first portion of the environment or the second camera feed corresponding to the second portion of the environment). In some embodiments, the input is a drag input on a user interface element to scrub the second camera feed corresponding to the second portion of the environment. In some embodiments, in response to detecting the input corresponding to the request to review the second camera feed at the respective time, in accordance with a determination that the respective time is a first time, the computer system displays, via the one or more display components, a representation of the second camera feed at the first time, wherein the representation of the second camera feed at the first time is different from the representation of the second camera feed displayed in response to receiving the indication that the subject is in the second portion of the environment. In some embodiments, the representation of the second camera feed at the first time includes recorded camera feed content (e.g., video and/or photo) recorded at the first time. In some embodiments, while displaying the representation of the first camera feed and before receiving the indication that the subject is at the second portion of the environment, the computer system detects, via the one or more input devices, an input (e.g., a tap input, a drag input, and/or a voice input) corresponding to a request to review the first camera feed at another time. In some embodiments, in response to detecting the input corresponding to the request to review the first camera feed at the other time, the computer system displays, via the one or more display components, a representation of the first camera feed at the other time, wherein the representation of the first camera feed at the other time is different from the representation of the first camera feed displayed in response to receiving the indication that the subject is in the first portion of the environment. In some embodiments, the first time is at the same time as the representation of the first camera feed displayed in response to receiving the indication that the subject is in the first portion of the environment. In some embodiments, in response to detecting the input corresponding to the request to review the second camera feed at the respective time, in accordance with a determination that the respective time is a second time, the computer system displays, via the one or more display components, a representation of the second camera feed at the second time (e.g., without displaying the representation of the second camera feed at the first time), wherein the second time is different from the first time, wherein the representation of the second camera feed at the second time is different from the representation of the second camera feed at the first time and the representation of the second camera feed displayed in response to receiving the indication that the subject is in the second portion of the environment (e.g., scrubbing displays only the feed of a camera currently displayed, such as described above with respect to FIG. 10C). In some embodiments, the representation of the second camera feed at the second time includes recorded camera feed content (e.g., video and/or photo) recorded at the second time. Displaying a camera feed with content from different times of the day allows the computer system to display the actions of a subject at different times of the day for a camera as directed by the user, thereby reducing the number of inputs needed to perform an operation and/or providing improved visual feedback to the user.

In some embodiments, the computer system is a first computer system. In some embodiments, the determination that the subject is detected in the first portion of the environment includes receiving from a seventh computer system (e.g., 1008 and/or 707-8) an indication that the subject has been detected (e.g., captured and/or sensed) by the seventh computer system. In some embodiments, the seventh computer system is different from the first computer system. In some embodiments, the seventh computer system captures the first camera feed. In some embodiments, receiving the indication that the subject is in the second portion of the environment is detected in the second portion of the environment includes receiving from an eighth computer system (e.g., 1016 and/or 714) the indication that the subject has been detected (e.g., captured and/or sensed) in the second portion of the environment by the eighth computer system. In some embodiments, the eighth computer system is different from the first computer system and the seventh computer system. In some embodiments, the eighth computer system captures the second camera feed. Receiving, from a different computer system, an indication that a subject has been detected by an accessory allows the computer system to display a subject's activities automatically even when detected by other computer systems, thereby reducing the number of inputs needed to perform an operation, performing an operation when a set of conditions has been met without requiring further user input, and/or providing improved visual feedback to the user.

In some embodiments, in response to detecting the input corresponding to the user interface element to review the subject being detected in the environment and in accordance with the determination that the subject is in the first portion of the environment, the computer system displays, via the one or more display components, a user interface (e.g., 1030 and/or 702, such as illustrated above with respect to FIG. 7S) (e.g., a system user interface and/or an application user interface including one or more user interface elements) including the representation of the first camera feed corresponding to the first portion of the environment. In some embodiments, the computer system maintains display of the user interface including the first portion of the environment while receiving the indication that the subject is at the second portion of the environment. In some embodiments, in response to receiving the indication that the subject is in the second portion of the environment, the computer system displays (and/or updates and/or maintains display of), via the one or more display components, the user interface including the representation of the second camera feed corresponding to the second portion of the environment (and/or without including the representation of the first camera feed corresponding to the first portion of the environment). Maintaining display of a user interface while a camera feed changes enables the computer system to update what camera feed is displayed in order to track activities of a subject in in one location, thereby reducing the number of inputs needed to perform an operation, performing an operation when a set of conditions has been met without requiring further user input, and/or providing improved visual feedback to the user.

In some embodiments, after (and/or while) displaying the representation of the second camera feed, the computer system detects, via the one or more input devices, an input (e.g., such as described above with respect to FIG. 10D) (e.g., a tap input, voice input, and/or air gesture) to review the subject being detected in the environment (and/or a respective portion of the environment). In some embodiments, after (and/or while) displaying the representation of the second camera feed, the computer system displays, via the one or more display components, a user interface element (e.g., a button, an icon, a widget, and/or a control) to review the subject being detected in the environment. In some embodiments, the input to review the subject being detected in the environment includes an input corresponding to the user interface element to review the subject being detected in the environment. In some embodiments, in response to detecting the input to review the subject being detected in the environment, in accordance with a determination that the subject is being detected at a fifth portion of the environment, the computer system displays, via the one or more display components, a representation of a fifth camera feed (e.g., entry camera 1014, such as described above with respect to FIG. 10D) corresponding to (and/or from an external device located at) the fifth portion of the environment. In some embodiments, the fifth camera feed is the live view or a camera feed different from the live view. In some embodiments, the fifth camera feed is the first camera feed or the second camera feed. In some embodiments, the fifth camera feed is a different camera feed from the first camera feed and/or the second camera feed. In some embodiments, the fifth portion of the environment is the same as the first portion of the environment or the second portion of the environment. In some embodiments, the fifth portion of the environment is different from the first portion of the environment and/or the second portion of the environment. In some embodiments, in response to detecting the input to review the subject being detected in the environment, in accordance with a determination that the subject is being detected at a sixth portion of the environment, the computer system displays, via the one or more display components, a representation of a sixth camera feed (e.g., kitchen tablet 1008, such as described above with respect to FIG. 10D) corresponding to (and/or from an external device located at) the sixth portion of the environment, wherein the sixth camera feed corresponding to the sixth portion of the environment is different from the fifth camera feed corresponding to the fifth portion of the environment. In some embodiments, the sixth camera feed is the live view or a camera feed different from the live view. In some embodiments, the sixth camera feed is the first camera feed or the second camera feed. In some embodiments, the sixth camera feed is a different camera feed from the first camera feed and/or the second camera feed. In some embodiments, the sixth portion of the environment is the same as the first portion of the environment or the second portion of the environment. In some embodiments, the sixth portion of the environment is different from the first portion of the environment and/or the second portion of the environment. Adapting a camera feed continually after previously changing camera feed in response to a subject moving to different parts of the environment allows the computer system to display to a user, after previously investigating the subject's activities, the subject's activities with the feed from additional and/or the same cameras as the subject moves around the environment, thereby reducing the number of inputs needed to perform an operation, performing an operation when a set of conditions has been met without requiring further user input, and/or providing improved visual feedback to the user.

In some embodiments, after (and/or while) displaying the representation of the second camera feed, the computer system detects, via the one or more input devices, an input (e.g., such as described above with respect to FIG. 10D) to review a seventh camera feed corresponding to a seventh portion of the environment (and/or while the subject is detected in an eighth portion of the environment different from the seventh portion of the environment). In some embodiments, the seventh camera feed is the live view or a camera feed different from the live view. In some embodiments, the seventh camera feed is the first camera feed or the second camera feed. In some embodiments, the seventh camera feed is a different camera feed from the first camera feed and/or the second camera feed. In some embodiments, the seventh portion of the environment is the same as the first portion of the environment or the second portion of the environment. In some embodiments, the seventh portion of the environment is different from the first portion of the environment and/or the second portion of the environment. In some embodiments, the input includes an air gesture of a hand wave and/or pointing in a direction (e.g., pointing down) corresponding to a command to reviewing the seventh camera feed corresponding to the seventh portion of the environment. In some embodiments, after (and/or while) displaying the representation of the second camera feed, the computer system displays, via the one or more display components, a user interface element (e.g., a button, an icon, a widget, and/or a control) to review the seventh camera feed corresponding to the seventh portion of the environment. In some embodiments, the input to review the seventh camera feed corresponding to the seventh portion of the environment includes an input corresponding to the user interface element to review the seventh camera feed corresponding to the seventh portion of the environment. In some embodiments, in response to detecting the input to review the seventh camera feed corresponding to the seventh portion of the environment, the computer system displays, via the one or more display components, a representation of the seventh camera feed (e.g., 1024 and/or 1034) corresponding to the seventh portion of the environment (and/or while the subject is detected in an eighth portion of the environment different from the seventh portion of the environment). Displaying a camera feed selected by a user allows the computer system to display particular camera feeds directed by the user, thereby providing additional control options without cluttering the user interface with additional displayed, and/or providing improved visual feedback to the user.

Note that details of the processes described above with respect to process 1100 (e.g., FIG. 11) are also applicable in an analogous manner to other processes described herein. For example, process 1200 optionally includes one or more of the characteristics of the various processes described above with reference to process 1100. For example, displaying the media content based on the criteria of process 1200 can be displayed while displaying the representation of the second camera feed of process 1100. For brevity, these details are not repeated herein.

FIG. 12 is a flow diagram illustrating a process (e.g., process 1200) for displaying media based on context in accordance with some embodiments. Some operations in process 1200 are, optionally, combined, the orders of some operations are, optionally, changed, and some operations are, optionally, omitted.

As described below, process 1200 provides an intuitive way for displaying media based on context in accordance with some embodiments. Process 1200 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

In some embodiments, process 1200 is performed at a computer system (e.g., 700 and/or 1000) that is in communication (e.g., wired or wirelessly) with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) and one or more display components (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

The computer system detects (1202), via the one or more input devices, an input (e.g., 1005c) (e.g., a tap input and/or a voice input) corresponding to a request to display an activity log (e.g., a list of activity performed in an environment and/or in an area, such as lit of activity performed by a single subject or any subject).

In response to detecting the input corresponding to the request to display the activity log, the computer system displays (1204), via the one or more display components, an indication (e.g., 1038, 1062, 1050, and/or “unknown person” and/or “?” such as illustrated above with respect to FIG. 7T) of a subject (and/or an indication of when and/or where the subject was detected in an environment): (1206) in accordance with a determination that authentication of the subject detected in an environment satisfies a first set of one or more criteria (e.g., that the subject is not identified, not authenticated via a first factor of authentication, and/or is authenticated via the first factor of authentication but is not authenticated via a second factor of authentication different from the first factor of authentication), with media content (e.g., 1040a, 1044a, 1046a, 1052a, and/or videos illustrated within 702, such as illustrated above with respect to FIG. 7T) (e.g., audio, a video, and/or an image) captured of the subject; and in accordance with (1208) a determination that authentication of the subject detected in the environment satisfies a second set of one or more criteria (e.g., that the subject is identified and/or authenticated, such as via the first factor of authentication and/or the second factor of authentication), without media content (e.g., audio, a video, and/or an image) captured of the subject, wherein the second set of one or more criteria is different from the first set of one or more criteria (e.g., such as described above with respect to FIGS. 10E and 10G and/or such as illustrated above with respect to FIG. 7T). In some embodiments, the computer system displays an indication of a number of events that correspond to the subject. In some embodiments, in response to detecting an input corresponding to the indication of the number of events that correspond to the subject, the computer system displays representations of each event. Providing improved feedback (such as by displaying media content of a subject depending on if a subject satisfies criteria, such as by displaying an indication of an activity that occurred and/or performed by the subject, displaying indications of events performed by the subject corresponding to the media captured as directed by a user, displaying media content of a second subject depending on if the second subject satisfies criteria, displaying different camera content as the subject moves, and/or displaying different camera content when the subject is detected in the environment) enhances the operability of the device by reducing accidental and mistaken inputs, reducing energy usage by the device. Performing an operation when a set of conditions has been met without requiring further user input (such as by displaying media content of a subject depending on if a subject satisfies criteria and/or displaying different camera content based on level of authentication) enhances the operability of the device by reducing unnecessary inputs and/or steps to navigate through different user interfaces or sets of controls, reducing energy usage by the device. Reducing the number of inputs needed to perform an operation (such as by displaying media content of a subject depending on if a subject satisfies criteria and/or displaying different camera content based on level of authentication) enhances the operability of the device by reducing the number of inputs and time required to perform a particular operation, reducing energy usage by the device. Providing improved feedback (such as by displaying activity and/or media captured of a subject) enhances the operability of the device by reducing accidental and mistaken inputs, reducing energy usage by the device.

In some embodiments, in response to detecting the input corresponding to the request to display the activity log, the computer system displays, via the one or more display components, an indication (e.g., 1042, 1054, and/or “Seen by Kitchen Tablet,” “Seen by Living Room,” such as illustrated above with respect to FIG. 7T) (e.g., a representation, an identification, a graphical icon, and/or a textual description) of an activity (e.g., an action performed with context) (e.g., entering a room, leaving a room, being identified, being authenticated, changing a state of an accessory device, walking to an area, sleeping, and/or the like) that occurred within the environment (e.g., by the subject and/or another subject different from the subject), wherein the activity does not correspond to (and/or is not represented in) the media content (e.g., the media content corresponds to another activity different from the activity that occurred within the environment).

In some embodiments, in response to detecting the input corresponding to the request to display the activity log, the computer system displays, via the one or more display components, an indication (e.g., 1048 and/or “Seen in Entryway,” such as illustrated above with respect to FIG. 7T) (e.g., a representation, an identification, a graphical icon, and/or a textual description) of an activity (e.g., an action performed with context) (e.g., entering a room, leaving a room, being identified, being authenticated, changing a state of an accessory device, walking to an area, sleeping, and/or the like) performed by the subject (and/or another subject different from the subject), wherein the activity does not correspond to (and/or is not represented in) the media content (e.g., the media content corresponds to another activity different from the activity performed by the subject). In some embodiments, the indication of the activity performed by the subject is separate from the indication of the activity that occurred within the environment.

In some embodiments, in response to detecting the input corresponding to the request to display the activity log and in accordance with the determination that authentication of the subject detected in the environment satisfies the first set of one or more criteria, the computer system displays, via the one or more display components, an indication (e.g., 1040, 1044, and/or “Seen by Kitchen Tablet,” “Seen by Entryway,” such as illustrated above with respect to FIG. 7T) (e.g., a representation, an identification, a graphical icon, and/or a textual description) of a first event (e.g., seen by Entry Camera and/or seen by Kitchen Tablet, such as described above with respect to FIG. 10C, and/or such as illustrated above with respect to FIG. 7T) (e.g., momentary state change) (e.g., a door opening, entering login information, authenticating with biometrics, turning a light off, and/or an alarm going off) of the subject (and/or an indication of an activity) and an indication of a second event (e.g., momentary state change) (e.g., a door opening, entering login information, authenticating with biometrics, turning a light off, and/or an alarm going off) of the subject, wherein: the first event of the subject is different from the second event of the subject; the indication of the first event includes the media content captured of the subject; and the indication of the second event includes media content (e.g., the media content and/or different media content) captured of the subject. In some embodiments, the media content captured of the subject was captured during the first event. In some embodiments, an activity includes entering a room, leaving a room, being identified, being authenticated, changing a state of an accessory device, walking to an area, and/or sleeping. In some embodiments, the indication of the first event performed by the subject is separate from the indication of the activity that occurred within the environment. In some embodiments, the indication of the second event performed by the subject is separate from the indication of the activity that occurred within the environment. In some embodiments, in response to detecting the input corresponding to the request to display the activity log and in accordance with the determination that authentication of the subject detected in the environment satisfies the second set of one or more criteria, the computer system forgoes display of the indication of the first event of the subject and/or the indication of the second event of the subject.

In some embodiments, the first set of one or more criteria includes a criterion that is satisfied when the subject is not able to be identified (e.g., such as described above with respect to FIGS. 10E-10G, such as illustrated above with respect to FIG. 7T) (e.g., by the computer system, such as (1) the subject is an unidentified subject, (2) an identity of the subject is an unknown subject, and/or (3) an identity of the subject is not able to be identified). In some embodiments, the second set of one or more criteria includes a criterion that is satisfied when the subject is able to be identified (e.g., by the computer system, such as (1) the subject is an identified subject, (2) an identity of the subject is detected, and/or (3) an identity of the subject is able to be identified).

In some embodiments, the first set of one or more criteria includes a criterion that is satisfied when the subject is not able to be authenticated (e.g., such as described above with respect to FIGS. 10E-10G, such as illustrated above with respect to FIG. 7T) (e.g., by the computer system, such as the subject has less than two methods of identification). In some embodiments, methods of identification include: the subject was previously identified (e.g., within a threshold period of time of another method of identification), biometric identification, PIN code, voice identification, and/or password. In some embodiments, the second set of one or more criteria includes a criterion that is satisfied when the subject is not able to be authenticated.

In some embodiments, the media content displayed with the indication of the subject is first media content (e.g., 1040a, 1044a, 1046a, 1052a, and/or videos such as illustrated above with respect to FIG>7T) (e.g., an image, an audio recording, and/or a video). In some embodiments, the indication of the subject is displayed with second media content (e.g., 1056a) (e.g., an image, an audio recording, and/or a video), different from the first media content, in accordance with a determination that authentication of the subject detected in the environment satisfies a third set of one or more criteria (e.g., that the subject is not identified, not authenticated via a first factor of authentication, and/or is authenticated via the first factor of authentication but is not authenticated via a second factor of authentication different from the first factor of authentication). In some embodiments, the first set of one or more criteria includes a criterion that is satisfied when the subject has a first level of authentication (e.g., level of security, such as described above with respect to FIG. 10H) (e.g., that a first form of authentication has been satisfied for the subject but a second form of authentication, separate from the first form of authentication, has not been satisfied for the subject). In some embodiments, the third set of one or more criteria includes a criterion that is satisfied when the subject has a second level of authentication (e.g., level of security, such as described above with respect to FIG. 10H) (e.g., that the first form of authentication and the second form of authentication has been satisfied for the subject). In some embodiments, the second level of authentication is different from the first level of authentication. In some embodiments, the third set of one or more criteria is different from the first set of one or more criteria and the second set of one or more criteria.

In some embodiments, in response to detecting the input corresponding to the request to display the activity log, the computer system displays, via the one or more display components, an indication (e.g., 1042, 1054, and/or “authorities contacted” such as illustrated above with respect to FIG. 7T) that a notification has been sent to a set of one or more people. In some embodiments, the set of one or more people is an administrator of the computer system and/or the environment. In some embodiments, the indication that the notification has been sent to the set of one or more people includes an identification of each person in the set of one or more people.

In some embodiments, the media content includes a visual output (e.g., such as described above with respect to FISG. 10E-10G, and/or such as illustrated above with respect to FIG. 7T) (e.g., a video, a photo, an image, an animation, a 3D rendering, an augmented reality overlay, a motion graphic, a data visualization, and/or a digital art). In some embodiments, the computer system is a first computer system. In some embodiments, the visual content is captured by a second computer system different from the first computer system.

In some embodiments, the media content is a first type (e.g., audio type, video type, and/or video type) of media content (e.g., video, such as described above with respect to FIG. 10G and/or videos, such as illustrated above with respect to FIG>7T). In some embodiments, in response to detecting the input corresponding to the request to display the activity log and in accordance with the determination that authentication of the subject detected in the environment satisfies the second set of one or more criteria, the indication of the subject is displayed with a second type (e.g., audio type, video type, and/or video type) of media content different from the first type of media content (e.g., photo, such as described above with respect to FIG. 10G).

In some embodiments, the input corresponding to the request to display the activity log is a first input corresponding to the request to display the activity log. In some embodiments, the subject is a first subject. In some embodiments, after (and/or while) displaying the indication of the first subject with the media content captured of the first subject, the computer system detects, via the one or more input devices, a second input (e.g., 1005c, such as described above with respect to FIG. 10D) (e.g., a tap input and/or a voice input) corresponding to a request to display an activity log (e.g., a list of activity performed in an environment and/or in an area, such as lit of activity performed by a single subject or any subject), wherein the second input corresponding to the request to display the activity log is separate (and/or different) from the first input corresponding to the request to display the activity log. In some embodiments, in response to detecting the second input corresponding to the request to display the activity log, in accordance with a determination that authentication of the second subject detected in the environment satisfies a fourth set of one or more criteria (e.g., that the second subject is not identified, not authenticated via a first factor of authentication, and/or is authenticated via the first factor of authentication but is not authenticated via a second factor of authentication different from the first factor of authentication), the computer system displays, via the one or more display components, an indication (e.g., 1050) of a second subject (and/or an indication of when and/or where the second subject was detected in an environment) with media content (e.g., image, such as described above with respect to FIG. 10G) (e.g., audio, a video, and/or an image) captured of the second subject. In some embodiments, the fourth set of one or more criteria is different from the first set of one or more criteria and/or the second set of one or more criteria. In some embodiments, the fourth set of one or more criteria is the same as the first set of one or more criteria and/or the second set of one or more criteria. In some embodiments, the second subject is different from the first subject. In some embodiments, the second subject is the same as the first subject. In some embodiments, in response to detecting the second input corresponding to the request to display the activity log, the computer system maintains display of the indication of the first subject with the media content captured of the first subject. In some embodiments, in response to detecting the second input corresponding to the request to display the activity log, the computer system ceases display of the indication of the first subject with the media content captured of the first subject. In some embodiments, in response to detecting the second input corresponding to the request to display the activity log, in accordance with a determination that authentication of the second subject detected in the environment satisfies a fifth set of one or more criteria (e.g., that the second subject is identified and/or authenticated, such as via the first factor of authentication and/or the second factor of authentication), the computer system displays, via the one or more display components, the indication of the second subject without media content (e.g., audio, a video, and/or an image) captured of the second subject, wherein the fifth set of one or more criteria is different from the fourth set of one or more criteria. In some embodiments, the computer system displays an indication of a number of events that correspond to the second subject. In some embodiments, in response to detecting an input corresponding to the indication of the number of events that correspond to the second subject, the computer system displays representations of each event. In some embodiments, the fifth set of one or more criteria is different from the first set of one or more criteria and/or the second set of one or more criteria. In some embodiments, the fifth set of one or more criteria is the same as the first set of one or more criteria and/or the second set of one or more criteria.

In some embodiments, in response to detecting the second input corresponding to the request to display the activity log, the computer system displays, via the one or more display components, the indication of the first subject with the media content captured of the first subject, wherein the indication of the first subject is separate from the indication of the third subject (e.g., such as described above with respect to FIG. 10G).

In some embodiments, the indication of the subject includes an indication of when the subject was detected in the environment (e.g., 7:02 PM such as described above with respect to FIGS. 10E and 10G and/or 9:01 AM, 9:02 AM, 9:08 AM, such as illustrated above with respect to FIG. 7T). In some embodiments, the indication of when the subject was detected in the environment includes a representation of the time when the subject was detected in the environment.

In some embodiments, the computer system is a first computer system. In some embodiments, before displaying the indication of the subject with the media content captured of the subject, the computer system receives, from a second computer system (e.g., 1008, 1014, 1016, and/or 714) different from the first computer system, the media content. In some embodiments, the second computer system is a camera, a watch, a phone, a tablet, a fitness tracking device, a processor, a head-mounted display (HMD) device, a communal device, a media device, a speaker, a television, and/or a personal computing device.

In some embodiments, the input corresponding to the request to display the activity log is a first request to display the activity log. In some embodiments, the subject is a first subject. In some embodiments, while (and/or after) displaying the indication of the first subject with the media content captured of the first subject, the computer system detects, via the one or more input devices, an activity (e.g., an action performed with context) (e.g., entering a room, leaving a room, being identified, being authenticated, changing a state of an accessory device, walking to an area, sleeping, and/or the like) of a third subject (e.g., such as described above with respect to FIG. 10F). In some embodiments, the third subject is different from the first subject. In some embodiments, the third subject is the same as the first subject. In some embodiments, in response to detecting the activity of the third subject and while displaying the indication of the first subject with the media content, the computer system displays, via the one or more display components, an indication (e.g., 1048) of the activity of the third subject (and/or an indication of when and/or where the activity of the third subject was detected in the environment): in accordance with a determination that the activity satisfies a sixth set of one or more criteria (e.g., that the third subject is not identified, not authenticated via a first factor of authentication, and/or is authenticated via the first factor of authentication but is not authenticated via a second factor of authentication different from the first factor of authentication), with media content (e.g., audio, a video, and/or an image) of the third subject (and/or performing the activity) (e.g., such as described above with respect to FIG. 10F); and in accordance with a determination that the activity satisfies a seventh set of one or more criteria (e.g., that the third subject is identified and/or authenticated, such as via the first factor of authentication and/or the second factor of authentication), without media content (e.g., audio, a video, and/or an image) captured of the third subject, wherein the seventh set of one or more criteria is different from the sixth set of one or more criteria. In some embodiments, the fourth set of one or more criteria is different from the first set of one or more criteria and/or the second set of one or more criteria. In some embodiments, the fourth set of one or more criteria is the same as the first set of one or more criteria and/or the second set of one or more criteria. In some embodiments, the third subject is different from the first subject. In some embodiments, the third subject is the same as the first subject.

In some embodiments, while displaying the indication of the subject with the media content captured of the subject, the computer system displays, via the one or more display components, a representation (e.g., 1024) of a first camera feed corresponding to (and/or from an external device located at) a first portion of the environment. In some embodiments, the first camera feed is the live view or a camera feed different from the live view. In some embodiments, while displaying the first camera feed corresponding to the first portion of the environment, the computer system receives an indication that the subject is at a second portion of the environment (e.g., office, such as described above with respect to FIG. 10D, and/or near 714, such as illustrated above with respect to FIGS. 7S-7T), wherein the second portion of the environment is different from the first portion of the environment. In some embodiments, in response to receiving the indication that the subject is in the second portion of the environment, the computer system displays, via the one or more display components, a representation (e.g., 1034) of a second camera feed corresponding to (and/or from an external device located at) the second portion of the environment (and/or ceases display of the representation of the first camera feed corresponding to the first portion of the environment) (e.g., without displaying the representation of the first camera feed corresponding to the first portion of the environment), wherein the first camera feed is different from the second camera feed.

Note that details of the processes described above with respect to process 1200 (e.g., FIG. 12) are also applicable in an analogous manner to the processes described herein. For example, process 1100 optionally includes one or more of the characteristics of the various processes described herein with reference to process 1200. For example, detecting the input to display the activity log of process 1200 can occur while displaying the representation of the second camera feed of process 1100. For brevity, these details are not repeated herein.

In order to provide clarification, the aforementioned description has been explained using particular embodiments and examples. At least some of these particular embodiments and examples can be found in the accompanying figures. However, such embodiments and examples should not be construed as restricting the disclosure or as exhaustive unless explicitly indicated otherwise. Without going beyond this description, a person of ordinary skill in the art can make changes and/or alterations in light of the aforementioned description.

In some embodiments, one or more computer systems automatically produce content in response to a request for it. The content can be produced either off-device (e.g., by one or more nearby computer systems (such as accessible via a local network) and/or by one or more remote computers accessible (such as accessible via the internet)) or on-device (e.g., by a computer system at which the request is received). Text, audio, and/or visual elements (such as pictures, graphics, and/or video) are optionally included in the content.

In some embodiments, generative content refers to content generated by one or more artificial intelligence (AI) techniques (e.g., generative images, generative graphics, generative video, generative audio, and/or generative text). In such embodiment, an AI technique can generate the content in response to a stimulus that is given to it. In some embodiments, the AI technique incorporates one or more pre-processing techniques (e.g., adjustment to a user-provided prompt, development of a system-generated prompt, and/or AI model selection) before generating the content. In some embodiments, the AI technique incorporates one or more post-processing steps (e.g., passing the content to another AI technique, upscaling, downscaling, cropping, formatting, and/or adding or removing metadata) before the content is used for other purposes, such as being sent to another software process for additional processing or being presented to a user (e.g., visually or audibly).

One or more words (such as a spoken or written natural language prompt), one or more drawings, one or more images, and/or one or more videos can be included in a prompt for generating content. Examples of AI techniques include neural networks, transformer-based deep neural networks, large language models (LLMs), and generative pre-trained transformer models.

Although generative material is typically based on a prompt, it is created using the prompt as a starting point rather than being deterministically chosen from pre-generated content. In some embodiments, the prompt includes pre-existing content (such as text, audio, and/or visual content). For example, a prompt can ask for a block of text to be redone or summarized in a different tone. The result can be generative text that has been rewritten or summarized in the different tone. Similar to this, a prompt can ask for changes to visual content in order to include or exclude content that is specified by the prompt (e.g., deleting a feature that has been identified in visual content, adding a feature that is described in a prompt, altering a style of visual content, and/or producing additional visual elements that are based on visual content but are not located in the visual content). In some embodiments, the prompt includes or is used with a random or pseudo-random seed (e.g., content is generated using the random or pseudo-random seed as a starting point). For example, in order to create an image based on a diffusion model, a random noise pattern can be iteratively denoised on a basis of the prompt. Although this description has discussed particular kinds of AI techniques, it should be acknowledged that content can be generated by a wide range of AI techniques.

When gathering user data, organizations that share, collect, and/or use it should be transparent and/or have consent from users. Publicly accessible data can be used in certain techniques instead of in addition to user data. Data can be anonymized, aggregated, and/or processed in other ways to eliminate or restrict any individual identification in order to preserve user privacy. Entities that gather, distribute, and/or use such data in any way should have user consent before doing so and/or be transparent about the data collection process. Moreover, organizations in charge of user data, including but not restricted to data used in connection with AI techniques should make an effort to adhere to established privacy policies and/or privacy practices. When it comes to creating and/or training AI/ML systems, these organizations can adopt and continuously adhere to rules and procedures that are acknowledged as reaching or surpassing industry standards and legal requirements. While doing this, efforts should be made to guarantee that all privacy concerns and intellectual property rights are upheld. Practices for protecting training data, including private information, from abuse or exploitation should be incorporated into training. All phases of the creation, training, and application of AI/ML systems, including data collection, data preparation, model training, model evaluation, model deployment, and continuing monitoring and maintenance, should be covered by such policies and procedures. Accountability and transparency ought to be upheld at all times. Users should have easy access to such policies, which should be updated in response to changes in data collection and/or use. User information must be gathered for the entity's reasonable and lawful purposes and not shared or sold for purposes other than those purposes. Furthermore, any gathering and sharing must to be transparent with users and/or only after obtaining their informed consent. Such organizations should also think about taking any necessary actions to protect and secure access to such data and make sure that those who have access to it follow their privacy policies and procedures. Additionally, such organizations ought to submit to third-party assessment in order to attest, if necessary for transparency, that they follow generally recognized privacy policies and procedures. Policies and/or practices should also be customized to a specific use case, applicable laws and standards, jurisdiction-specific factors, and the precise type of data being collected and/or accessed.

In some embodiments, AI/ML systems might make use of models that have been trained (for example, through supervised or unsupervised learning) utilizing a variety of training data, including information gathered from a user device. Such utilization of user-gathered data can be restricted to tasks performed on the user's device. For instance, a model can be trained locally on the user's device, preventing any data from being transferred to a different device. For another example, a model can be trained on one or more devices (e.g., a server) in addition to the user device, but this can be done in a way that protects privacy, like multi-party computation, which can be done cryptographically by secret sharing data or in another way that prevents user data from leaking to the other devices.

In certain implementations, such as federated learning, a model can be kept on several devices or centrally on the user's device. Such decentralized storage can also be accomplished in a way that protects privacy, for example, by using cryptographic procedures that split each piece of data into shards that prevent the data from being reassembled or used by the user device alone or only in conjunction with another device or devices. In this way, a model can be trained and run using additional computational power of other devices, without exposing a user or device activity pattern. As a result, user-gathered data can be safeguarded. In certain implementations, a model can be trained by combining input from several devices in a way that protects privacy.

In some embodiments, the current disclosure assumes that information utilized by AI/ML systems can be kept completely distinct from platforms on which the AI/ML systems are installed, used to communicate with users, or used to process data. In these implementations, data used to train the AI/ML systems offline can be kept in restricted-access, secured datastores, and/or kept for no longer than is required for training. In certain implementations, the AI/ML systems can temporarily store data in a local memory cache while a user is interacting with them. The AI/ML systems’ performance can be enhanced by using the local memory cache. However, after the user session is over, data kept in the local memory cache can be deleted to preserve user privacy. After processing, any temporary data caches utilized for online learning or inference can be quickly deleted. Secure communication and/or industry-standard encryption should be used for all data collection, transfer, and/or storage.

As previously mentioned, in some embodiments, methods like homomorphic encryption, secure hardware components, federated learning, differential privacy, and/or multi-party computation can be used to further protect personal data while the AI/ML systems are being trained and/or used. Changes in the underlying data distribution, such as idea drift or data skew, should be watched for in AI/ML systems as they can eventually impair their performance. In some embodiments, both online and offline training are used to train the AI/ML systems. While online training enables AI/ML systems to continuously adapt and/or improve, offline training can use carefully selected datasets to set baseline model performance. The current disclosure acknowledges how crucial it is to uphold stringent data governance procedures during this procedure in order to guarantee user privacy. In some embodiments, the AI/ML systems might be built with protections to ensure that they stay true to their initial goals even as they change in response to fresh data. Any significant adjustments to the way an AI/ML system collects and/or uses data can (and in certain situations should) be openly shared with the relevant parties. This can involve getting user consent for any changes to the way user data is gathered and/or used.

The current disclosure additionally considers examples where users can block or selectively restrict access to and/or use of data. In other words, the current disclosure assumes that components of software and/or hardware can be offered to restrict or stop data access. For certain services, for instance, the current technology should be set up to provide customers the option to “opt in” or “opt out” of taking part in data collecting at the time of service registration or at any point subsequently. As an additional illustration, current technology ought to be set up to let users choose not to supply specific data for AI/ML system training or for usage as input when the systems are in the inference stage. Another example is that current technology should be set up to give customers the option to restrict how long their data is kept or to completely forbid AI/ML systems from using their data. The current disclosure involves sending alerts regarding the access or use of personal information in addition to offering “opt in” and “opt out” options. A user can be reminded when the AI/ML systems produce outputs or make judgments based on their data, for example, or they can receive notifications when their data is being entered into the systems for training or inference.

The current disclosure acknowledges that, even when AI/ML systems are developed, constructed, and/or operated in accordance with industry best practices and standards, they should have clear limitations and/or oversight to reduce potential hazards. For instance, outputs that might be deemed inaccurate, damaging, offensive, and/or biased might be generated; these outputs might not accurately represent the views or stances of the organizations creating or implementing these systems. Additionally, in certain situations, mentions of third-party goods and/or services in the outputs should not be interpreted as affiliations or endorsements by the companies who supply the AI/ML systems. Human oversight and/or the capacity to override or fix incorrect or undesirable outputs can be maintained as a failsafe, and generated content can be checked for potentially unsuitable or dangerous material before being shown to users.

The current disclosure also takes into consideration that users of the AI/ML systems should not use the services in any way that violates, infringes upon, or misappropriates the rights of any other party. Additionally, the AI/ML systems should not be utilized for any illegal or unlawful conduct, nor should they be used to create any use cases or applications that would commit or assist in the commission of any criminal, tortious, or illegal act. The AI/ML systems must properly attribute content as needed and not infringe upon, violate, or misappropriate any copyrights, trademarks, rights of privacy and publicity, trade secrets, patents, or other property or legal rights of any party. Furthermore, no security, digital signing, digital rights management, content protection, verification, or authentication process should be hampered by AI/ML systems. Machine-generated outputs should not be mistakenly represented as human-generated by AI/ML systems.

Using and/or collecting data from several sources is one aspect of the technology mentioned above. Such information can be utilized to enhance a device's interactions with its surroundings, such as those with users. Personal information that can be used to uniquely identify an individual can be included in such data in certain situations. Demographic information, phone numbers, email addresses, location and/or location-related information, home, and work addresses, and/or any other identifying information can all be considered personal information. Users of the device can benefit from the use of such personal information. For instance, a user's personal data can be utilized to enhance the device's communication with the user. Within the parameters of the current disclosure, additional advantages can potentially arise from the usage of personal data.

One or more entities can need to handle personal data in order for it to be used. These organizations can be engaged in gathering, processing, revealing, moving, storing, or performing other tasks that facilitate the technologies covered here. Although it does not prevent it, the current disclosure assumes that all uses of personal identifiable data adhere to existing privacy rules and/or procedures of such entities. Generally speaking, such policies and practices must adhere to all relevant legislative regulations pertaining to data privacy and security, as well as reach or beyond widely accepted industry standards. For instance, businesses should obtain users' informed consent before collecting and using personal data, and they should only do so for appropriate and justifiable purposes. Furthermore, a user's personal information should never be sold, transferred, divulged, or used for purposes other than those that are reasonable and/or lawful.

There are a number of situations where personal data is unavailable, such as when a user decides not to disclose it. The user can, for instance, “opt out” of sharing such data or not specifically “opt in” during the registration process to refuse consent for the gathering and/or use of such data. Any number of other hardware and/or software components that prohibit the gathering and/or use of such data can also be used by the user. The current disclosure considers that implementations of the current technology can be used without such data, even though the usage of personal information can benefit a user by improving the device's performance. For instance, the device's functions can make use of non-personal data (for instance, in lieu of or in addition to personal data). Other methods involve drawing conclusions from data that does not contain personal information or from a small amount of personal information.

What is claimed is:

1. A method, comprising:
at a computer system that is in communication with one or more input devices and one or more display components:
receiving a notification that a subject has been detected in an environment;
in response to receiving the notification that the subject has been detected in the environment, displaying, via the one or more display components, a user interface element to view indications of activities of the subject in the environment;
while displaying the user interface element to view indications of activities of the subject in the environment, detecting, via the one or more input devices, an input corresponding to the user interface element to view indications of activities of the subject in the environment; and
in response to detecting the input corresponding to the user interface element to view indications of activities, displaying, via the one or more display components, a plurality of representations of activities performed by the subject, wherein the plurality of representations of activities includes a first representation of a first activity and a second representation of a second activity, wherein the first representation is separate from the second representation.

2. The method of claim 1, wherein:
in accordance with a determination that the first activity was performed before the second activity, the first representation of the first activity is ordered ahead of the second representation of the second activity; and
in accordance with a determination that the second activity was performed before the first activity, the second representation of the second activity is ordered ahead of the first representation of the first activity.

3. The method of claim 1, wherein:
in accordance with a determination the first activity and the second activity satisfy a set of one or more criteria, the first representation of the first activity and the second representation of the second activity are displayed in a first group; and
in accordance with a determination that the first activity and the second activity do not satisfy the set of one or more criteria, the first representation of the first activity is displayed in a second group and the second representation of the second activity is displayed in a third group different from the second group.

4. The method of claim 1, wherein the first representation of the first activity includes an indication of when the first activity was performed, and wherein the second representation of the second activity includes an indication of when the second activity was performed.

5. The method of claim 1, wherein the user interface element to view indications of activities of the subject in the environment includes an identification of the environment.

6. The method of claim 1, wherein the first representation of the first activity includes an identification of a first portion of the environment, and wherein the second representation of the second activity includes an identification of a second portion of the environment, wherein the first portion of the environment is different from the second portion of the environment.

7. The method of claim 1, wherein the user interface element to view indications of activities of the subject in the environment is displayed in a first user interface, and wherein the first representation of the first activity and the second representation of the second activity are displayed in a second user interface different from the first user interface.

8. The method of claim 1, further comprising:
in response to detecting the input corresponding to the user interface element to view indications of activities, displaying, via the one or more display components, an indication that the subject is unknown.

9. The method of claim 1, further comprising:
in response to detecting the input corresponding to the user interface element to view indications of activities, concurrently displaying, via the one or more display components, the plurality of representations of activities performed by the subject and an identification of the subject.

10. The method of claim 1, further comprising:
in response to detecting the input corresponding to the user interface element to view indications of activities, concurrently displaying, via the one or more display components, the plurality of representations of activities performed by the subject and an identification of the environment.

11. The method of claim 1, further comprising:
in response to detecting the input corresponding to the user interface element to view indications of activities, concurrently displaying, via the one or more display components, the plurality of representations of activities performed by the subject and an identification of when the first subject was detected.

12. The method of claim 1, further comprising:
in response to detecting the input corresponding to the user interface element to view indications of activities, concurrently displaying, via the one or more display components, the plurality of representations of activities performed by the subject and an indication of how the subject was detected.

13. The method of claim 1, wherein the first activity is different from the second activity.

14. The method of claim 1, wherein the first activity is the same as and separate from the second activity.

15. The method of claim 1, wherein the first activity includes detecting the subject in the environment.

16. The method of claim 1, wherein the subject is a first subject, the method further comprising:
in response to receiving a notification that a second subject has been detected in the environment and in accordance with a determination that a registered user is not detected in the environment, displaying, via the one or more display components, a user interface element to view indications of activities of the second subject in the environment.

17. The method of claim 1, wherein the notification that the subject has been detected in the environment is received from a resident device, and wherein the resident device is in communication with one or more accessories within the environment, the method further comprising:
in response to receiving the notification from the second computer system that the subject has been detected in the environment, displaying, via the one or more display components, a representation of the notification that the subject has been detected in the environment.

18. The method of claim 1, wherein the subject is a respective subject, the method further comprising:
in response to receiving the notification that the respective subject has been detected in the environment:
in accordance with a determination that the respective subject is a third subject, concurrently displaying, via the one or more display components, the user interface element to view indications of activities of the third subject in the environment and a user interface element to contact the third subject; and
in accordance with a determination that the respective subject is a fourth subject, concurrently displaying, via the one or more display components, the user interface element to view indications of activities of the fourth subject in the environment and a user interface element to contact the fourth subject without displaying the user interface element to contact the third subject, wherein the third subject is different from the fourth subject, and wherein the user interface element to contact the third subject is separate from the user interface element to contact the fourth subject.

19. The method of claim 1, wherein the plurality of representations of activities performed by the subject include activities performed since the subject was detected in the environment until the subject is detected as exiting the environment.

20. The method of claim 1, wherein the first activity was detected during a first session and the second activity was detected during a second session separate from the first session.

21. The method of claim 1, wherein the subject is a respective subject, the method further comprising:
while displaying the plurality of representations of activities performed by the respective subject, receiving an indication of a third activity of a fifth subject, wherein the third activity of the fifth subject is separate from the first activity of the respective subject and the second activity of the respective subject; and
in response to receiving the indication of the third activity of the fifth subject, updating display of, via the one or more display components, the plurality of representations of activities performed by the respective subject to include a third representation of the third activity, wherein the third representation of the third activity is separate from the first representation of the first activity and the second representation of the second activity.

22. A non-transitory computer-readable storage medium storing one or more programs configured to be executed by one or more processors of a computer system that is in communication with one or more input devices and one or more display components, the one or more programs including instructions for:
receiving a notification that a subject has been detected in an environment;
in response to receiving the notification that the subject has been detected in the environment, displaying, via the one or more display components, a user interface element to view indications of activities of the subject in the environment;
while displaying the user interface element to view indications of activities of the subject in the environment, detecting, via the one or more input devices, an input corresponding to the user interface element to view indications of activities of the subject in the environment; and
in response to detecting the input corresponding to the user interface element to view indications of activities, displaying, via the one or more display components, a plurality of representations of activities performed by the subject, wherein the plurality of representations of activities includes a first representation of a first activity and a second representation of a second activity, wherein the first representation is separate from the second representation.

23. A computer system that is configured to communicate with one or more input devices and one or more display components, the computer system comprising:
one or more processors; and
memory storing one or more programs configured to be executed by the one or more processors, the one or more programs including instructions for:
receiving a notification that a subject has been detected in an environment;
in response to receiving the notification that the subject has been detected in the environment, displaying, via the one or more display components, a user interface element to view indications of activities of the subject in the environment;
while displaying the user interface element to view indications of activities of the subject in the environment, detecting, via the one or more input devices, an input corresponding to the user interface element to view indications of activities of the subject in the environment; and
in response to detecting the input corresponding to the user interface element to view indications of activities, displaying, via the one or more display components, a plurality of representations of activities performed by the subject, wherein the plurality of representations of activities includes a first representation of a first activity and a second representation of a second activity, wherein the first representation is separate from the second representation.
